(19) United States
(12) Patent Application Publication
(10) Pub. No.: US 2016/0340463 A1
(43) Pub. Date: Nov. 24, 2016

(54) PROCESS FOR PREPARING A POLYMER

(71) Applicant: NEWSOUTH INNOVATIONS PTY LIMITED, Sydney (AU)

(72) Inventors: Jiangtao Xu, New South Wales (AU); Cyrille Andre Jean-Marie Boyer, New South Wales (AU)

(21) Appl. No.: 15/114,827

(22) PCT Filed: Jan. 30, 2015
(86) PCT No.: PCT/AU2015/000052

§ 371 Date: Jul. 27, 2016

(30) Foreign Application Priority Data
Jan. 31, 2014 (AU) 2014900300
Apr. 7, 2014 (AU) 2014901259

(51) Int. Cl. C08F 293/00; C08F 20/56; C08F 30/02; C08F 18/04; C08F 26/10; C08F 20/14; C08F 18/08

(52) U.S. Cl. CPC C08F 293/005; C08F 20/14; C08F 20/56; C08F 18/08; C08F 18/04; C08F 26/10; C08F 30/02; C08F 2500/03; C08F 2438/03; C08F 2800/10

(57) ABSTRACT

This application relates to a process of radical polymerization of a monomer, wherein the radical polymerization is carried out in the presence of a photoredox catalyst and a chain transfer agent. This application also relates to a process for preparing a polymer, comprising exposing a mixture comprising a monomer, an initiator, a chain transfer agent and a photoredox catalyst, to light, wherein exposing the mixture to light initiates radical polymerization of the monomer. The application also relates to polymers produced by these processes and polymerization systems suitable for carrying out these processes.

This application claims priority from Australian provisional patent application no. 2014900300 filed on 31 Jan. 2014 and Australian provisional patent application no. 2014901259 filed on 7 Apr. 2014. The disclosure of each of these provisional patent applications is incorporated herein in its entirety.

### TECHNICAL FIELD

The invention relates to a process for preparing a polymer. More particularly, the invention relates to a controlled radical polymerization process that is mediated by light.

### BACKGROUND

There is growing interest in the development of controlled polymerization techniques that can be triggered by stimulus, including photochemical, thermal and electrochemical stimuli. For example, a controlled radical polymerization using a dithiocarbamate photoinitiator triggered by high energy light (300 nm; >20 W) has previously been described (see Otsu, T.; Yoshida, M.; Tazaki, T. Die Makromolekulare Chemie, Rapid Communications 1982, 3, 133). This methodology has attracted a great deal of attention due to the easy control of polymerization in both space and time at room temperature. It has been demonstrated that this technique can be used to prepare various architectures such as block, graft and star polymers. However, the architectures and compositions of the polymers made by this technique were relatively poorly controlled with broad molecular weight distribution (MWD).

Recently the first example of photo-controlled free radical polymerization performed under visible light has been described (see Fors, B. P.; Hawker, C. J. Angewandte Chemie International Edition 2012, 51, 8850., Poelma, J. E.; Fors, B. P.; Meyers, G. F.; Kramer, J. W.; Hawker, C. J. Angewandte Chemie International Edition 2013, 52, 6844., and WO 2013/148722 A1). This polymerization process employed the photoredox catalyst fac-[Ir(ppy)₃] in the presence of an alkyl halide for the polymerization of methacrylate monomers. However, the photocontrolled radical polymerization process described in these documents is only effective for a limited range of monomer families, limiting the application of this process.

A photo-controlled polymerization technique able to polymerize a broader range of monomers, including conjugated monomers (e.g. (meth)acrylates, (meth)acrylamide and styrene) and unconjugated monomers (e.g. vinyl acetate (VAc)) would be desirable. It would also be desirable to provide such a polymerization technique which can be used to produce polymers with a narrow molecular weight distribution.

### SUMMARY

In a first aspect, the present invention provides a process for preparing a polymer, comprising exposing a mixture comprising a monomer, an initiator, a chain transfer agent and a photoredox catalyst, to light, wherein exposing the mixture to light initiates radical polymerization of the monomer.

In a second aspect, the present invention provides a process for preparing a polymer, comprising exposing a mixture comprising a monomer, a thiocarbonylthio compound, an initiator and a photoredox catalyst, to light, wherein exposing the mixture to light initiates radical polymerization of the monomer.

In a third aspect, the present invention provides a process of radical polymerization of a monomer, wherein the radical polymerization is carried out in the presence of a photoredox catalyst and a chain transfer agent.

In a fourth aspect, the present invention provides a process of radical polymerization of a monomer, wherein the radical polymerization is carried out in the presence of a photoredox catalyst and a thiocarbonylthio compound.

In a fifth aspect, the present invention provides a reversible addition-fragmentation chain transfer (RAFT) polymerization process, wherein the polymerization process is initiated by irradiating a photoredox catalyst with light having a wavelength effective to excite the photoredox catalyst and induce photoinduced electron transfer (PET).

In a sixth aspect, the present invention provides a polymer produced by the process described herein.

In a seventh aspect, the present invention provides a composition comprising a monomer, an initiator, a chain transfer agent and a photoredox catalyst, wherein exposing the composition to light initiates radical polymerization of the monomer.

In an eighth aspect, the present invention provides a composition comprising a monomer, an initiator, a thiocarbonylthio compound and a photoredox catalyst, wherein exposing the composition to light initiates radical polymerization of the monomer.

In a ninth aspect, the present invention provides a method for producing a polymer, comprising exposing the composition of the seventh aspect or the eighth aspect to light.

In a tenth aspect, the present invention provides a polymerization system comprising a monomer, an initiator, a chain transfer agent and a photoredox catalyst, wherein exposure to light initiates radical polymerization of the monomer.

In an eleventh aspect, the present invention provides a polymerization system comprising a monomer, an initiator, a thiocarbonylthio compound and a photoredox catalyst, wherein exposure to light initiates radical polymerization of the monomer.

In a twelfth aspect, the present invention provides a combination of a photoredox catalyst and a thiocarbonylthio compound. Preferably, the thiocarbonylthio compound is capable of acting as chain transfer agent and initiator.

In a thirteenth aspect, the present invention provides a process for preparing a polymer bioconjugate, comprising exposing a mixture comprising a monomer, an initiator, a photoredox catalyst and a biomolecule comprising, or bound to, a moiety capable of acting as a chain transfer agent, to light, wherein exposing the mixture to light initiates radical polymerization of the monomer and conjugation of the polymerized monomer to the biomolecule.

In a fourteenth aspect, the present invention provides a process for preparing a polymer bioconjugate, comprising exposing a mixture comprising a monomer, an initiator, a photoredox catalyst and a biomolecule comprising, or bound to, a thiocarbonylthio group, to light, wherein exposing the mixture to light initiates radical polymerization of the monomer and conjugation of the polymer to the biomolecule.

In a fifteenth aspect, the present invention provides a method for preparing a polymer bioconjugate, comprising exposing a mixture comprising a monomer, a photoredox catalyst and a macroinitiator, wherein the macroinitiator comprises a biomolecular moiety and a thiocarbonylthio moiety, to light, wherein exposing the mixture to light initiates radical polymerization of the monomer and conjugation of the polymerized monomer to the biomolecular moiety.

In a sixteenth aspect, the present invention provides a polymer bioconjugate produced by the method of the thirteenth, fourteenth or fifteenth aspects.

### BRIEF DESCRIPTION OF DRAWINGS

The invention will be further described, by way of example only, with reference to the accompanying drawings, in which:

FIG. 1 shows a proposed mechanism of a photoinduced electron transfer—reversible addition-fragmentation chain transfer (PET-RAFT) polymerization using fac-[Ir(ppy)₃] as photoredox catalyst and examples of thiocarbonylthio compounds that may be used in the polymerization.

FIG. 2 shows graphs relating to the polymerization of methyl methacrylate (MMA) using CPADB as CTA and fac-[Ir(ppy)₃] as photo-redox catalyst in the presence (on) or in the absence (off) of light: a) conversion vs. time; b) Mₙ () and M_{w}/Mₙ (∘) vs. conversion; c) In[M]₀/[M]ₜ vs. time of exposure; d) GPC traces at different times of exposure.

FIG. 3 shows a graph of normalized w(log M) against molecular weight (g/mol) for a polymerization reaction at various time points. The polymerization reaction produced multi-block co-polymers and used a 4.8 W LED lamp as light source.

FIG. 4 shows photographs of an experimental setup for photo-polymerization using 4.8 Watts blue LED light.

FIG. 5 shows the chemical structure of photoredox catalyst fac-[Ir(ppy)₃] (ppy=2-pyridylphenyl).

FIG. 6a shows the chemical structures of monomers(a) methyl methacrylate (MMA), (b) methyl acrylate (MA), (c) tert-butyl acrylate (tBuA), (d) styrene (St), (e) N,N-dimethylacrylamide (DMA), (f)N-(2-hydroxypropyl) methacrylamide (HPMA), (g)N-isopropylacrylamide (NIPAAm), (h) vinyl acetate, (i) vinyl pivalate (VP), (j)N-vinyl pyrolidinone (NVP), (k) dimethyl vinylphosphonate (DVP), (I) oligoethylene glycol methyl ether methacrylate (OEGMA), (m) oligoethylene glycol methyl ether acrylate (OEGA), (n) isoprene.

FIG. 6b shows the chemical structures of thiocarbonylthio compounds: 4-cyanopentanoic acid dithiobenzoate (CPADB), 3-benzylsulfanylthiocarbonylsufanylpropionic acid (BSTP), 2-phenyl-2-propyl benzodithioate (CDB), 2-cyano-2-propylbenzodithioate (CPD), 2-(n-butyltrithiocarbonate)-propionic acid (BTPA), methyl 2-[(ethoxycarbonothioyl)sulfanyl]propanoate, and 4-Cyano-4-[(dodecylsulfanylthiocarbonyl)sulfanyl]pentanoic acid (CDTPA).

FIG. 7 shows a synthetic scheme of the synthesis of a di-block copolymer via PET-RAFT polymerization.

FIG. 8 shows a series of graphs relating to a PET-RAFT polymerization of MMA at the photocatalyst ratio ([catalyst]/[MMA]) of 2 ppm in DMSO. a) (▪) Mₙ vs. conversion and (∘) M_{w}/Mₙ vs. conversion; b) In([M]₀/[M]ₜ) vs. exposure time, with [M]₀ and [M]ₜ correspond to the concentrations of monomers at time zero and t, respectively; c) GPC curves vs exposure time.

FIG. 9 shows a UV-visible spectrum of purified PMMA polymer synthesized by PET-RAFT polymerization using the CPADB as chain transfer agent in DMSO during 24 h and 4.8 W blue LED lamp (M_{n, NMR} 7280 g/mol, M_{n, GPC}=7300 g/mol).

FIG. 10 shows a ¹H NMR spectrum of purified PMMA polymer synthesized by PET-RAFT polymerization using the CPADB as chain transfer agent in DMSO during 24 h and 4.8 W blue LED lamp (M_{n, NMR} 7180 g/mol, M_{n, GPC}=7320 g/mol, monomer conversion 71%). The reaction conditions for the synthesis of the PMMA polymer were: molar ratio [MMA]:[CPADB]:[fac-[Ir(ppy)₃]]=200:1:1×10⁻⁴ in DMSO at room temperature with irradiation from a 4.8 W Blue LED lamp.

FIG. 11 shows ¹H NMR spectra of CPADB in DMSO with fac-[Ir(ppy)₃] before and after 24 hours exposure under 4.8 W Blue LED light.

FIG. 12 shows GPC traces of PMMA macro-initiator and PMMA-b-PMMA block copolymers synthesized by PET-RAFT polymerization.

FIG. 13 shows GPC traces of PMMA macro-initiator and PMMA-b-POEGMA block copolymers synthesized by PET-RAFT polymerization.

FIG. 14 shows GPC traces of PMMA macro-initiator and PMMA-b-PtBuMA block copolymers synthesized by PET-RAFT polymerization.

FIG. 15 shows GPC traces of MA synthesized by PET-RAFT polymerization mediated by BTPA at the photocatalyst ratio ([catalyst]/[MA]) of 1 ppm in DMSO at different reaction times.

FIG. 16 shows a ¹H NMR spectrum of purified PMA polymer synthesized by PET-RAFT polymerization using BTPA as chain transfer agent in DMSO during 24 h and 4.8 W blue LED lamp (M_{n, NMR} 8500 g/mol, M_{n, GPC}=8560 g/mol, monomer conversion >98%). The reaction conditions for synthesis of the PMA polymer were: molar ratio [MA]:[BTPA]:[fac-[Ir(ppy)₃]]=110:1:1×10⁻⁴ in DMSO at room temperature with irradiation from a 4.8 W Blue LED lamp.

FIG. 17 shows a series of graphs relating to the PET-RAFT polymerization of styrene at the photocatalyst ratio ([catalyst]/[styrene]) of 10 ppm in DMSO. a) Mₙ, GPC (▪) and M_{w}/Mₙ (∘) vs. exposure time; b) In([M]₀/[M]ₜ) vs. time, with [M]₀ and [M]ₜ being the concentrations of monomers at time points zero and t, respectively; c) GPC traces at different polymerization times.

FIG. 18 shows chemical structures of various photoredox catalysts.

FIG. 19 shows chemical structures of ligands which may be included in a photoredox catalyst.

FIG. 20 shows a proposed mechanism of a photoinduced electron transfer—reversible addition-fragmentation chain transfer (PET-RAFT) polymerization using Ru(bpy)₃Cl₂ as photoredox catalyst.

FIG. 21 shows the structure of the tris(2,2′-bipyridyl)ruthenium(II) ion which forms part of the photocatalyst, tris(2,2′-bipyridyl)ruthenium(II) chloride (Ru(bpy)₃Cl₂); commercially available as the hexahydrate, i.e. tris(2,2′-bipyridyl)ruthenium(II) chloride hexahydrate (Ru(bpy)₃Cl₂.6H₂O).

FIG. 22 shows chemical structures of monomers and thiocarbonylthio compounds used in Example 3: (a) N,N′-dimethylacrylamide (DMA), (b) N,N′-diethylacrylamide (DEA), (c)N-isopropylacrylamide (NIPAAm), (d) di(ethylene glycol) ethyl ether acrylate (DEGA), (e) oligoethylene glycol methyl ether acrylate (OEGA), (f) oligoethylene glycol methyl ether methacrylate (OEGMA); 4-cyanopentanoic acid dithiobenzoate (CPADB), 2-(n-butyltrithiocarbonate)-propionic acid (BTPA) and 2-(pyridin-2-yldisulfanyl)ethyl 2-(((butylthio)carbonothioyl)thio)propanoate (PDS-BTP).

FIG. 23 shows a synthetic scheme of the synthesis of BSA-polymer bioconjugate, and the subsequent cleavage of the disulphide bond between BSA and the polymer in the presence of tris(2-carboxyethyl)phosphine (TCEP).

FIG. 24 shows the excitation and emission spectra of photoredox catalyst Ru(bpy)₃Cl₂ in DMSO. λ_{max, ex}=458 nm, λ_{max, em}=620 nm.

FIG. 25 shows (a) fluorescence emission spectra showing fluorescent emission intensity for different concentrations of CPADB; and (b) shows a plot of the ratio Iₒ/I versus quencher concentration, from fluorescence quenching (Stern-Volmer) studies of a 6.68 μM solution of Ru(bpy)₃Cl₂ in DMSO with varying concentrations of thiocarbonylthio compound CPADB. I₀ and I correspond to the emission intensity in the absence and presence of quencher, respectively.

FIG. 26 shows traces from gel permeation chromatography (GPC) for the aqueous PET-RAFT polymerization of DMA in different solvents: (a) DMSO; (b) acetonitrile; (c) methanol; (d) toluene. Experimental condition: [DMA]:[BTPA]:[Ru(bpy)₃Cl₂]=202:1:0.000202, room temperature under 4.8 W blue LED light.

FIG. 27 shows a graph of w log M (Normalized) against Log M (g/mol) indicating the molecular weight distribution (MWD) recorded by UV and RI detector for the aqueous PET-RAFT polymerization of DMA at 3 h in DMSO. Experimental condition: [DMA]:[BTPA]:[Ru(bpy)₃Cl₂]=202:1:0.000202, room temperature under 4.8 W blue LED light.

FIG. 28 shows a graph of w log M (Normalized) against Log M (g/mol) indicating the molecular weight distribution (MWD) recorded by UV (305 nm; solid line) and RI (dashed line) detector for the aqueous PET-RAFT polymerization of DMA at 4 h in water. Experimental condition: [DMA]:[BTPA]:[Ru(bby)₃Cl₂]=202:1:0.000202, room temperature under 4.8 W blue LED light.

FIG. 29 shows (a) a ¹H NMR spectrum for purified PDMA prepared by aqueous PET-RAFT polymerization of DMA at 4 h in water; and (b) a UV-vis spectrum of purified PDMA in acetonitrile. Experimental conditions: [DMA]:[BTPA]:[Ru(bpy)₃Cl₂]=202:1:0.000202, room temperature under 4.8 W blue LED light. M_{n, GPC}=17 150 g/mol, PDI=1.10. The absorbance at 305 nm confirms the presence of trithiocarbonate (C═S). The trithiocarbonate end group functionality was determined to be ˜100% using the following equation: F^{end group}=(Abs/∈^{BTPA})/[PDMA], where Abs, ∈^{BTPA} and [PDMA] correspond to absorbance, extension coefficient of BTPA agent and PDMA concentration, respectively. PDMA concentration was calculated using the molecular weight determined by NMR.

FIG. 30 shows UV-vis spectra recorded with a RI detector for the aqueous PET-RAFT polymerization of PDMA in water at room temperature under 4.8 W blue LED light. Experimental conditions: Dotted line: [DMA]:[BTPA]:[Ru(bpy)₃Cl₂]=100:1:1×10⁻⁴, Table 2, Entry 9; Dashed line: [DMA]:[BTPA]:[Ru(bpy)₃Cl₂]=200:1:2×10⁻⁴, Table 2, Entry 5; Double thin line: [DMA]:[BTPA]:[Ru(bpy)₃Cl₂]=500:1:5×10⁻⁴, Table 2, Entry 8; Solid line: [DMA]:[BTPA]:[Ru(bpy)₃Cl₂]=1000:1:10×10⁻⁴, Table 2, Entry 7.

FIG. 31 shows a graph of w log M (Normalized) against Log M (g/mol) indicating molecular weight distribution (MWD) recorded by UV (solid line) and RI (dashed line) detector for the aqueous PET-RAFT polymerization of NIPAAm at 3 h in water to provide poly-N-isopropylacrylamide (PNIPAAm). Experimental conditions: [NIPAAm]:[BTPA]:[Ru(bpy)₃Cl₂]=202:1:0.000202, room temperature under 4.8 W blue LED light.

FIG. 32 shows (a) a ¹H NMR spectrum for purified POEGMA prepared by aqueous PET-RAFT polymerization of OEGMA at 22 h in water; and (b) a UV-vis spectrum for purified POEGMA prepared by aqueous PET-RAFT polymerization of OEGMA at 22 h in water. Experimental conditions: [OEGMA]:[CPADB]:[Ru(bpy)₃Cl₂]=70:1:3.5×10⁻⁴, room temperature under 4.8 W blue LED light. M_{n, GPC}=9470 g/mol, PDI=1.18 (Entry 1 in Table 2). The absorbance at 305 nm confirms the presence of dithioester (C═S). The dithioester end group functionality was determined to be ˜100% using the following equation: F^{end group}=(Abs/∈^{CPADB})/[OEGMA], where Abs, ∈^{CPADB} and [OEGMA] correspond to absorbance, extension coefficient of CPADB agent and OEGMA concentration, respectively. OEGMA concentration was calculated using the molecular weight determined by NMR.

FIG. 33 shows a ¹H NMR spectrum for purified POEGA prepared by aqueous PET-RAFT polymerization of OEGA at 22 h in water. Experimental conditions: [OEGA]:[BTPA]:[Ru(bpy)₃Cl₂]=50:1:2.5×10⁻⁴, room temperature under 4.8 W blue LED light. M_{n, GPC}=15400 g/mol, PDI=1.29 (Entry 2 in Table 2).

FIG. 34 shows GPC traces for PDMA macroinitiator (solid line), and PDMA-diblock copolymers a) PDMA-b-PDEGA (dashed line), b) PDMA-b-PNIPAAm (dashed line) and c) PDMA-b-POEGA (dashed line). Experimental conditions: [monomer]:[macroinitiator]:[Ru(bpy)₃Cl₂]=202:1:0.000202 for PDMA-b-PDEGA and PDMA-b-PNIPAAm, [OEGA]:[macroinitiator]:[Ru(bpy)₃Cl₂]=42:1:0.0002 for PDMA-b-POEGA, room temperature under 4.8 W blue LED light in water.

FIG. 35 shows GPC traces for triblock copolymer PNIPAAm-b-PDMA-b-PDMA produced using Ru(bpy)₃Cl₂; diblock copolymer PNIPAAm-b-PDMA produced using Ru(bpy)₃Cl₂; and PNIPAAm macroinitiator. Experimental conditions: room temperature under 4.8 W blue LED light in water.

FIG. 36 shows a graph of w log M (a.u.) against log M (g/mol) indicating the molecular weight distributions of PDMA synthesized by PET-RAFT polymerization of N,N′-dimethylacrylamide (DMA) in fetal bovine serum using two different concentrations of Ru(bpy)₃Cl₂, i.e. [Ru(bpy)₃Cl₂]/[DMA]=1 ppm (thin line) and [Ru(bpy)₃Cl₂]/[DMA]=10 ppm (thicker line). Experimental conditions: (thin line) [DMA]:[BTPA]:[Ru(bpy)₃Cl₂]=202:1:2×10⁻⁴ and (thicker line) [DMA]:[BTPA]:[Ru(bpy)₃Cl₂]=202:1:2×10⁻³.

FIG. 37 shows plots of (a) Mₙ (▪) and M_{w}/Mₙ (◯) vs. conversion; (b) In([M]₀/[M]ₜ) () and conversion (▪) vs. time of exposure; (c) molecular weight distribution (MWD) at different times of exposure; for material obtained from the aqueous PET-RAFT polymerization of N,N′ dimethylacrylamide (DMA) in fetal bovine serum using BTPA as chain transfer agent and Ru(bpy)₃Cl₂ as photoredox catalyst under 4.8 W blue LED light: Experimental conditions: [DMA]:[BTPA]:[Ru(bpy)₃Cl₂]=202:1:2×10⁻³, room temperature.

FIG. 38 shows a ¹H NMR spectrum of 2-(pyridin-2-yldisulfanyl)ethyl 2-(((butylthio)carbonothioyl)thio) propanoate (PDS-BTP).

FIG. 39 shows (A) kinetic plots; (B) plots of apparent propagation rate (kₚ^{app}) vs. dielectric constant; (c) plots of polydispersity (Mₙ (g/mol)) against conversion; and (D) plots of polydispersity (M_{w}/Mₙ) against conversion; of aqueous PET-RAFT polymerization of N,N′ dimethylacrylamide (DMA) in the presence of BTPA and Ru(bpy)₃Cl₂ under blue LED light in different solvents: (▪) H₂O; (□) dimethyl sulfoxide (DMSO); () acetonitrile (ACN); (∘) methanol (MeOH); (Δ) toluene. [DMA]:[BTPA]:[Ru(bpy)₃Cl₂]=202:1:2×10⁻⁴, room temperature.

FIG. 40 shows plots of A) conversion vs. time; B) Mₙ (▪) and M_{w}/Mₙ (∘) vs. conversion; C) In([M]₀/[M]ₜ) vs. time of exposure; and D) GPC traces at different times of exposure; for an aqueous PET-RAFT polymerization of N,N′-dimethylacrylamide (DMA) using BTPA as chain transfer agent and Ru(bpy)₃Cl₂ as photoredox catalyst in the presence (“ON”) or in the absence (“OFF”) of blue LED light. Experimental conditions: [DMA]:[BTPA]:[Ru(bpy)₃Cl₂]=202:1:2×10⁻⁴, room temperature.

FIG. 41 shows plots of A) In([M]₀/[M]ₜ) vs. time of exposure; B) Mₙ and M_{w}/Mₙ vs. conversion; for an aqueous PET-RAFT polymerization of DMA using varied concentrations of photoredox catalyst (Ru(bpy)₃Cl₂) with blue LED light in the presence of BTPA at room temperature, using a molar ratio of [DMA]:[BTPA]=202:1 in water.

FIG. 42 shows A) aqueous GPC traces of BSA-PDMA at different times of exposure; B) a plot of Mₙ (▪) and M_{w}/Mₙ (∘) vs. conversion; C) a plot of In([M]₀/[M]ₜ) vs. time; D) a plot of the MWD of PDMA after reduction of disulfide bond between BSA and PDMA; E) a UV-visible spectrum indicating hydrolysis of p-nitrophenyl acetate by polymer-BSA conjugate as described in Example 3; and F) a chart of esterase activity of BSA after treatments under various conditions (normalized using native BSA).

FIG. 43 shows plots of a) monomer conversion (♦) and In([M]₀/[M]ₜ) (▪) vs. time; b) M_{n,GPC} (▪), M_{n,th} (regression line) and M_{w}/Mₙ (∘) vs. conversion; d) GPC traces at different times of exposure; for the photopolymerization of VAc in the presence of xanthate and fac-[Ir(ppy)₃] as photoredox catalyst under 4.8 W blue LED irradiation at room temperature as described in Example 4. Experimental conditions: [VAc]:[xanthate]:[catalyst]=200:1:10×10⁻⁴.

FIG. 44 shows (A) UV-vis spectra showing a comparison of molecular weight distributions recorded using a RI and UV (λ=305 nm) detector; and (B)¹H NMR spectra for purified PMMA and PMA polymer synthesized by PET-RAFT polymerization in the presence of air using BTPA and 4.8 W blue LED lamp (λₘₐₓ=435 nm) as light source (M_{n, NMR, PMMA}=8 010 g/mol, M_{n, GPC,PMMA}=8 200 g/mol, monomer conversion 41%; M_{n, NMR, PMA}=4 620 g/mol, M_{n, GPC,PMA}=4 700 g/mol, monomer conversion 29%).

FIG. 45 shows kinetics plots for PET-RAFT polymerizations of MMA (A and B) and MA (C and D) in the presence of oxygen (red dots) and absence of oxygen (black squares) in DMSO. (A) In([M]₀/[M]ₜ) vs. exposure time for MMA; (B) Mₙ vs. conversion (top) and M_{w}/Mₙ vs. conversion (bottom) for MMA; (C) In([M]₀/[M]ₜ) vs. exposure time for MA; (D) Mₙ vs. conversion (top) and M_{w}/Mₙ vs. conversion (bottom) for MA. Note: [M]₀ and [M]ₜ correspond to the concentrations of monomers at time zero and t, respectively; (B) and (D) straight lines correspond to the theoretical values

FIG. 46 shows (A) a plot indicating the growth of polymer chain (Mₙ and M_{w}/Mₙ) and number of chain extension from the “ON”/“OFF” experiment for preparing triblock copolymer PMA-b-PtBuA-b-PnBuA described in Example 6; (B) UV-vis spectra showing molecular weight distributions of triblock copolymer PMA-b-PtBuA-b-PnBuA as described in Example 6; (C) UV-vis spectra showing molecular weight distribution of diblock of PMMA-b-PMMA as described in Example 6.

FIG. 47 shows a ¹H NMR spectrum of purified PVAc polymer synthesized by PET-RAFT polymerization using methyl 2-[(ethoxycarbonothioyl)sulfanyl]propanoate and 4.8 W blue LED lamp as light source (M_{n, NMR}=3 700 g/mol, M_{n, GPC}=5 300 g/mol, monomer conversion 16%, Example 4; Table 3, #3).

FIG. 48 shows a plot of w log M and log M (g/mol) comparing molecular weight distribution determined by RI (black line) and UV (red line; A=305 nm) detectors for PVAc synthesized by PET-RAFT polymerization using xanthate and 4.8 W blue LED lamp as light source in DMSO during 22 h (M_{n, NMR}=13 300 g/mol, M_{n, GPC}=18 200 g/mol, monomer conversion 76%, Example 4; Table 3, #2).

FIG. 49 shows GPC traces (eluent=DMAc) of PMMA macro-initiator and PMMA-b-PHPMA block copolymers synthesized by PET-RAFT polymerization. (See Example 5; Table 4, #4).

FIG. 50 shows GPC traces (eluent=DMAc) of PHPMA macro-initiator and PHPMA-b-PMMA block copolymers synthesized by PET-RAFT polymerization. (See Example 5; Table 4, #7).

FIG. 51 shows GPC traces (eluent=THF) of PSt macro-initiator and PSt-b-PMA block copolymers synthesized by PET-RAFT polymerization. (See Table 4, #10),

FIG. 52 shows plots of molecular weight distributions for PET-RAFT polymerizations of MMA (a) and MA (b) prepared in the presence of oxygen in DMSO.

FIG. 53 shows ¹H NMR spectra for purified poly(methyl acrylate) (PMA—top); purified diblock copolymer poly(methyl acrylate)-block-poly-(tert-butyl acrylate) (PMA-bPtBuA—middle); and purified triblock copolymer poly(methyl acrylate)-block-poly(tert-butyl acylate)-block-poly(n-butyl acrylate) (PMA-b-PtBuA-b-PnBuA—bottom) obtained by PET-RAFT polymerization in the presence of air.

FIG. 54 shows (A) a proposed mechanism of a photoinduced electron transfer—reversible addition-fragmentation chain transfer (PET-RAFT) polymerization using Chlorophyll A (Chl a) as photoredox catalyst and examples of thiocarbonylthio compounds that may be used in the polymerization; and (B) the structure of Chl a.

FIG. 55 shows (A) a plot of In([M]₀/[M]ₜ) vs. exposure time under blue (squares) and red (dots) lights; (B and E) Mₙ vs. conversion for blue (B) and red (E) light system, respectively; (C and F) molecular weight distributions at different time points under blue (C) and red (F) light irradiation, respectively; and (D) a plot of Ln([M]₀/[M]ₜ) vs time for conversion of MA in the presence (“ON”) and absence (“OFF”) of red light. The measurements in FIG. 55 were obtained from online Fourier transform near-infrared (FTNIR) of a PET-RAFT polymerization of methyl acrylate (MA) at room temperature with Chl a as the photoredox catalyst and BTPA as combined initiator and chain transfer agent under blue (A, B and C) and red (A, D, E and F) light irradiation, using molar ratio of [MA]:[BTPA]:[Chl a]=200:1:8×10⁻⁴ in DMSO.

FIG. 56 shows a plot of In([M]₀/[M]ₜ) against exposure time measured by online Fourier transfer near-infrared (FTNIR) for different Chl a concentrations (4 ppm against 10 ppm relative to monomer concentration) for the polymerization of MMA at room temperature under red light irradiation with CPADB as combined initiator and chain transfer agent using molar ratio of [MMA]:[CPADB]=200:1 in DMSO.

FIG. 57 shows plots of molecular weight distributions of PMA macroinitiators and their diblock copolymers prepared at room temperature in the presence of Chl a and BTPA as chain transfer in DMSO: (A) plot of molecular weight distributions of PMA macroinitiator and PMA-b-PDMA diblock copolymers at 1, 2, 3, and 5 h prepared under red light irradiation; (B) plot of overlapping UV and RI GPC traces of PMA-b-PDMA diblock copolymer obtained at 5 h from (A); (C) plot of molecular weight distributions of PMA macroinitiator and PMA-b-PDMA diblock copolymers at 1, 2, 3 and 5 h prepared under blue light irradiation; and (D) plot of overlapping UV and RI GPC traces of PMA-b-PDMA diblock copolymer obtained at 5 h from (C).

FIG. 58 shows a plot of Ln([M]₀/[M]ₙ) vs. time obtained by online Fourier transform near-infrared (FTNIR) of the polymerization of methyl acrylate (MA) in the presence and absence of irradiation under red light with Chl a as the photoredox catalyst and BTPA as the combined initiator and chain transfer agent using molar ratio of [MA]:[BTPA]:[Chl a]=200:1:8×10⁻⁴ in DMSO.

### DESCRIPTION OF EMBODIMENTS

In a first aspect, the present invention provides a process for preparing a polymer. The process comprises exposing a mixture to light. The mixture comprises a monomer, an initiator, a chain transfer agent, and a photoredox catalyst. The initiator and the chain transfer agent may be separate compounds or may be a single compound able to act as both an initiator and a chain transfer agent. Exposing the mixture to light initiates radical polymerization of the monomer.

Without wishing to be bound by theory, it is believed that on exposure to light the photoredox catalyst generates a species which is able to cause the initiator to form a radical that initiates radical polymerization of the monomer. It is also believed that the chain transfer agent controls the molecular weight distribution of the polymer produced by the radical polymerization.

Advantageously, in the process of the present invention, both the commencement of the polymerization process and the propagation of the polymerization process are photo-controlled. As light is required to commence and maintain the polymerization process, the polymerization process is reversibly activated by light and reversibly deactivated by the absence of light. This allows for greater control over the polymerization process compared to various prior art processes. In various embodiments, the radical polymerization of the monomer can be initiated using visible light, and the process may be carried out at room temperature. Further, the process can be carried out using a wide variety of monomers. In addition, in some embodiments, the process may be carried out without degassing of the reaction mixture to remove oxygen.

The ability to precisely control the molecular weight and molecular weight distribution in polymer synthesis is of great importance in a variety of technologies.

Of the available techniques for producing polymers, radical polymerization is one of the most widely used processes for the commercial production of high-molecular-weight polymers. Several controlled radical polymerization methods have previously been described, including nitroxide-mediated radical polymerization (NMP), atom transfer radical polymerization (ATRP) and reversible addition fragmentation chain transfer polymerization (RAFT). These techniques allow the facile synthesis of well-defined polymers that are diverse in both their structure and function.

The development of RAFT polymerization is described in the recent reviews Moad, G.; Rizzardo, E.; Thang, S. H. Accounts of Chemical Research 2008, 41, 1133 and Moad, G.; Rizzardo, E.; Thang, S. H. Polymer 2008, 49, 1079. The RAFT polymerization process requires the presence of a chain transfer agent (a chain transfer agent suitable for use in RAFT polymerization processes is sometimes referred to as a “RAFT agent”), an initiator and monomers, and is described by the following Scheme 1:

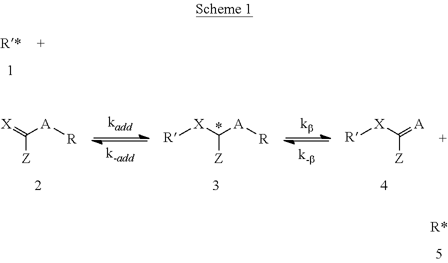

wherein, R and R′ are each a homolytic leaving group (i.e. the growing polymer chains) and R. and R′. must be able to re-initiate polymerization, Z is a group that modifies addition and fragmentation rates, X is, for example, S or CH₂, and A is, for example, S, CH₂ or O. Typically X and A are the same and are S or CH₂.

In a typical RAFT process, the propagating groups R′. (1) and R. (5), are presented with the option of reacting with an additional monomer to extend the chain, or with chain transfer agent (2 or 4). The control of the MWD of the resultant polymers from this process depends on the balance of the rates k_{add}, k_{-add}, k_{β} and k_{-β}.

Prior art RAFT polymerization processes typically involve preparing a solution of one or more monomers, a chain transfer agent and an initiator, such as 2,2′azobis(isopropionitrile) (AIBN). The solution is then heated to a temperature of at least about 60° C. to “activate” the initiator, and the solution maintained at the elevated temperature for an extended period of time, typically about 16 hours, to allow for polymerization to proceed. In the case of AIBN, the heat triggers decomposition, which releases nitrogen and forms two equivalents of an isopropionitrile radical. This isopropionitrile radical initiates radical polymerization of the monomer or monomers. Other initiators used in RAFT processes that are also activated by heat include: 1,1′-azobis(cyclohexanecarbonitrile), 2,2′-acobis(2-methylpropionamidine) dihydrochloride, and 4,4′azobis(4-cyanovaleric acid). The particular initiator selected will dictate to which temperature the reaction mixture needs to be heated to initiate radical polymerization of the monomer or monomers. Generally, a RAFT polymerization is heated to a temperature of about 60° C. to about 100° C. or higher.

Although prior art RAFT polymerization processes provide control over the MWD of the polymer products produced, these processes suffer from a number of limitations. For example, traditional RAFT processes require heating to initiate the reaction. Such processes are therefore not suitable for use with heat sensitive monomers or for the production of heat sensitive polymers. Also, heating large scale reaction mixtures (e.g. greater than 1 kg) is undesirable for a number of reasons, including the potential for uneven heat distribution, temperature lag, and the additional processing time required for allowing temperature adjustments (first to heat the bulk reaction mixture to reaction temperature and then to return the bulk reaction mixture to ambient after completion of the process). Another example of a drawback of traditional RAFT processes is that maintaining high temperatures of the reaction mixture may limit the length of polymer chain produced as a result of loss of end-group fidelity. In order to address these issues, some photo-controlled RAFT-like radical polymerization techniques have been previously investigated and described. These studies have been motivated in part by the desire to obtain the MWD advantages provided by the RAFT process without the need to heat the reaction mixture. These photocontrolled radical polymerizations proceed via a similar mechanism to that shown in Scheme 1, however, the source of the initiating radical is provided not by the thermal decomposition of an initiator, but by either direct photolysis of a RAFT agent under high-energy light (e.g. 350 nm; 8 W) or by replacing the heat activated initiator with a photo-initiator (i.e. a compound that decomposes upon exposure to light to provide an initiating radical species). These photoinitiated RAFT processes do not require heat activation, and therefore allow for the synthesis of polymers from heat sensitive monomers, such as N-isopropyl acrylamide (NIPAM). However, these photoinitiated processes suffer from various limitations. For example, the use of high energy light (e.g. UV light) often causes the loss of end group fidelity as a result of photolysis of the RAFT end group from the living polymer chain and the use of photo-initiators generally results in about 5-10% dead chains (non-functional polymers).

The present invention provides a process for forming a polymer in which the commencement of the polymerization process and the subsequent polymerization steps can be photoregulated. In at least preferred embodiments, the process described herein provides the benefits of RAFT polymerization with the added advantage of temporal control by light. The inventors have termed this photo-controlled polymerization technique: photoinduced electron transfer—reversible addition fragmentation chain transfer (PET-RAFT) polymerization.

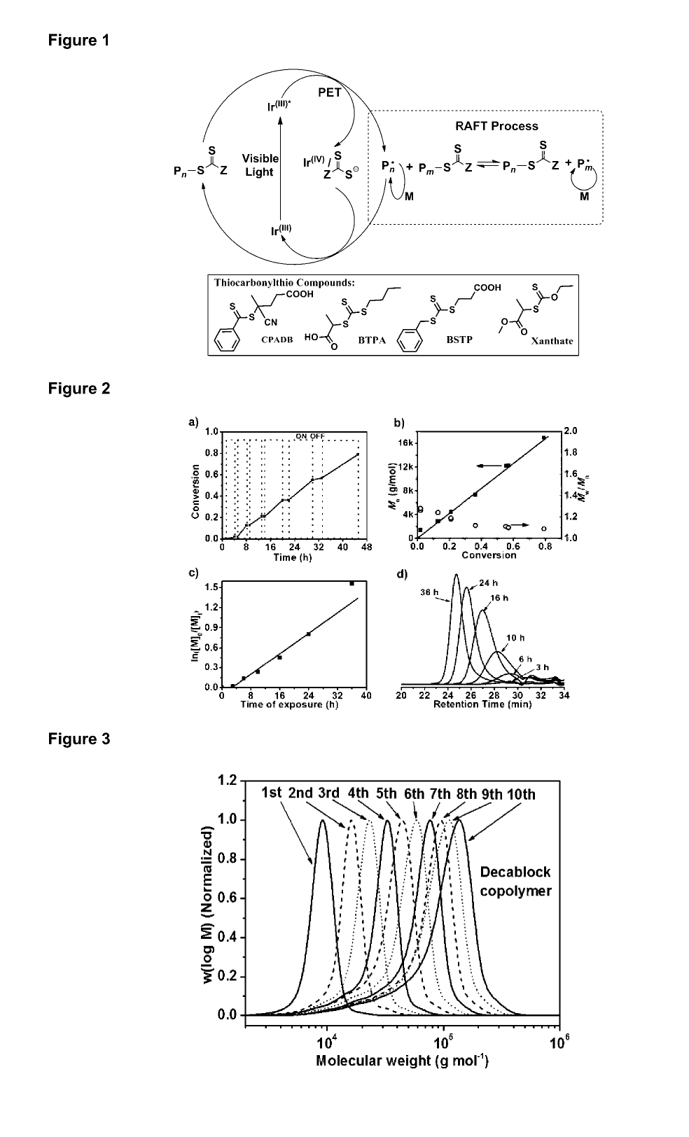

Without wishing to be bound by theory, the inventors have proposed the mechanism for PET-RAFT polymerization as depicted in FIG. 1. As shown in FIG. 1, a photoredox catalyst (e.g., fac-[Ir(ppy)₃], Ir^{(III)})exposed to light generates an excited species (Ir^{(III)*}), which is able to reduce an initiator, e.g. a thiocarbonylthio compound as depicted in FIG. 1, by photoinduced electron transfer (PET) resulting in the production of radical (Pₙ^{}) and an Ir^{(IV)} species. In the mechanism shown in FIG. 1, the thiocarbonylthio compound acts as both a chain transfer agent and an initiator. The radical (Pₙ^{}) can initiate polymerization of the monomer (M) and the RAFT process or react with Ir^{(IV)} to deactivate and regenerate Ir^{(III)}, which will restart the catalytic cycle. In this way, continuous exposure to light causes continuous initiation of radical polymerization of the monomer. A similar mechanism is proposed for other photoredox catalysts, such as Ru(bpy)₃Cl₂, as shown in FIG. 20, and for Chlorophyll a, as shown in FIG. 54. The photoredox catalyst can be selected so that the PET-RAFT mechanism occurs using a low energy visible light source at relatively low temperatures. This may advantageously allow the production of various temperature sensitive polymer products, or facilitate polymerization of temperature sensitive starting materials. In addition, in some embodiments, the process may be carried out using a compound that is able to act as both an initiator and a chain transfer agent. In such embodiments, the process can be carried out without the addition of further initiators. This is advantageous as it is believed that an overabundance of radical initiators promotes the formation of dead polymers. Moreover, the process may be performed with a very low amount of catalyst (few ppm).

Molecular weight distribution (MWD) or polydispersity is commonly described by the ratio of the weight average molecular weight (M_{w}) to the number average molecular weight (Mₙ), i.e. M_{w}/Mₙ. For an ideal polymerization, the M_{w}/Mₙ of the resultant polymer is equal to 1. In one embodiment of the present invention, the M_{w}/Mₙ is between 1.0 and about 1.8. More preferably, the M_{w}/Mₙ is between 1.0 and about 1.5 or between 1.0 and about 1.2. In one embodiment, the M_{w}/Mₙ is about 1.01 to about 1.25, about 1.01 to about 1.23, about 1.05 to about 1.23 or about 1.05 and about 1.2.

As discussed above, WO 2013/148722 A1 describes the polymerization of methacrylate monomers in a process employing the photoredox catalyst fac-[Ir(ppy)₃] and an alkyl halide. The process described in WO 2013/148722 A1 is an example of photoinitiated ATRP. The PET-RAFT polymerization process of the present invention can advantageously provide superior MWD of the product polymer relative to the polymerization process described in WO 2013/148722 A1. The superior MWD of product polymer provided by the process of the present invention is believed to be due to the role of the chain transfer agent in addition to the control of the polymerization process provided by the photoredox catalyst. In addition, the process of the present invention can be carried out with lower catalyst loadings and works for a much broader array of monomer types than the process described in WO 2013/148722 A1.

Unlike traditional RAFT polymerization, the process of the present invention is mediated or regulated by light which allows for greater control over the polymerization process. As seen in FIG. 2(a), the reaction proceeds when exposed to light, indicated by the boxes marked “ON”, and when the reaction is not exposed to light, the reaction is suspended or stopped, indicated by the gaps marked “OFF”. The ability to switch on and off a reaction allows temporal control of the reaction. In this way, exposure of the mixture comprising a monomer, an initiator, a chain transfer agent and a photoredox catalyst to light reversibly activates radical polymerization of the monomer.

The temporal control of the polymerization process provided by the process of the present invention may allow easier access to more complex products, such as gradient co-polymers and gradient block co-polymers. These more complex products may be produced, for example, by timing the “ON” or “OFF” light signal while changing the monomer mix present in the reaction mixture. It will be appreciated that in some embodiments, the withdrawal of light may not completely stop the radical polymerization reaction; however, when the reaction mixture is not exposed to light the rate of reaction is reduced relative to when the reaction mixture is exposed and, preferably, the reaction stops completely.

The photo-control of the polymerization process provided by the process of the present invention is particularly advantageous for large scale processes. For large scale processes (e.g. above 100 g scale to industrial kilogram scales) control over traditional thermal controlled processes is difficult due to factors such as temperature lag and temperature distribution through large mixture volumes. For a photo-controlled process, the “ON” or “OFF” signal would be faster for such larger mixtures, providing greater control over the polymerization process in large scale processes.

The process of the present invention is preferably conducted with low energy light. In one embodiment, the light intensity (energy provided over unit area) is less than about 10 W/cm², preferably less than about 5 W/cm², for example the light intensity may be about 0.001 W/cm² to about 10 W/cm². As further described below, the energy of the light will depend in part on the photoredox catalyst selected and the degree to which the light may penetrate the reaction mixture.

Each of the components of the reaction will now be described.

### Photoredox Catalyst

In the process of the present invention, the polymerization is initiated by activation of a photoredox catalyst. As is known in the art, a catalyst is a substance that increases the rate of reaction while not being consumed by the reaction. A photoredox catalyst is a catalyst that, when exposed to light, is able to cause oxidation or reduction of another compound. The photoredox catalyst will also be oxidized or reduced as a result of this process (i.e. when the other compound is oxidized or reduced, the photoredox catalyst will be reduced or oxidized). The photoredox catalyst used in the process of the present invention may be any photoredox catalyst that, when exposed to light, is capable of producing a species that is capable of triggering or initiating radical polymerization of the monomer, for example by causing the initiator to form a radical which can initiate radical polymerization of the monomer.

In one embodiment, the catalyst is a metal photoredox catalyst. For a review of photoredox catalysts see Narayanam, J. M. R.; et al.; Chemical Society Reviews 2011, 40, 102 and Nicewicz, D. A. et al.; Science, 2008, 322, 77.

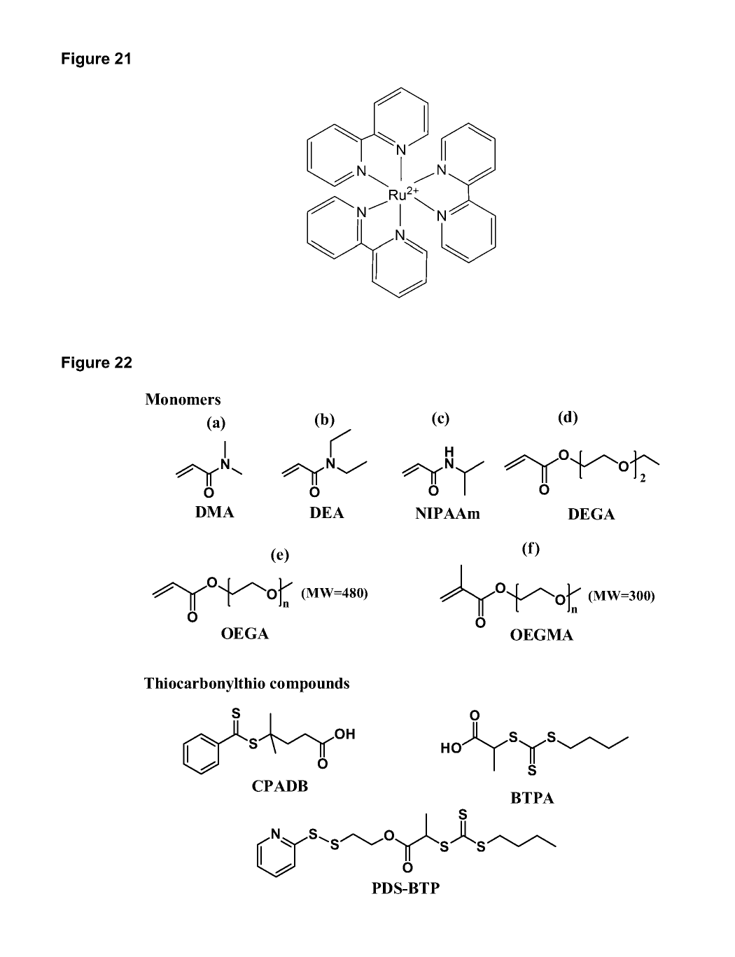

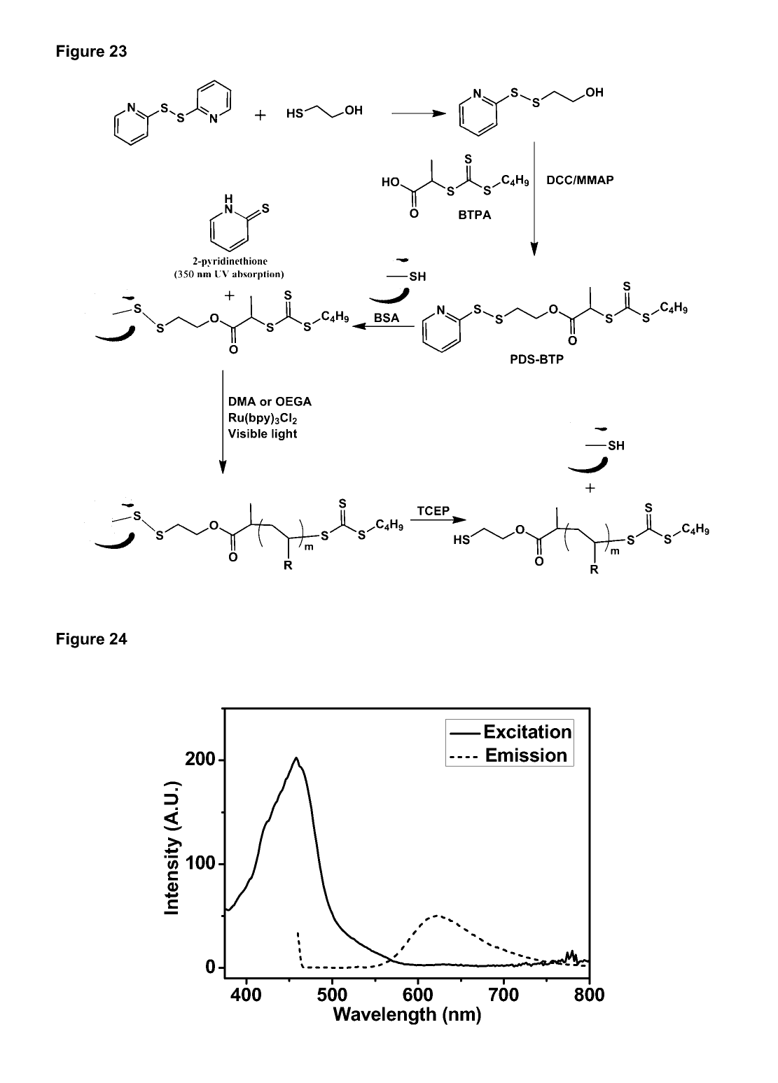

In one embodiment, the photoredox catalyst is selected from the group consisting of transition metal complexes. In one embodiment, the photoredox catalyst is fac-Ir(ppy)₃. Other photoredox catalysts that may be used include, but are not limited to, those shown in FIG. 18. In one embodiment, the photoredox catalyst is a complex of a transition metal selected from the group consisting of Ir, Ru, Cr, Co, Fe, Rh, Mn, Pt, Pd, Os, Eu, Cu, Al, Ti, Zn and Cd. Preferably the photoredox catalyst is a complex comprising Ir or Ru. Photoredox catalysts can include structures of the type ML¹L²L³, where M is a transition metal selected from the group consisting of Ir, Ru, Cr, Co, Fe, Rh, Mn, Pt, Pd, Os, Eu, Cu, Al, Ti, Zn and Cd, and L¹, L² and L³ are the same or different and are selected from the ligands shown in FIG. 19. In one embodiment, the photoredox catalyst is tris(2,2′-bipyridyl)ruthenium dichloride (Ru(bpy)₃Cl₂) (the Ru(bpy)₃²⁺ cation is shown in FIG. 21 and the bipyridyl (bpy) ligand is shown in FIG. 19) or a solvate thereof, e.g. a hydrate thereof (the structure of tris(2,2′-bipyridyl)ruthenium dichloride hexahydrate is shown in FIG. 18).

In one embodiment, the photoredox catalyst is an organo-photocatalyst. Suitable organo-photocatalysts include fluorescein, perylene, nile red, eosin (e.g. eosin Y), rhodamine 6G, a porphyrin (metal bound or free) and derivatives thereof or a salt thereof. Preferably, the organo-photocatalyst is activated using visible light. In one embodiment, the organo-photocatalyst is selected from fluorescein, eosin and a salt thereof.

In one embodiment, the photoredox catalyst is a photo-biocatalyst. For example, the photo-biocatalyst may be a chlorophyll, such as chlorophyll a (Chl a), chlorophyll b (Chl b), chlorophyll c (Chl c) or chlorophyll d (Chl d). The photo-biocatalyst may be obtained from natural sources, for example, Chl a may be isolated from spinach (Example 8). Advantageously, the chlorophyll can be obtained from renewal sources and is non-toxic. In contrast, many transition metal photocatalysts are expensive and/or toxic. As a result of the toxicity of these catalysts, for some applications of polymers prepared using such catalysts, the catalyst must be removed from the resultant polymer incurring additional processing costs.

The photoredox catalyst is typically used in sub-stoichiometric amounts. The photoredox catalyst may, for example, be present in the mixture in an amount of about 0.1 to about 10 ppm relative to the monomer. In one embodiment, the photoredox catalyst is present in the mixture in an amount of less than about 5 ppm relative to the monomer, preferably less than about 4, about 3, about 2 or about 1 ppm, most preferably, the photoredox catalyst is present in an amount of about 1 ppm relative to the monomer. In one embodiment, the photoredox catalyst is present in the mixture in an amount of 0.1 ppm to about 10 ppm relative to the monomer, e.g. about 0.1 ppm to about 5 ppm, about 0.1 ppm to about 4 ppm, about 0.1 ppm to about 3 ppm, about 0.1 ppm to about 2 ppm, or about 0.5 ppm to about 1.5 ppm, relative to the monomer. In one embodiment, the photoredox catalyst is present in the mixture in an amount of about 0.0000001 mol % to about 0.1 mol % (e.g. about 0.0000001 mol % to about 0.005 mol %, or about 0.000001 to about 0.005 mol %) relative to the monomer. The photoredox catalyst may, for example, be present in the mixture in an amount of less than about 0.005 mol %, about 0.003 mol %, about 0.001 mol %, about 0.0005 mol %, about 0.00025 mol %, about 0.00015 mol %, about 0.0003 mol %, about 0.0001 mol %, about 0.00005 mol %, about 0.000025 mol %, about 0.000015 mol % or about 0.00001 mol % relative to the monomer. In some embodiments, the photoredox catalyst is present in the mixture in an amount of about 0.0000001 to about 0.005 mol %, about 0.0000001 to about 0.003 mol %, about 0.0000001 to about 0.0005 mol %, about 0.000001 to about 0.005 mol %, about 0.000001 to about 0.003 mol %, about 0.000001 to about 0.0005 mol %, about 0.00001 to about 0.003 mol %, or about 0.00001 to about 0.0005 mol %, relative to the monomer.

In one embodiment, the photoredox catalyst is present in the mixture in an amount of about 0.001 to about 15 mol % relative to the initiator (e.g. about 0.001 to about 5 mol % relative to the initiator). The photoredox catalyst may, for example, be present in the mixture in an amount of less than about 5 mol %, about 1.0 mol %, about 0.5 mol %, about 0.4 mol %, about 0.3 mol %, about 0.2 mol %, about 0.15 mol %, about 0.1 mol %, about 0.05 mol %, about 0.04 mol %, about 0.03 mol %, about 0.02 mol % or about 0.01 mol % relative to the initiator. In some embodiments, the photoredox catalyst is present in the mixture in an amount of about 0.001 to about 1.0 mol %, about 0.001 to about 0.5 mol %, about 0.001 to about 0.1 mol %, about 0.01 to about 1.0 mol %, about 0.01 to about 0.5 mol %, or about 0.01 to about 0.1 mol %, relative to the initiator.

The light may be any light having a wavelength effective to excite the photoredox catalyst. Therefore, the wavelength of light will depend on the particular photoredox catalyst selected. In one embodiment, the wavelength of the light corresponds to an absorption maxima of the photoredox catalyst. However, any wavelength absorbed by the photoredox catalyst and effective to excite the photoredox catalyst may be used. The absorbance spectrum for the photoredox catalyst may be determined by UV-visible spectrometry. For example, as discussed in Example 8 below, Chl a possesses two absorption maxima in the visible range at 430 nm and 665 nm, and absorbs light in the regions of about 400 nm to about 480 nm and about 550 nm to about 680 nm. In Example 8, it is shown that exposure of the reaction mixture to light of different wavelength (red LED−λₘₐₓ=635 nm, and blue LED−λₘₐₓ=461 nm) corresponding to Chl a absorbing wavelengths is able to initiate radical polymerization, while exposure to light of a wavelength that is not absorbed by Chl a is not able to initiate radical polymerization (green LED−λₘₐₓ=530 nm). In one embodiment, the photoredox catalyst is activated by visible light. In one embodiment, the photoredox catalyst is activated by light having a wavelength in the range of about 400 nm to about 480 nm. In one embodiment, the light is provided by an LED. Preferably, the light source is of low energy intensity, for example, less than about 10 W/cm², more preferably, less than about 5 W/cm².

### Chain Transfer Agent

In one aspect, the present invention provides a process for preparing a polymer, comprising exposing a mixture comprising a monomer, an initiator, a chain transfer agent and a photoredox catalyst, to light, wherein exposing the mixture to light initiates radical polymerization of the monomer. In another aspect, the present invention provides a process of radical polymerization of a monomer, wherein the radical polymerization is carried out in the presence of a photoredox catalyst and a chain transfer agent. In these processes, the chain transfer agent (CTA) acts to control the polydispersity of the resultant polymer. In other words, the molecular weight distribution (or polydispersity) depends on the chain transfer agent (CTA).

Without wishing to be bound by theory, the inventors believe that the chain transfer agent controls the polydispersity of the polymer in a similar manner to traditional RAFT polymerization (described above in relation to Scheme 1). However, unlike traditional RAFT polymerization, in the process of the present invention, the polymerization reaction can be photoregulated. The control over molecular weight distribution (MWD) provided by the process of the present invention is evident in the experimentally determined MWDs disclosed herein (see, e.g. Example 1).

The chain transfer agent may be any compound which is capable of reacting with a growing polymer chain by a reaction in which the polymer chain is deactivated and a new growing polymer chain is generated.

In one embodiment, the chain transfer agent comprises a thiocarbonylthio group (i.e. —C(S)S—), or in other words, the chain transfer agent may be a thiocarbonylthio compound. Preferably the chain transfer agent comprises a dithioester group (—C(S)S—), a dithiocarbamate group (>NC(S)S—), a trithiocarbonate group (—SC(S)S—) or a xanthate group (—OC(S)S—).

In one embodiment, the chain transfer agent is a RAFT agent. Any RAFT agent compatible with the selected photoredox catalyst and matched to the selected monomer or monomers may be used. Some suitable RAFT agents are described in Moad, G.; Rizzardo, E.; Thang, S. H. Accounts of Chemical Research 2008, 41, 1133. The person skilled in the art will be able to select an appropriate RAFT agent for a particular monomer or monomers based on RAFT agents suitable for use in traditional RAFT polymerization processes.

In one embodiment, the chain transfer agent is a compound of formula (I):

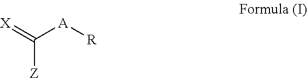

wherein:
X and A are independently selected from S or CH₂; preferably X and A are S;
Z is a group able to stabilize an intermediate radical species formed during the polymerization reaction at the carbon to which it is attached (e.g. radical 3 shown in Scheme 1 above), and confer the compound of formula (I) with appropriate reactivity toward propagation; and R is a hemolytic leaving group such that R. is capable of efficiently re-initiating polymerization. In some embodiments, Z is selected from optionally substituted aryl, optionally substituted heterocyclyl, optionally substituted -Oaryl, optionally substituted -Oheterocyclyl, optionally substituted —OC₁₋₂₀alkyl (e.g. optionally substituted —OC₁₋₆alkyl), optionally substituted —SC₁₋₂₀alkyl (e.g. optionally substituted —SC₁₋₆alkyl) and —NR⁴R⁵, wherein R⁴ and R⁵ are independently selected from C₁₋₄alkyl, aryl and heteroaryl. In some embodiments, Z is selected from optionally substituted aryl, optionally substituted heteroaryl, optionally substituted —OC₁₋₁₀alkyl (e.g. optionally substituted —OC₁₋₆alkyl), and optionally substituted —SC₁₋₁₀alkyl (e.g. optionally substituted —SC₁₋₆alkyl).

The choice of the CTA is important in the synthesis of low polydispersity polymers. The preferred CTAs give chain transfer with high chain transfer constants.

The transfer constant is defined as the ratio of the rate constant for chain transfer to the rate constant for propagation at zero conversion of monomer and CTA. If chain transfer occurs by addition-fragmentation, the rate constant for chain transfer (kₜᵣ) is defined as follows:

$${k}_{tr} = {k}_{add} \times \frac{{k}_{β}}{{k}_{- add} + {k}_{β}} \qquad Equation 1$$

where k_{add} is the rate constant for addition to the CTA and k_{-add} and k_{β} are the rate constants for fragmentation in the reverse and forward directions respectively (as defined in Scheme 1, above).

Preferably, the transfer constant for the addition-fragmentation chain transfer process is >0.1. The polydispersity obtained under a given set of reaction conditions is sensitive to the value of the transfer constant. Lower polydispersities will result from the use of reagents with higher transfer constants. For example, benzyl dithiobenzoate derivatives have transfer constants which are estimated to be >20 in polymerization of styrene or acrylate esters. Higher transfer constants also allow greater flexibility in the choice of reaction conditions. For reagents with low chain transfer constants, the use of feed addition is advantageous to obtain low polydispersities.

In one embodiment, the CTA is a compound comprising a thiocarbonylthio moiety, i.e. the CTA is a thiocarbonylthio compound. The thiocarbonylthio compound may, for example, be a compound of formula (I) wherein X and A are both S with other variables as defined above, or a compound of formula (II′) as defined below.

In one embodiment, the CTA is a compound comprising a thiol. Suitable thiol compounds include substituted thiols, such as mercaptoethanol, mercaptopropionic acid, etc., and disulphide compounds and salts thereof.

In one embodiment, the chain transfer agent is present in the mixture in an amount of about 0.0005 to about 10 mol % relative to the monomer. The chain transfer agent may, for example, be present in the mixture in an amount of less than about 10 mol %, about 6 mol %, about 4 mol %, about 3 mol %, about 2 mol %, about 1.5 mol %, about 1 mol %, about 0.6 mol %, about 0.05 mol %, about 0.025, about 0.01, about 0.009, about 0.006, or about 0.005 mol % relative to the monomer. In some embodiments, the chain transfer agent is present in the mixture in an amount of about 0.0005 to about 10 mol %, about 0.0005 to about 5 mol %, about 0.0005 to about 3 mol %, about 0.0005 to about 1 mol %, about 0.0005 to about 0.6 mol %, about 0.0005 to about 0.05 mol %, about 0.005 to about 5 mol %, about 0.005 to about 1 mol %, about 0.05 to about 5 mol %, or about 0.05 to about 1 mol %, relative to the monomer. The chain transfer agent may, for example, be present in an amount such that the molar ratio of chain transfer agent:initiator is from about 1:0.1 to about 1:1. The chain transfer agent may, for example, be present in an amount such that the molar ratio of chain transfer agent:photoredox catalyst is from about 1:0.00001 to about 1:1.

The inventors have found that thiocarbonylthio compounds are effective in controlling the molecular weight distribution of polymers produced by a photocontrolled radical polymerization process catalyzed by a photoredox catalyst.

Accordingly, in one aspect, the present invention provides a process for producing a polymer, comprising exposing a mixture comprising a monomer, a thiocarbonlythio compound, an initiator and a photoredox catalyst, to light, wherein exposing the mixture to light initiates radical polymerization of the monomer. In some embodiments, the thiocarbonylthio compound may act as an initiator as described below. In such embodiments, it is not necessary to include in the mixture an initiator in addition to the thiocarbonylthio compound.

Suitable thiocarbonylthio compounds include compounds of formula (II′) as defined below. The thiocarbonylthio compound may be present in the mixture in an amount of less than about 10 mol %, about 6 mol %, about 4 mol %, about 3 mol %, about 2 mol %, about 1.5 mol %, about 1 mol %, about 0.6 mol %, about 0.05 mol %, about 0.025 mol %, about 0.01 mol %, about 0.009 mol %, about 0.006 mol %, or about 0.005 mol % relative to the monomer. In some embodiments, the thiocarbonylthio compound is present in the mixture in an amount of about 0.0005 to about 10 mol %, about 0.0005 to about 5 mol %, about 0.0005 to about 3 mol %, about 0.0005 to about 1 mol %, about 0.0005 to about 0.6 mol %, about 0.0005 to about 0.05 mol %, about 0.005 to about 5 mol %, about 0.005 to about 1 mol %, about 0.05 to about 5 mol %, or about 0.05 to about 1 mol %, relative to the monomer.

### Initiator

The initiator may be any compound capable, in the presence of the photo-redox catalyst when exposed to light, of generating a radical which can initiate radical polymerization of the monomer.

The initiator and photoredox catalyst are selected such that excitation of the photoredox catalyst is able to cause the initiator to form a radical which can initiate radical polymerization of the monomer. The photoredox catalyst, when exposed to light, may oxidise or reduce the initiator to form the radical which can initiate radical polymerization of the monomer.

In the proposed mechanism for PET-RAFT polymerization depicted in FIG. 1, the initiator is reduced by photoinduced electron transfer to produce a reactive radical species. After the first cycle, the radical is located at one end of a propagating polymer chain. Without wishing to be bound by theory, it is believed that the propagating polymer chain may be quenched by an unstable, or metastable, intermediate of the photoredox catalyst to return the photocatalyst to its unactivated state, and restart the catalytic cycle. For example, as depicted in FIG. 1, it is believed for fac-Ir(ppy)₃ that, following photoexcitation of the Ir(III) catalyst, the Ir(III)* reduces the initiator to form a reactive radical species and the reactive radical species may then react with a monomer to form the propagating polymer chain, Pₙ^{}. A similar process occurs to release the propagating chain from the CTA. The propagating polymer chain Pₙ^{} may be quenched by the Ir(IV) species, returning the photoredox catalyst to the Ir(III) state. When the reaction mixture is exposed to light, this process repeats, possibly with intervening RAFT cycles; however, when the reaction mixture is not exposed to light, it is believed that the quenching of the propagating polymer chain by the Ir(IV) species stops the radical polymerization reaction. This proposed mechanism suggests that photocontrol is provided at two points: the photoinduced electron transfer step required to initiate the reaction and release the propagating polymer chain from the CTA, and also the quenching step. Consequently, each catalytic cycle involves an initiation step, thus exposure to light continuously initiates radical polymerization of the monomer.

In one embodiment, the initiator is reduced by the photoredox catalyst to form the initiating radical.

The initiator may, for example, be an organic halide. The initiator may, for example, be a compound comprising an alkyl halide or pseudo halide. Alkyl halides include alkyl bromides. As discussed below, the initiator may be a compound of formula (I′) or (II′) as defined below.

In one embodiment, the initiator is a thiol compound.

In one embodiment, the initiator is present in the mixture in an amount of about 0.0005 to about 10 mol % relative to the monomer. The initiator may, for example, be present in the mixture in an amount of less than about 10 mol %, about 6 mol %, about 4 mol %, about 3 mol %, about 2 mol %, about 1.5 mol %, about 1 mol %, about 0.6 mol %, about 0.05 mol %, about 0.025, about 0.01, about 0.009, about 0.006, or about 0.005 mol % relative to the monomer. In some embodiments, the initiator is present in the mixture in an amount of about 0.0005 to about 10 mol %, about 0.0005 to about 5 mol %, about 0.0005 to about 3 mol %, about 0.0005 to about 1 mol %, about 0.0005 to about 0.6 mol %, about 0.0005 to about 0.05 mol %, about 0.005 to about 5 mol %, about 0.005 to about 1 mol %, about 0.05 to about 5 mol %, or about 0.05 to about 1 mol %, relative to the monomer.

### Combined Initiator and Chain Transfer Agent (or PET-RAFT Agent)

In one embodiment, a single compound may act as both the initiator and the chain transfer agent. Such a compound is referred to herein as a PET-RAFT agent. Accordingly, in one embodiment, the present invention provides a process for preparing a polymer, comprising exposing a mixture comprising a monomer, a photoredox catalyst and a compound able to act as an initiator and a chain transfer agent (i.e. a PET-RAFT agent), to light, wherein exposing the mixture to light initiates radical polymerization of the monomer. In another embodiment, the present invention provides a process of radical polymerization of a monomer, wherein the radical polymerization is carried out in the presence of a photoredox catalyst and a PET-RAFT agent.

The use of a single compound as initiator and chain transfer agent simplifies the process, in terms of preparation and/or purification of the resultant mixture.

When the mixture comprises a PET-RAFT agent, it is not necessary to include in the mixture an additional initiator in addition to the PET-RAFT agent. Accordingly, in some embodiments, the mixture does not comprise an initiator that is not able to act as a chain transfer agent. In some embodiments, the mixture does not comprise an alkyl halide or pseudo halide.

In another embodiment, the present invention provides a composition comprising a monomer, a PET-RAFT agent and a photoredox catalyst, wherein exposing the composition to light initiates radical polymerization of the monomer. In another embodiment, the present invention provides a polymerization system comprising a monomer, a PET-RAFT agent and a photoredox catalyst, wherein exposure to light initiates radical polymerization of the monomer.

In one embodiment, the combined initiator and chain transfer agent (the PET-RAFT agent) may be a compound of formula (I) described above, wherein R is a moiety which, as a free radical, is capable of initiating a radical polymerization reaction. That is to say, in one embodiment, the initiator and chain transfer agent is a compound of formula (I′):

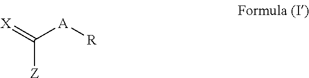

wherein:
X and A are independently selected from S or CH₂; preferably X and A are both S;
Z is a group selected to stabilize an intermediate radical species formed during the polymerization reaction at the carbon to which it is attached, and confer the compound of formula (I′) with appropriate reactivity toward propagation; Z may, for example, be selected from optionally substituted aryl, optionally substituted heterocyclyl, optionally substituted -Oaryl, optionally substituted -Oheterocyclyl, optionally substituted —OC₁₋₂₀alkyl (e.g. optionally substituted —OC₁₋₆alkyl), optionally substituted —SC₁₋₂₀alkyl (e.g. optionally substituted —SC₁₋₆alkyl) and —NR⁴R⁵, wherein R⁴ and R⁵ are independently selected from C₁₋₄alkyl, aryl and heteroaryl; and
R is a moiety which, as a free radical, is capable of initiating radical polymerization of the monomer; R may, for example, be —CR¹R²R³, wherein R¹, R² and R³ are independently selected from H, cyano, optionally substituted C₁₋₄alkyl, optionally substituted aryl, optionally substituted heteroaryl and optionally substituted carboxyl.

In one embodiment, the initiator and chain transfer agent is a compound of formula (I′) as defined above, wherein Z is selected from optionally substituted aryl, optionally substituted heteroaryl, optionally substituted —OC₁₋₂₀alkyl (e.g. optionally substituted —OC₁₋₆alkyl), and optionally substituted —SC₁₋₂₀alkyl (e.g. optionally substituted —SC₁₋₆alkyl).

In one embodiment, the combined initiator and chain transfer agent is a compound of formula (I′) as defined above, wherein Z is selected from optionally substituted aryl, optionally substituted heterocyclyl, optionally substituted -Oaryl, optionally substituted -Oheterocyclyl, optionally substituted —OC₁₋₁₅alkyl, optionally substituted —SC₁₋₁₅alkyl and —NR⁴R⁵, wherein R⁴ and R⁵ are independently selected from C₁₋₄alkyl, aryl and heteroaryl. In another embodiment, the initiator and chain transfer agent is a compound of formula (I′) as defined above, wherein Z is selected from optionally substituted aryl, optionally substituted heterocyclyl, optionally substituted -Oaryl, optionally substituted -Oheterocyclyl, optionally substituted —OC₁₋₆alkyl, optionally substituted —SC₁₋₆alkyl and —NR⁴R⁵, wherein R⁴ and R⁵ are independently selected from C₁₋₄alkyl, aryl and heteroaryl.

In one embodiment, at least one or R¹, R² and R³ may be a group capable of stabilizing a free radical formed at the carbon atom to which R¹, R² and R³ are attached. For example, at least one or R¹, R² and R³ may be an electron withdrawing group selected from nitrile and optionally substituted carboxyl, or at least one or R¹, R² and R³ may be a group capable of resonance stabilization, such as optionally substituted aryl, or inductive stabilization, such as optionally substituted C₁₋₄alkyl. In one embodiment, the initiator and chain transfer agent is a compound of formula (I′) as defined above, wherein R is —CR¹R²R³ wherein R¹, R² and R³ are independently selected from H, cyano, methyl, phenyl, —COOH and —COOEt, and wherein at least one of R¹, R² and R³ is not H. In one embodiment, the initiator and chain transfer agent is a compound of formula (I′) as defined above, wherein R is —CR¹R²R³, and two or more of R¹, R² and R³ are independently selected from cyano, optionally substituted C₁₋₄alkyl, optionally substituted aryl, optionally substituted heteroaryl and optionally substituted carboxyl. In one embodiment, none of R¹, R² and R³ are H. In another embodiment, one or two of R¹, R² and R³ are H.

Thiocarbonylthio compounds may act as initiator and chain transfer agent. For example, the thiocarbonylthio compound may be a compound of formula (II′):

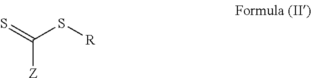

wherein:
Z is selected from optionally substituted aryl, optionally substituted heterocyclyl, optionally substituted -Oaryl, optionally substituted -Oheterocyclyl, optionally substituted —OC₁₋₂₀alkyl (e.g. optionally substituted —OC₁₋₆alkyl), optionally substituted —SC₁₋₂₀alkyl (e.g. optionally substituted —SC₁₋₆alkyl) and —NR⁴R⁵, wherein R⁴ and R⁵ are independently selected from C₁₋₄alkyl, aryl and heteroaryl; and
R is a moiety which, as a free radical, is capable of initiating polymerization of the monomer; R may, for example, be —CR¹R²R³, wherein R¹, R² and R³ are independently selected from H, cyano, optionally substituted C₁₋₄alkyl, optionally substituted aryl, optionally substituted heteroaryl and optionally substituted carboxyl.

In one embodiment, the initiator and chain transfer agent is a compound of formula (II′) as defined above, wherein Z is selected from optionally substituted aryl, optionally substituted heteroaryl, optionally substituted —OC₁₋₂₀alkyl (e.g. optionally substituted —OC₁₋₆alkyl), and optionally substituted —SC₁₋₂₀alkyl (e.g. optionally substituted —SC₁₋₆alkyl). In one embodiment, the initiator and chain transfer agent is a compound of formula (II′) as defined above, wherein R is —CR¹R²R³, wherein R¹, R² and R³ are independently selected from H, cyano, methyl, phenyl, —COOH and —COOEt, and wherein at least one of R¹, R² and R³ is not H.

In one embodiment, the combined initiator and chain transfer agent is a thiocarbonylthio compound selected from:

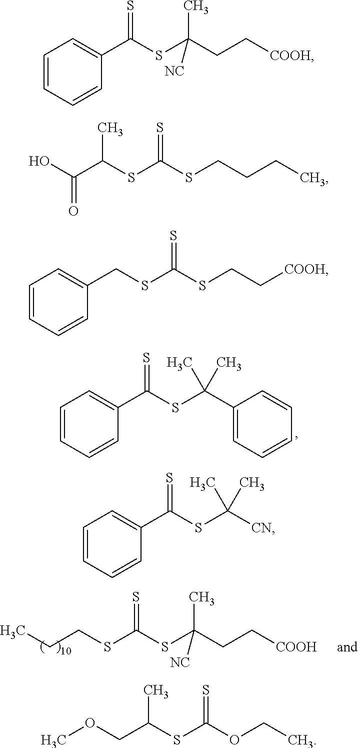

In one embodiment, the combined initiator and chain transfer agent is a compound comprising a thio group. Suitable thiol compounds include mercaptoethanol, mercaptopropionic acid, C₁₋₁₈alkylthiol (e.g. butanethiol and octanethiol), aminoC₁₋₁₈alkylthiol (e.g. 2-aminoethanethiol), and disulphide compounds, such as mercaptopropionic acid disulphide and hydroxyethyldisulfide, or a salt thereof.

In one embodiment, the combined initiator and chain transfer agent is a macroinitiator comprising a moiety capable of acting as a chain transfer agent. A macroinitiator is macromolecule capable of initiating a polymerization reaction. The macroinitiator may comprise a biomolecular moiety, e.g., a protein, within its structure. A macroinitiator comprising a moiety capable of acting as a chain transfer agent may be used as the combined initiator and chain transfer agent.

In one embodiment, the combined initiator and chain transfer agent is a macroinitiator of formula (I′), wherein at least one of R or Z is a macromolecular moiety and R and Z are otherwise as defined above, and X and A are as defined above. In one embodiment, R is a macromolecular moiety, and Z, X and A are as defined above. In another embodiment, Z is a macromolecular moiety, and R, X and A are as defined above. In embodiments where Z or R is a macromolecular moiety, the process of the present invention can be used to prepare a polymer bound to a macromolecular moiety as described below in more detail in relation to polymer bioconjugates.

In one embodiment, the macroinitiator is a macroinitiator which comprises a thiocarbonylthio moiety. In one embodiment, the macromolecular moiety is a protein, for example, bovine serum albumin. In another embodiment, the macromolecular moiety is a poly-nucleaic acid, which may be DNA or RNA, e.g. the macromolecular moiety may be a short-interfering RNA (siRNA) strand. In another embodiment, the macromolecular moiety is a polymer, for example, a linear polymer, block co-polymer or star polymer. Preferably, when the macromolecular moiety is a polymer, the polymer has a molecular weight of about 2500 g/mol to about 2000000 g/mol, e.g. about 2500 g/mol to about 1500000 g/mol, about 2500 g/mol to about 1000000 g/mol, or about 3000 g/mol to about 750000 g/mol.

The combined initiator and chain transfer agent (i.e. the PET-RAFT agent) is preferably present in an amount sufficient to provide a suitable rate of polymerization, i.e. the reaction rate is not too fast such that the creation of dead polymer chains predominates and not too slow such that negligible polymerization occurs. In one embodiment, the PET-RAFT agent is present in the mixture in an amount of about 0.0005 to about 10 mol % relative to the monomer. In some embodiments, the PET-RAFT agent is present in the mixture in an amount of about 0.0005 to about 10 mol %, about 0.0005 to about 5 mol %, about 0.0005 to about 3 mol %, about 0.0005 to about 1 mol %, about 0.0005 to about 0.6 mol %, about 0.0005 to about 0.05 mol %, about 0.005 to about 5 mol %, about 0.005 to about 1 mol %, about 0.05 to about 5 mol %, or about 0.05 to about 1 mol %, relative to the monomer. In one embodiment, the combined initiator and chain transfer agent is present in an amount of about 0.05 to about 1.5 mol % relative to the monomer. The combined initiator and chain transfer agent may, for example, be present in an amount of about 1 mol % relative to the monomer, preferably about 0.9 mol %, about 0.8 mol %, about 0.7 mol %, about 0.6 mol %, or about 0.5 mol % relative to the monomer. In one embodiment, the combined initiator and chain transfer agent is present in an amount of about 0.001 mol % to about 1 mol % relative to the monomer. In one embodiment, the combined initiator and chain transfer agent is present in a concentration of less than about 0.1 M.

### Monomer

A variety of monomers may be used in the process. One advantage of the process of the present invention is that a wide variety of monomer types are compatible with the process, and hence a wide variety of polymers of simple or complex architectures may be produced by this process. Any monomer or combination of monomers which can form a polymer in a radical polymerization reaction can be used in the process of the present invention. For example, any monomer types that may be used in a traditional FRET process, i.e. monomers that are capable of participating in a radical polymerization process, react with the initiator and form a propagating polymer chain after reacting with the initiator and each successive monomer addition, may be used in the process of the present invention. As the process of the present invention can be carried out at and below ambient temperature, temperature sensitive monomer types and monomers that link together to form temperature sensitive polymers may be used.

Monomers which may be used in the process of the present invention include those with the general structure:

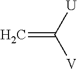

wherein:
U is selected from the group consisting of hydrogen, halogen and optionally substituted C₁-C₄ alkyl, wherein the optional substituents are independently selected from the group that consists of hydroxy, —OR″, carboxy, —O₂CR″ and —CO₂R″;
V is selected from the group consisting of hydrogen, R″, CO₂H, CO₂R″, COR″, CN, CONH₂, CONHR″, CONR″₂, O₂CR″, OR″ and halogen; and
R″ is selected from the group consisting of optionally substituted C₁-C₁₈ alkyl, optionally substituted C₂-C₁₈ alkenyl, optionally substituted aryl, optionally substituted heterocyclyl, optionally substituted aralkyl and optionally substituted alkaryl, wherein the optional substituents are independently selected from the group that consists of epoxy, hydroxy, alkoxy, acyl, acyloxy, carboxy (and salts thereof), sulfonic acid (and salts thereof), alkoxy- or aryloxycarbonyl, isocyanato, cyano, silyl, halo, and dialkylamino. Optionally, the monomers are selected from the group consisting of maleic anhydride, N-alkylmaleimide, N-arylmaleimide, dialkyl fumarate and cyclopolymerizable monomers. Monomers of the general structure CH₂=CUV include acrylate and methacrylate esters, acrylic and methacrylic acid, styrene, acrylamide, methacrylamide and methacrylonitrile. A combination of one or more monomers of the general structure CH₂=CUV with other monomers may be used. As one skilled in the art would recognize, the choice of comonomers is determined by their steric and electronic properties. The factors which determine copolymerizability of various monomers are well documented in the art. For example, see: Greenley, in Polymer Handbook 3rd Edition (Brandup, and Immergut, E. H Eds.) Wiley: New York, 1989 p 11/53.

In some embodiments, the mixture comprises one monomer, e.g. methacrylate. In other embodiments, the reaction mixture comprises two or more different monomers.

The monomer may, for example be: methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methystyrene, methyl acrylate, ethyl acrylate, propyl acrylate (all isomers), butyl acrylate (all isomers), 2-ethylhexyl acrylate, isobornyl acrylate, acrylic acid, benzyl acrylate. phenyl acrylate, acrylonitrile, styrene, functional methacrylates, acrylates and styrenes selected from glycidyl methacrylate, 2-hydroxyethyl methacrylate, hydroxypropyl methacrylate (all isomers), hydroxybutyl methacrylate (all isomers), N,N-dimethylaniinoethyl methacrylate, N,N-diethylaminoethyl methacrylate, triethyleneglycol methacrylate, di(ethylene glycol) ethyl ether acrylate (DEGA), oligo(ethyleneglycol) methyl ether methacrylate (OEGMA, e.g. Mₙ=300), oligo(ethyleneglycol) methyl ether acrylate (OEGA, e.g. Mₙ=480), itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethylacrylamide (DMA), N-ethylacrylamide, N,N-diethylacrylamide (DEA), N-tert-butylmethacrylamide, N-n-butylmethacrylamide, N-methylolmethacrylamide, N-ethylolmethacrylamide, hydroxypropylmethacrylamide, N-tert-butylacrylamide, N-n-butylacrylamide, N-methylolacrylamide, N-ethylolacrylamide, N-isopropylacrylamide (NIPAAm), vinyl benzoic acid (all isomers), diethylaminostyrene (all isomers), alpha-methylvinyl benzoic acid (all isomers), diethylamino alpha-methylstyrene (all isomers). p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilyipropylmethacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilyipropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, vinyl pivalate, dimethyl vinylphosphonate, butadiene, isoprene, chloroprene, vinyl difluoride, tetrafluoroethylene, vinyl chloride, vinyl dichloride, or a combination thereof. Preferred monomers include methyl methacrylate, di(ethylene glycol) ethyl ether acrylate (DEGA), oligo(ethyleneglycol) methyl ether methacrylate, N-isopropylacrylamide (NIPAAm), N,N-dimethylacrylamide (DMA), N,N-diethylacrylamide (DEA), hydroxypropylmethacrylamide, styrene and vinyl acetate, or a combination thereof.

The substituents on groups referred to above for U, V, R″ in the monomer do not take part in the polymerization reactions but form part of the polymer chains and may be capable of subsequent chemical reaction. The low polydispersity polymer containing any such reactive group is thereby able to undergo further chemical transformation, such as being joined with another polymer chain. Suitable reactive substituents include: epoxy, hydroxy, alkoxy, acyl, acyloxy, carboxy (and salts), sulfonic acid (and salts), alkylcarbonyloxy, isocyanato, cyano, silyl, halo, and dialkylamino. Alternatively, the substituents may be non-reactive such as alkoxy, alkyl or aryl. Reactive groups should be chosen such that there is no adverse reaction with the CTA under the conditions of the polymerization process. For example, groups such as primary or secondary amino (—NH₂, NHalkyl) under some conditions may react with dithioesters to give thioamides thus destroying the CTA.

The amount of monomer present is determined by the target molecular weight of the polymer to be produced. In one embodiment, the monomers are present in an amount of about 20,000 mol % relative to the initiator. In another embodiment, the monomers are present in an amount of about 20,000 mol % relative to the chain transfer agent.

### Process

The process of the present invention can be carried out in emulsion, solution or suspension in either a batch, semi-batch, continuous, or feed mode.

The process may be performed by forming a reaction mixture comprising a monomer, an initiator, a chain transfer agent and a photoredox catalyst. The monomer, chain transfer agent (which may be a PET-RAFT agent) and photoredox catalyst may, for example, be combined in a concentration ratio of [monomer]:[CTA]:[cat.] of about 20 to about 2000:about 1:about 0.5×10⁻⁴ to about 1. The components of the reaction mixture may be combined in any order and in any manner. The reaction mixture is typically first exposed to light to initiate the radical polymerization after all the components of the reaction mixture have been combined. However, in some embodiments, one or more components of the reaction mixture may be added after radical polymerization of the monomer has commenced. For example, a mixture of a monomer, initiator and photoredox catalyst may be exposed to light to initiate radical polymerization of the monomer prior to the CTA being added to form the reaction mixture comprising a monomer, an initiator, a chain transfer agent and a photoredox catalyst. It will be appreciated that when the mixture comprising the monomer, the initiator, the chain transfer agent and the photoredox catalyst is exposed to light, radical polymerization of the monomer is continuously initiated. In some embodiments, a mixture of two or more of the monomer, initiator, chain transfer agent and photoredox catalyst may be exposed to light while the remaining components are added to the mixture. For example, a mixture of initiator, chain transfer agent and photoredox catalyst may be exposed to light and a monomer may then be added, for example via syringe pump. For lowest polydispersity polymers, the CTA is preferably added before polymerization is commenced. For example, when carried out in batch mode in solution, the reactor is typically charged with CTA, initiator, photoredox catalyst and monomer or medium plus monomer. The mixture is then exposed to light for a time which is dictated by the desired conversion and molecular weight. Polymers with broad, yet controlled, polydispersity or with multimodal molecular weight distribution can be produced by controlled addition of the CTA over the course of the polymerization process, and/or by turning on and off the light source.

The mixture is exposed to light such that radical polymerization of the monomer is initiated. The mixture may be exposed to light by any means of irradiating the mixture with light having a wavelength effective to cause excitation of the photoredox catalyst. The excitation of the photoredox catalyst induces the initiator to form a radical initiating the radical polymerization of the monomer. A natural or artificial light source may be used. In one embodiment, a light emitting diode is used as light source.

The reaction is typically run at ambient temperature (about 20-25° C.). As the exposure of the photoredox catalyst to light initiates the radical polymerization reaction, generally no additional heating is required. This is advantageous, relative to traditional RAFT polymerization, as temperature sensitive monomers and/or target polymers may be synthesized using the process described herein that were previously inaccessible using traditional RAFT polymerization processes. In one embodiment, the process may be conducted at low temperature, i.e. about 5° C. or less.

Typically, radical polymerizations are sensitive to oxygen. Advantageously, in some embodiments, the process of the present invention may be carried out in the presence of oxygen. For example, the reaction may be carried out in a closed vessel without degassing the mixture and/or purging the vessel of oxygen with an inert gas, e.g. nitrogen or argon. In one embodiment, the mixture is not degassed. In these embodiments, the photoredox catalyst is preferably oxygen tolerant, for example, Ru(bpy)₃Cl₂.

In order to determine when the reaction is complete, an aliquot may be taken for analysis. Any suitable analytical technique known in the art may be employed.

In the case of emulsion or suspension polymerization the medium will often be predominantly water and the conventional stabilizers, dispersants and other additives can be present.

For solution polymerization, the reaction medium can be chosen from a wide range of media to suit the monomer(s) being used. In the case of solution polymerization, a solvent is selected that will dissolve the reactive species or a sufficient portion of each reactive species to drive the reaction. In addition to solvating the reactive species, the solvent should also provide sufficient light penetration for excitation of the photoredox catalyst. The solvent may be polar or apolar. Suitable polar solvents include dimethylsulphoxide (DMSO), dimethylformamide (DMF), water, methanol, acetonitrile (ACN), N-methylpyrrolidine (NMP), acetone, and combinations thereof. Suitable apolar solvents include toluene. Preferably, the solvent is a polar solvent. Typically, the PET-RAFT reaction is conducted at a concentration of monomer of about 10 M or less.

The process of the present invention may be carried out in an aqueous medium. Accordingly, in one embodiment, the reaction mixture comprises an aqueous solvent. The aqueous solvent may be water or a mixture of water with a water-miscible solvent or combination of solvents. The use of an aqueous system is advantageous as water is a relatively safe and inexpensive solvent. Further, as the process can be carried out in an aqueous medium, the process can advantageously be carried out in a biological medium and in the presence of biomolecules. By linking a biomolecule, such as a protein, to a moiety capable of acting as a chain transfer agent, e.g. a thiocarbonylthio moiety, the process can be used to prepare biomolecule polymer conjugates. When the process is carried out in an aqueous medium, the photoredox catalyst may be any photoredox catalyst described above that retains its activity in an aqueous environment, such as, for example, the commercially available water soluble photoredox catalyst Ru(bpy)₃Cl₂ (see Example 3). The use of an aqueous solvent may be advantageous for the preparation of polymers from water-soluble monomers. The use of an aqueous solvent may also be advantageous for preparing polymers that are highly polar, e.g. polymers derived from hydrophilic monomers or polymer conjugates of polar monomers conjugated to a polar substrate, e.g. a biomolecule. Hydrophilic monomers include, for example, oligo(ethyleneglycol) methyl ether acrylate, oligo(ethyleneglycol) methyl ether methacrylate, di(ethyleneglycol) methyl ether methacrylate, tri(ethyleneglycol) methyl ether methacrylate, N-isopropylacrylamide (NIPAAm), N,N-dimethylacrylamide (DMA), N,N-diethylacrylamide (DEA), hydroxypropylmethacrylamide, N,N-dimethylaminoethyl acrylate, N,N-diethylaminoethyl acrylate, N,N-dimethylaniinoethyl methacrylate, N,N-diethylaminoethyl methacrylate, triethyleneglycol methacrylate and N-vinylpyrrolidone.

It will be appreciated that for liquid monomers, no solvent may be required when the reactive species are soluble in the monomer alone. Consequently, in one embodiment, the solvent is a monomer selected from the group described above.

The use of feed polymerization conditions allows the use of CTAs with lower transfer constants and allows the synthesis of block polymers that are not readily achieved using batch polymerization processes. If the polymerization is carried out as a feed system the reaction can be carried out as follows. The reactor is charged with the chosen medium, the CTA, initiator, photoredox catalyst and optionally a portion of the monomer(s). Into a separate vessel is placed the remaining monomer(s). The medium in the reactor is exposed to light and stirred while the monomer medium is introduced, for example by a syringe pump or other pumping device. The rate and duration of feed is determined largely by the quantity of solution, the desired monomer/CTA/initiator/catalyst ratio and the rate of the polymerization. When the feed is complete, exposure to light can be continued for an additional period.

Following completion of the polymerization, the polymer can be isolated by stripping off the medium and unreacted monomer(s) or by precipitation with a non-solvent. Alternatively, the polymer solution/emulsion can be used as such, if appropriate to its application. Other suitable isolation/purification techniques are well known in the art. The photoredox catalyst may be removed during this isolation and/or purification procedure. The photoredox catalyst may also be recovered during the purification step. The recovered catalyst may then be reused in further polymerizations.

Following isolation, the resultant polymer may be further reacted to, for example, add additional functionality or modify the end-groups of the polymer chain. Techniques for such modifications are known in the art as for traditional polymers produced by RAFT polymerization, i.e. polymers comprising a CTA end-group.

### Polymer

The process of the present invention produces a polymer. The resultant polymer will depend on the monomers selected for polymerization and the end portion of each polymer chain will depend on the chain transfer agent and initiator selected for the reaction.

Various polymer architectures may be produced using the process of the present invention, including block, graft and star polymers. Also, different polymer types may be produced, such as copolymers, gradient copolymers and gradient block co-polymers.

The polymers produced by the process of the present invention are typically low polydispersity polymers. Low polydispersity polymers are those with polydispersities that are significantly less than those produced by conventional free radical polymerization. In conventional free radical polymerization, polydispersities (as described above, the polydispersity is defined as the ratio of the weight average and number average molecular weights M_{w}/Mₙ) of the polymers formed are typically in the range 1.6-2.0 for low conversions (<10%) and are substantially greater than this for higher conversions. In some embodiments, polydispersities obtained with the process described herein are less than 1.5, preferably less than 1.3 and, with appropriate choice of the chain transfer agent and the reaction conditions, may be less than 1.1. The low polydispersity can be maintained at high conversions (see Examples). As described above, ideal polydispersities (M_{w}/Mₙ) approach 1. Thus, in some embodiments, the polydispersity is about 1 to about 1.5, about 1 to about 1.3, about 1 to about 1.2 or about 1 to about 1.1.

Note that it is also possible to produce polymers with broad, yet controlled, polydispersity or multimodal molecular weight distribution by controlled addition of the CTA over the course of the polymerization process, and/or controlling the exposure of the reaction mixture to light.

The process of the present invention allows for the production of polymers possessing higher molecular weights than were previously accessible for polymers with low polydispersity, e.g. via prior art RAFT polymerization processes. Such polymers are able to be produced using the process of the present invention as the process can be carried out at or below ambient temperature. In one embodiment, the molecular weight of the polymer is about 2500 to about 2,000,000 g/mol. In another embodiment, the molecular weight of the polymer is about 5000 to about 1,500,000 g/mol.

In addition, due to the gentle thermal conditions, longer polymer blocks may be linked together to form block polymers or block co-polymers. In one embodiment, the block has a molecular weight of about 20,000 g/mol to about 100,000 g/mol.

In one aspect, the present invention provides a polymer produced by the process described herein.

In another aspect, the present invention provides a composition comprising a monomer, an initiator, a chain transfer agent and a photoredox catalyst, wherein exposing the composition to light initiates radical polymerization of the monomer. Suitable monomers, initiator, chain transfer agent and photoredox catalyst are described above. In one embodiment, the initiator and the chain transfer agent are the same compound.

In another aspect, the present invention provides a composition comprising a monomer, an initiator, a thiocarbonylthio compound and a photoredox catalyst, wherein exposing the composition to light initiates radical polymerization of the monomer. Suitable monomer, initiator, thiocarbonylthio compound and photoredox catalyst are described above. In one embodiment, the initiator and the thiocarbonylthio compound are the same compound.

In another aspect, the present invention provides a method for producing a polymer, comprising exposing the composition comprising a monomer, an initiator, a chain transfer agent and a photoredox catalyst, to light. The light has a wavelength suitable to excite the photoredox catalyst and initiate the radical polymerization.

In another aspect, the present invention provides a method for producing a polymer, comprising exposing the composition comprising a monomer, an initiator, a thiocarbonylthio compound and a photoredox catalyst, to light. The light has a wavelength suitable to excite the photoredox catalyst and initiate the radical polymerization.

In another aspect, the present invention provides a polymerization system comprising a monomer, an initiator, a chain transfer agent and a photoredox catalyst, wherein exposure of the composition to light initiates radical polymerization of the monomer. Suitable monomers, initiators, chain transfer agents and photoredox catalysts are described above. In one embodiment, the initiator and the chain transfer agent are the same compound.

In another aspect, the present invention provides a polymerization system comprising a monomer, an initiator, a thiocarbonylthio compound and a photoredox catalyst, wherein exposure of the composition to light initiates radical polymerization of the monomer. Suitable monomers, initiators, thiocarbonylthio compounds and photoredox catalysts are described above. In one embodiment, the initiator and the thiocarbonylthio compound are the same compound.

### Polymer Bioconjugates

In one aspect, the invention provides a process for preparing a polymer bioconjugate, comprising exposing a mixture comprising a monomer, an initiator, a photoredox catalyst and a biomolecule comprising, or bound to, a moiety capable of acting as a chain transfer agent, to light, wherein exposing the mixture to light initiates radical polymerization of the monomer and conjugation of the polymerized monomer to the biomolecule.

Advantageously, the process of the present invention may be used to prepare a polymer bioconjugate. As used herein, the term “polymer bioconjugate” refers to a biomolecule conjugated to a polymer; typically the biomolecule is covalently bound to the polymer. The process of the present invention is advantageous for this purpose as the process can be carried out in an aqueous or biological medium. Further, the process of the present invention can be carried out under relatively mild conditions (low catalyst concentrations, low light levels and at ambient temperature (e.g. at room temperature)). Due to the relatively mild conditions, the process can be used to prepare polymer bioconjugates without sacrificing the bioactivity of the biomolecule.

Polymer bioconjugates may, for example, be employed in the pharmaceutical and biomedical fields. For example, a polymer bioconjugate may be used for the preparation of a drug delivery system. Alternatively, a polymer bioconjugate may be employed in the construction of a medical device. The medical device may be for internal (e.g. an implant, such as a pacemaker) or external use (e.g. a catheter).

Typically, in the process for preparing a polymer bioconjugate, the mixture comprises an aqueous solvent, preferably water, to solubilise the biomolecule. Any of the monomers, initiators, and photoredox catalysts described above may be employed. The person skilled in the art will be able to determine the appropriate selection based on the properties of the biomolecule and the known properties of the above described monomers, initiators, and photoredox catalysts.

In one embodiment, the photoredox catalyst is Ru(bpy)₃Cl₂.

The biomolecule may be a naturally occurring biomolecule comprising a moiety capable of acting as a chain transfer agent, or may be a biomolecule that has been modified such that the biomolecule is covalently bound to a moiety capable of acting as a chain transfer agent, such as a thiocarbonylthio group. Formation of a biomolecule bound to a moiety capable of acting as a chain transfer agent may be achieved, for example, based on a biomolecule comprising a thiol moiety, such as bovine serum albumin (BSA), by converting the thiol moiety to a moiety capable of acting as a chain transfer agent, e.g. a thiocarbonylthio group. The thiol moiety may be converted to a thiocarbonylthio moiety by methods known in the art. In one embodiment, the thiol group may be converted to a thiocarbonylthio moiety by reaction of the thiol moiety with a thiocarbonylthio-transfer compound, e.g. 2-(pyridin-2-yldisulfanyl)ethyl 2-(((butylthio)carbonothioyl)thio)propanoate (PDS-BTP), preferably with an excess of the thiocarbonylthio-transfer compound. As described above, a thiocarbonylthio group may act as a chain transfer agent. Advantageously, the use of a biomolecule comprising, or bound to, a moiety capable of acting as a chain transfer agent, e.g. a thiocarbonylthio group, controls the structure of the polymer bioconjugate. Typically, for a PET-RAFT polymerization employing a biomolecule comprising a moiety capable of acting as a chain transfer agent within its structure, the growing polymer chain extends from the site of the biomolecule which was bound to the moiety capable of acting as a chain transfer agent, e.g. when a thiol moiety of BSA is converted to a thiocarbonylthio moiety the polymer chain will grow from the location of the thiocarbonylthio moiety of the modified BSA.

In another embodiment, the biomolecule comprising, or bound to, a moiety capable of acting as a chain transfer agent also as acts as the initiator. In such embodiments, a separate initiator is not required. In one embodiment, the combined initiator and biomolecule comprising, or bound to, a moiety capable of acting as a chain transfer agent is a macroinitiator of formula (I′), wherein at least one of R and Z is a biomolecular moiety (a moiety derived from a biomolecule), and X and A are as defined above.

In another aspect, the invention provides a process for preparing a polymer bioconjugate, comprising exposing a mixture comprising a monomer, an initiator, a photoredox catalyst and a biomolecule bound to a thiocarbonylthio group, to light, wherein exposing the mixture to light initiates radical polymerization of the monomer and conjugation of the polymer to the biomolecule.

In one embodiment, the biomolecule bound to a thiocarbonylthio group also as acts as the initiator, that is, the biomolecule is a macroinitiator comprising a biomolecular moiety and thiocarbonylthio moiety. In such an embodiment, it is not necessary to include a separate initiator in the mixture. Accordingly, in one aspect, the invention provides a process for preparing a polymer bioconjugate, comprising exposing a mixture comprising a monomer, a photoredox catalyst and a macroinitiator comprising a biomolecular moiety and a thiocarbonylthio moiety, to light, wherein exposing the mixture to light initiates radical polymerization of the monomer and conjugation of the polymer to the biomolecular moiety.

Typically, the mixture comprises an aqueous solvent, preferably water, to solubilise the macroinitiator. Any of the monomers and photoredox catalysts described above may be employed. The person skilled in the art will be able to determine the appropriate selection based on the properties of the biomolecule and the known properties of the above described monomers and photoredox catalysts.

In one embodiment, the photoredox catalyst is Ru(bpy)₃Cl₂.

In one particular aspect, the present invention provides a process for preparing a polymer bioconjugate from a biomolecule, e.g. a protein, comprising the steps of:
1) treating the biomolecule to form a biomolecule bound to a thiocarbonyl group; and
2) exposing a mixture of the thiocarbonyl-functionalized biomolecule, a monomer, an initiator and a photoredox catalyst, to light, wherein exposing the mixture to light initiates radical polymerization of the monomer and conjugation of the polymerized monomer to the biomolecule.

In one embodiment, the thiocarbonyl-functionalized biomolecule also as acts as the initiator. In such embodiments, a separate initiator is not required. Accordingly, in another aspect, the present invention provides a process for preparing a polymer bioconjugate from a biomolecule, e.g. a protein, comprising the steps of:
1) treating the biomolecule to form a biomolecule bound to a thiocarbonyl group; and
2) exposing a mixture of the thiocarbonyl-functionalized biomolecule with a monomer and a photoredox catalyst, to light, wherein exposing the mixture to light initiates radical polymerization of the monomer and conjugation of the polymerized monomer to the biomolecule.

### Kits and Articles of Manufacture

In another aspect, the present invention provides a kit comprising two or more of a photoredox catalyst, an initiator and a chain transfer agent in separate compartments.

In another aspect, the present invention provides a combination of a photoredox catalyst and a thiocarbonylthio compound, wherein the thiocarbonylthio compound is a combined chain transfer agent and initiator. The combination of the photoredox catalyst and the thiocarbonylthio compound further simplifies the experimental set-up of a PET-RAFT process.

### DEFINITIONS

Unless otherwise herein defined, the following terms will be understood to have the general meanings which follow. The terms referred to below have the general meanings which follow when the term is used alone and when the term is used in combination with other terms, unless otherwise indicated. Hence, for example, the definition of “alkyl” applies to “alkyl” as well as the “alkyl” portions of “alkylthio”, “alkylcarbonyloxy” etc.

The term “alkyl” refers to a straight chain or branched chain saturated hydrocarbyl group. The term “C₁₋₂₀alkyl” refers to an alkyl group having 1 to 20 carbon atoms. Preferred are C₁₋₁₆alkyl, C₁₋₁₂alkyl, C₁₋₁₀alkyl, C₁₋₆alkyl, C₁₋₄alkyl and C₁₋₃alkyl groups. Examples of C₁₋₆alkyl include methyl (Me), ethyl (Et), propyl (Pr), isopropyl (i-Pr), butyl (Bu), isobutyl (i-Bu), sec-butyl (s-Bu), tert-butyl (t-Bu), pentyl, neopentyl, hexyl and the like. Unless the context requires otherwise, the term “alkyl” also encompasses alkyl groups containing one less hydrogen atom such that the group is attached via two positions, i.e. divalent.

The term “alkenyl” refers to a straight chain or branched chain hydrocarbyl group having at least one double bond of either E- or Z-stereochemistry where applicable. The term “C₂₋₆alkenyl” refers to an alkenyl group having 2 to 6 carbon atoms. Examples of C₂₋₆alkenyl include vinyl, 1-propenyl, 1- and 2-butenyl and 2-methyl-2-propenyl. Unless the context requires otherwise, the term “alkenyl” also encompasses alkenyl groups containing one less hydrogen atom such that the group is attached via two positions, i.e. divalent. Preferred are C₂₋₄alkenyl and C₂₋₃alkenyl groups.

The term “alkynyl” refers to a straight chain or branched chain hydrocarbyl group having at least one triple bond. The term “C₂₋₆alkynyl” refers to an alkynyl group having 2 to 6 carbon atoms. Examples of C₂₋₆alkynyl include ethynyl, 1-propynyl, 1- and 2-butynyl, 2-pentynyl, 3-pentynyl, 4-pentynyl, 2-hexynyl, 3-hexynyl, 4-hexynyl and 5-hexynyl and the like. Unless the context indicates otherwise, the term “alkynyl” also encompasses alkynyl groups containing one less hydrogen atom such that the group is attached via two positions, i.e. divalent. C₂₋₃alkynyl is preferred.

The term “C₃₋₈cycloalkyl” refers to a non-aromatic cyclic hydrocarbyl group having from 3 to 8 carbon atoms. Such groups include cyclopropyl, cyclobutyl, cyclopentyl, cyclohexyl, cycloheptyl and cyclooctyl. The term “C₃₋₈cycloalkyl” encompasses groups where the cyclic hydrocarbyl group is saturated such as cyclohexyl or unsaturated such as cyclohexenyl. C₃₋₆cycloalkyl such as cyclopropyl, cyclobutyl, cyclopentyl and cyclohexyl are preferred.

The terms “hydroxy” and “hydroxyl” refer to the group —OH.

The term “oxo” refers to the group ═O.

The term “alkoxy” refers to a alkyl group as defined above covalently bound via an O linkage, such as methoxy, ethoxy, propoxy, isoproxy, butoxy, tert-butoxy and pentoxy. Preferred are C₁₋₁₈alkoxy and C₁₋₆alkoxy.

The term “carboxylate” refers to the group —COO⁻.

The term “carboxyl” refers to the group —COOH.

The term “ester” refers to a carboxyl group having the hydrogen replaced with, for example, a C₁₋₆alkyl group (“C₁₋₆alkylester” or “C₁₋₆alkylcarbonyl”), an aryl or aralkyl group (“arylester” or “aralkylester”) and so on. Alkylester groups include, for example, methylester (—CO₂Me), ethylester (—CO₂Et) and propylester (—CO₂Pr) and reverse esters thereof (e.g. —OC(O)Me, —OC(O)Et and —OC(O)Pr).

The term “cyano” or “nitrile” refers to the group —CN.

The term “nitro” refers to the group —NO₂.

The term “amino” refers to the group —NH₂.

The term “substituted amino” or “secondary amino” refers to an amino group having a hydrogen replaced with, for example, a C₁₋₆alkyl group (“C₁₋₆alkylamino”), an aryl or aralkyl group (“arylamino”, “aralkylamino”) and so on. Alkylamino groups include, for example, methylamino (—NHMe), ethylamino (—NHEt) and propylamino (—NHPr).

The term “disubstituted amino” or “tertiary amino” refers to an amino group having the two hydrogens replaced with, for example, a C₁₋₆alkyl group, which may be the same or different (“di(C₁₋₆alkyl)amino”), an aryl and alkyl group (“aryl(alkyl)amino”) and so on. Di(alkyl)amino groups include, for example, dimethylamino (—NMe₂), diethylamino (—NEt₂), dipropylamino (—NPr₂) and variations thereof (e.g. —N(Me)(Et) and so on).

The term “acyl” or “aldehyde” refers to the group —C(═O)H.

The term “substituted acyl” or “ketone” refers to an acyl group having the hydrogen replaced with, for example, a C₁₋₆alkyl group (“C₁₋₆alkylacyl” or “C₁₋₆alkylketone”), an aryl group (“arylketone”), an aralkyl group (“aralkylketone”) and so on. C₁₋₃alkylacyl groups are preferred.

The term “amido” or “amide” refers to the group —C(O)NH₂.

The term “aminoacyl” refers to the group —NHC(O)H.

The term “substituted amido” or “substituted amide” refers to an amido group having a hydrogen replaced with, for example, a C₁₋₆alkyl group (“C₁₋₆alkylamido” or “C₁₋₆alkylamide”), an aryl (“arylamido”), aralkyl group (“aralkylamido”) and so on. C₁₋₃alkylamide groups are preferred, such as, for example, methylamide (—C(O)NHMe), ethylamide (—C(O)NHEt) and propylamide (—C(O)NHPr) and reverse amides thereof (e.g. —NHC(O)Me, —NHC(O)Et and —NHC(O)Pr).

The term “disubstituted amido” or “disubstituted amide” refers to an amido group having the two hydrogens replaced with, for example, a C₁₋₆alkyl group (“di(C₁₋₆alkyl)amido” or “di(C₁₋₆alkyl)amide”), an aralkyl and alkyl group (“alkyl(aralkyl)amido”) and so on. Di(C₁₋₃alkyl)amide groups are preferred, such as, for example, dimethylamide (—C(O)NMe₂), diethylamide (—C(O)NEt₂) and dipropylamide (—C(O)NPr₂) and variations thereof (e.g. —C(O)N(Me)Et and so on) and reverse amides thereof.

The term “thiol” refers to the group —SH.

The term “C₁₋₆alkylthio” refers to a thiol group having the hydrogen replaced with a C₁₋₁₈alkyl group. C₁₋₁₈alkylthio groups include, for example, thiolmethyl, thiolethyl and thiolpropyl.

The term “thioxo” refers to the group ═S.

The term “thiocarbonyl” refers to the group >C═S.

The term “thioester” refers to the group corresponding to an ester group, as defined above, wherein one or two of the ester oxygen atoms have been substituted with sulphur, i.e. any one of the groups —C(O)S—, —C(S)O— or —C(S)S—.

The term “dithioester” refers to a thioester group containing two sulphur atoms, i.e. the group —C(S)S—.

The term “carbonate” refers to the group —OC(O)O—.

The term “xanthate” refers to a carbonate where the oxo group and one other oxygen atom have been replaced with sulphur, i.e. the group —OC(S)S—.

The term “thiocarbonate” refers to a carbonate group where one or more oxygen atoms have been replaced with a sulphur atom, e.g. a di-thiocarbonate group may refer to the group —OC(S)S—, and a trithiocarbonate group refers to the group —SC(S)S—.

The term “carbamate” refers to the group >NC(O)O—.

The term “thiocarbamate” refers to a carbamate group where one or more oxygen atoms have been replaced with a sulphur atom. Dithiocarbamates are preferred, i.e. the group >NC(S)S—.

The term “halo” refers to fluoro, chloro, bromo or iodo.

The term “aryl” refers to a carbocyclic (non-heterocyclic) aromatic ring or mono-, bi- or tri-cyclic ring system. The aromatic ring or ring system is generally composed of 6 to 10 carbon atoms. Examples of aryl groups include but are not limited to phenyl, biphenyl, naphthyl and tetrahydronaphthyl. The term “arylalkyl” or “aralkyl” refers to an arylalkyl- such as benzyl. The term “alkaryl” refers to an alkyl-substituted aryl.

The term “heterocyclyl” refers to a moiety obtained by removing a hydrogen atom from a ring atom of a heterocyclic compound which moiety has from 3 to 10 ring atoms (unless otherwise specified), of which 1, 2, 3 or 4 are ring heteroatoms, each heteroatom being independently selected from O, S and N, and the remainder of the ring atoms are carbon atoms.

In this context, the prefixes 3-, 4-, 5-, 6-, 7-, 8-, 9- and 10-membered denote the number of ring atoms, or range of ring atoms, whether carbon atoms or heteroatoms. For example, the term “3-10-membered heterocylyl”, as used herein, refers to a heterocyclyl group having 3, 4, 5, 6, 7, 8, 9 or 10 ring atoms. Examples of heterocylyl groups include 5-6-membered monocyclic heterocyclyls and 9-10 membered fused bicyclic heterocyclyls.

Examples of monocyclic heterocyclyl groups include, but are not limited to, those containing one nitrogen atom such as aziridine (3-membered ring), azetidine (4-membered ring), pyrrolidine (tetrahydropyrrole), pyrroline (e.g., 3-pyrroline, 2,5-dihydropyrrole), 2H pyrrole or 3H-pyrrole (isopyrrole, isoazole) or pyrrolidinone (5-membered rings), piperidine, dihydropyridine, tetrahydropyridine (6-membered rings), and azepine (7 membered ring); those containing two nitrogen atoms such as imidazoline, pyrazolidine (diazolidine), imidazoline, pyrazoline (dihydropyrazole) (5-membered rings), piperazine (6 membered ring); those containing one oxygen atom such as oxirane (3-membered ring), oxetane (4-membered ring), oxolane (tetrahydrofuran), oxole (dihydrofuran) (5-membered rings), oxane (tetrahydropyran), dihydropyran, pyran (6-membered rings), oxepin (7 membered ring); those containing two oxygen atoms such as dioxolane (5-membered ring), dioxane (6-membered ring), and dioxepane (7-membered ring); those containing three oxygen atoms such as trioxane (6-membered ring); those containing one sulfur atom such as thiirane (3-membered ring), thietane (4-membered ring), thiolane (tetrahydrothiophene) (5-membered ring), thiane (tetrahydrothiopyran) (6-membered ring), thiepane (7-membered ring); those containing one nitrogen and one oxygen atom such as tetrahydrooxazole, dihydrooxazole, tetrahydroisoxazole, dihydroisoxazole (5-membered rings), morpholine, tetrahydrooxazine, dihydrooxazine, oxazine (6-membered rings); those containing one nitrogen and one sulfur atom such as thiazoline, thiazolidine (5-membered rings), thiomorpholine (6-membered ring); those containing two nitrogen and one oxygen atom such as oxadiazine (6-membered ring); those containing one oxygen and one sulfur such as: oxathiole (5-membered ring) and oxathiane (thioxane) (6-membered ring); and those containing one nitrogen, one oxygen and one sulfur atom such as oxathiazine (6-membered ring).

The term “heterocyclyl” encompasses aromatic heterocyclyls and non-aromatic heterocyclyls.

The term “aromatic heterocyclyl” may be used interchangeably with the term “heteroaromatic” or the term “heteroaryl” or “hetaryl”. The heteroatoms in the aromatic heterocyclyl group may be independently selected from N, S and O.

“Heteroaryl” is used herein to denote a heterocyclic group having aromatic character and embraces aromatic monocyclic ring systems and polycyclic (e.g. bicyclic) ring systems containing one or more aromatic rings. The term aromatic heterocyclyl also encompasses pseudoaromatic heterocyclyls. The term “pseudoaromatic” refers to a ring system which is not strictly aromatic, but which is stabilized by means of delocalization of electrons and behaves in a similar manner to aromatic rings. The term aromatic heterocyclyl therefore covers polycyclic ring systems in which all of the fused rings are aromatic as well as ring systems where one or more rings are non-aromatic, provided that at least one ring is aromatic. In polycyclic systems containing both aromatic and non-aromatic rings fused together, the group may be attached to another moiety by the aromatic ring or by a non-aromatic ring.

Examples of heteroaryl groups are monocyclic and bicyclic groups containing from five to ten ring members. The heteroaryl group can be, for example, a five membered or six membered monocyclic ring or a bicyclic structure formed from fused five and six membered rings or two fused six membered rings or two fused five membered rings. Each ring may contain up to four heteroatoms selected from nitrogen, sulphur and oxygen. The heteroaryl ring group will contain up to 4 heteroatoms, more typically up to 3 heteroatoms, more usually up to 2 heteroatoms. In one embodiment, the heteroaryl ring group contains at least one ring nitrogen atom. The nitrogen atoms in the heteroaryl rings group can be basic, as in the case of an imidazole or pyridine, or essentially non-basic as in the case of an indole or pyrrole nitrogen. In general the number of basic nitrogen atoms present in the heteroaryl group, including any amino group substituents of the ring, will be less than five.

Aromatic heterocyclyl groups may be 5-membered or 6-membered mono-cyclic aromatic ring systems.

Examples of 5-membered monocyclic heteroaryl groups include but are not limited to furanyl, thienyl, pyrrolyl, oxazolyl, oxadiazolyl (including 1,2,3 and 1,2,4 oxadiazolyls and furazanyl, i.e. 1,2,5-oxadiazolyl), thiazolyl, isoxazolyl, isothiazolyl, pyrazolyl, imidazolyl, triazolyl (including 1,2,3-, 1,2,4- and 1,3,4-triazolyls), oxatriazolyl, tetrazolyl, thiadiazolyl (including 1,2,3- and 1,3,4-thiadiazolyls) and the like.

Examples of 6-membered monocyclic heteroaryl groups include but are not limited to pyridinyl, pyrimidinyl, pyridazinyl, pyrazinyl, triazinyl, pyranyl, oxazinyl, dioxinyl, thiazinyl, thiadiazinyl and the like. Examples of 6-membered aromatic heterocyclyls containing nitrogen include pyridyl (1 nitrogen), pyrazinyl, pyrimidinyl and pyridazinyl (2 nitrogens).

Aromatic heterocyclyl groups may also be bicyclic or polycyclic heteroaromatic ring systems such as fused ring systems (including purine, pteridinyl, napthyridinyl, 1H-thieno[2,3-c]pyrazolyl, thieno[2,3-b]furyl and the like) or linked ring systems (such as oligothiophene, polypyrrole and the like). Fused ring systems may also include aromatic 5 membered or 6-membered heterocyclyls fused to carbocyclic aromatic rings such as phenyl, napthyl, indenyl, azulenyl, fluorenyl, anthracenyl and the like, such as 5-membered aromatic heterocyclyls containing nitrogen fused to phenyl rings, 5-membered aromatic heterocyclyls containing 1 or 2 nitrogens fused to phenyl ring.

A bicyclic heteroaryl group may be, for example, a group selected from: a) a benzene ring fused to a 5- or 6-membered ring containing 1, 2 or 3 ring heteroatoms; b) a pyridine ring fused to a 5- or 6-membered ring containing 1, 2 or 3 ring heteroatoms; c) a pyrimidine ring fused to a 5- or 6-membered ring containing 1 or 2 ring heteroatoms; d) a pyrrole ring fused to a 5- or 6-membered ring containing 1, 2 or 3 ring heteroatoms; e) a pyrazole ring fused to a 5- or 6-membered ring containing 1 or 2 ring heteroatoms; f) an imidazole ring fused to a 5- or 6-membered ring containing 1 or 2 ring heteroatoms; g) an oxazole ring fused to a 5- or 6-membered ring containing 1 or 2 ring heteroatoms; h) an isoxazole ring fused to a 5- or 6-membered ring containing 1 or 2 ring heteroatoms; i) a thiazole ring fused to a 5- or 6-membered ring containing 1 or 2 ring heteroatoms; j) an isothiazole ring fused to a 5- or 6-membered ring containing 1 or 2 ring heteroatoms; k) a thiophene ring fused to a 5- or 6-membered ring containing 1, 2 or 3 ring heteroatoms; l) a furan ring fused to a 5- or 6 membered ring containing 1, 2 or 3 ring heteroatoms; m) a cyclohexyl ring fused to a 5- or 6-membered aromatic ring containing 1, 2 or 3 ring heteroatoms; and n) a cyclopentyl ring fused to a 5- or 6-membered aromatic ring containing 1, 2 or 3 ring heteroatoms.

Particular examples of bicyclic heteroaryl groups containing a five membered ring fused to another five membered ring include but are not limited to imidazothiazole (e.g. imidazo[2,1-b]thiazole) and imidazoimidazole (e.g. imidazo[1,2-a]imidazole).

Particular examples of bicyclic heteroaryl groups containing a six membered ring fused to a five membered ring include but are not limited to benzofuran, benzothiophene, benzimidazole, benzoxazole, isobenzoxazole, benzisoxazole, benzothiazole, benzisothiazole, isobenzofuran, indole, isoindole, indolizine, indoline, isoindoline, purine (e.g., adenine, guanine), indazole, pyrazolopyrimidine (e.g. pyrazolo[1,5-a]pyrimidine), benzodioxole and pyrazolopyridine (e.g. pyrazolo[1,5-a]pyridine) groups. A further example of a six membered ring fused to a five membered ring is a pyrrolopyridine group such as a pyrrolo[2,3-b]pyridine group.

Particular examples of bicyclic heteroaryl groups containing two fused six membered rings include, but are not limited to, quinoline, isoquinoline, chroman, thiochroman, chromene, isochromene, isochroman, benzodioxan, quinolizine, benzoxazine, benzodiazine, pyridopyridine, quinoxaline, quinazoline, cinnoline, phthalazine, naphthyridine and pteridine groups.

Examples of heteroaryl groups containing an aromatic ring and a non-aromatic ring include tetrahydronaphthalene, tetrahydroisoquinoline, tetrahydroquinoline, dihydrobenzothiophene, dihydrobenzofuran, 2,3-dihydro-benzo[1,4]dioxine, benzo[1,3]dioxole, 4,5,6,7-tetrahydrobenzofuran, indoiline and, isoindoline and indane groups.

Examples of aromatic heterocyclyls fused to carbocyclic aromatic rings may therefore include, but are not limited to, benzothiophenyl, indolyl, isoindolyl, benzofuranyl, isobenzofuranyl, benzimidazolyl, indazolyl, benzoxazolyl, benzisoxazolyl, isobenzoxazoyl, benzothiazolyl, benzisothiazolyl, quinolinyl, isoquinolinyl, quinoxalinyl, quinazolinyl, cinnolinyl, benzotriazinyl, phthalazinyl, carbolinyl and the like.

The term “non-aromatic heterocyclyl” encompasses saturated and unsaturated rings which contain at least one heteroatom selected from the group consisting of N, S and O.

Non-aromatic heterocyclyls may be 3-7 membered mono-cyclic rings.

Examples of 5-membered non-aromatic heterocyclyl rings include 2H-pyrrolyl, 1 pyrrolinyl, 2-pyrrolinyl, 3-pyrrolinyl, pyrrolidinyl, 1-pyrrolidinyl, 2-pyrrolidinyl, 3-pyrrolidinyl, tetrahydrofuranyl, tetrahydrothiophenyl, pyrazolinyl, 2-pyrazolinyl, 3-pyrazolinyl, pyrazolidinyl, 2-pyrazolidinyl, 3-pyrazolidinyl, imidazolidinyl, 3-dioxalanyl, thiazolidinyl, isoxazolidinyl, 2-imidazolinyl and the like.

Examples of 6-membered non-aromatic heterocyclyls include piperidinyl, piperidinonyl, pyranyl, dihyrdopyranyl, tetrahydropyranyl, 2H-pyranyl, 4H-pyranyl, thianyl, thianyl oxide, thianyl dioxide, piperazinyl, diozanyl, 1,4-dioxinyl, 1,4-dithianyl, 1,3,5 triozalanyl, 1,3,5-trithianyl, 1,4-morpholinyl, thiomorpholinyl, 1,4-oxathianyl, triazinyl, 1,4 thiazinyl and the like.

Examples of 7-membered non-aromatic heterocyclyls include azepanyl, oxepanyl, thiepanyl and the like.

Non-aromatic heterocyclyl rings may also be bicyclic heterocyclyl rings such as linked ring systems (for example uridinyl and the like) or fused ring systems. Fused ring systems include non-aromatic 5-membered, 6-membered or 7-membered heterocyclyls fused to non-aromatic carbocyclic aromatic rings such as phenyl, napthyl, indenyl, azulenyl, fluorenyl, anthracenyl and the like. Examples of non-aromatic 5-membered, 6-membered or 7 membered heterocyclyls fused to carbocyclic aromatic rings include indolinyl, benzodiazepinyl, benzazepinyl, dihydrobenzofuranyl and the like.

Unless otherwise defined, the term “optionally substituted” as used herein indicates a group may or may not be substituted with 1, 2, 3, 4 or more groups, preferably 1, 2 or 3 groups, more preferably 1 or 2 groups, independently selected from the group consisting of C₁₋₆alkyl, C₂₋₆alkenyl, C₂₋₆alkynyl, C₃₋₈cycloalkyl, hydroxyl, oxo, C₁₋₆alkoxy, aryloxy, arylC₁₋₆alkoxy, halo, haloC₁₋₆alkyl (such as —CF₃ and —CHF₂), haloC₁₋₆alkoxy (such as —OCF₃ and —OCHF₂), carboxyl, esters, cyano, nitro, amino, substituted amino, disubstituted amino, acyl, ketones, amides, aminoacyl, substituted amides, disubstituted amides, thiol, alkylthio, thioxo, sulfates, sulfonates, sulfinyl, substituted sulfinyl, sulfonyl, substituted sulfonyl, sulfonylamides, substituted sulfonamides, disubstituted sulfonamides, aryl, arylC₁₋₆alkyl, heterocyclylC₁₋₆alkyl, arylC₂₋₆alkenyl, heterocyclylC₂₋₆alkenyl, arylC₂₋₆alkynyl, heterocyclylC₂₋₆alkynyl, heteroarylC₁₋₆alkyl, heteroarylC₂₋₆alkenyl, heteroarylC₂₋₆alkynyl, heterocyclyl and heteroaryl, wherein each alkyl, alkenyl, alkynyl, cycloalkyl, aryl and heterocyclyl and groups containing them may be further optionally substituted. Optional substituents in the case of heterocycles containing N may also include but are not limited to C₁₋₆alkyl i.e. N—C₁₋₆alkyl.

For optionally substituted “C₁₋₆alkyl”, “C₂₋₆alkenyl” and “C₂₋₆alkynyl”, the optional substituent or substituents are preferably selected from halo, aryl, heterocyclyl, C₃₋₈cycloalkyl, C₁₋₆alkoxy, hydroxyl, oxo, aryloxy, haloC₁₋₆alkyl, haloC₁₋₆alkoxyl and carboxyl. Each of these optional substituents may also be optionally substituted with any of the optional substituents referred to above, where nitro, amino, substituted amino, cyano, heterocyclyl (including non-aromatic heterocyclyl and heteroaryl), C₁₋₆alkyl, C₂₋₆alkenyl, C₂₋₆alkynyl, C₁₋₆alkoxyl, haloC₁₋₆alkyl, haloC₁₋₆alkoxy, halo, hydroxyl and carboxyl are preferred.

Various compounds described herein may be provided in a salt form. Examples of suitable salts include salts of cations such as sodium, potassium, lithium, calcium, magnesium, ammonium and alkylammonium; acid addition salts of inorganic acids such as hydrochloric, orthophosphoric, sulfuric, phosphoric, nitric, carbonic, boric, sulfamic and hydrobromic acids; or salts of organic acids such as acetic, propionic, butyric, tartaric, maleic, hydroxymaleic, fumaric, citric, lactic, mucic, gluconic, benzoic, succinic, oxalic, phenylacetic, methanesulfonic, trihalomethanesulfonic, toluenesulfonic, benzenesulfonic, isethionic, salicylic, sulphanilic, aspartic, glutamic, edetic, stearic, palmitic, oleic, lauric, pantothenic, tannic, ascorbic, valeric and orotic acids.

The term “biomolecule” as used herein refers to a macromolecule produced by a living organism. Biomolecules typically consist primarily of carbon, hydrogen, nitrogen and oxygen, but may include other elements such as sulfur. Examples of biomolecules include proteins, polysaccharides, nucleic acids, amino acids, DNA and RNA found in living organisms. The biomolecule may have biological activity.

The term “macromolecule” as used herein refers to a molecule with a large number of atoms. Macromolecules typically have more than 100 component atoms. A macromolecule may, for example, have a molecular weight of greater than a few thousand Daltons (e.g. greater than about 2000 Da or about 2000 g/mol).

### EXAMPLES

The invention will be further described by way of the following non-limiting example. It will be understood to persons skilled in the art of the invention that many modifications may be made without departing from the spirit and scope of the invention.

### Example 1

### Materials

Methyl methacrylate (99%), tert-butyl methacrylate (99%), methyl acrylate (99%), styrene (99%), vinyl acetate (99%), methyl 2-bromopropionate (98%), poly(ethylene glycol) methyl ether acrylate (average Mₙ 480), N,N-dimethylacrylamide (99%), and tris[2-phenylpyridinato-C²,N]iridium(III) (fac-[Ir(ppy)₃], 99%) were all purchased from Aldrich and used as received. N-(2-hydroxypropyl) methacrylamide (HPMA, Polysciences Inc., 97%) was used as received. N,N-dimethylformamide (DMF, 99.8%, Ajax Chemical), dimethyl sulfoxide (DMSO, Ajax Chemical), n-hexane (Ajax Chemical), methanol (Ajax Chemical), diethyl ether (Ajax Chemical), petroleum spirit (Ajax Chemical) were also used as received. Chain transfer agents (CTA), 4-cyanopentanoic acid dithiobenzoate (CPADB), 2-(n-butyltrithiocarbonate)-propionic acid (BTPA), 3-benzylsulfanylthiocarbonylsufanylpropionic acid (BSTP), and methyl 2-[(ethoxycarbonothioyl)sulfanyl]propanoate (xanthate) were synthesized according to literature procedures in, for example, J. Xu, L. Tao, C. Boyer, A. B. Lowe, T. P. Davis, Macromolecules 2009, 43, 20-24; M. H. Stenzel, L. Cummins, G. E. Roberts, T. P. Davis, P. Vana, C. Barner-Kowollik, Macro. Chem. Phys. 2003, 204, 1160-1168.

Instrumentation

Gel permeation chromatography (GPC) was performed using tetrahydrofuran (THF) or dimethylacetamide (DMAc) as the eluent. The GPC system was a Shimadzu modular system comprising an auto injector, a Phenomenex 5.0 μm beadsize guard column (50×7.5 mm) followed by four Phenomenex 5.0 μm bead-size columns (10⁵, 10⁴, 10³ and 10² Å) for DMAc system, two Phenomenex 5.0 μm bead-size columns (10⁴ and 10² Å, MIX C provided by Polymer Lab) for THF system, and a differential refractive-index detector. The system was calibrated with narrow molecular weight distribution polystyrene standards with molecular weights of 200 to 10⁶ g mol⁻¹.

Nuclear magnetic resonance (NMR) spectroscopy was carried out on a Bruker DPX 300 spectrometer operating at 400 MHz for ¹H and 100 MHz for ¹³C using CDCl₃ and DMSO-d₆ as solvents and tetramethylsilane (TMS) as a reference. Data were reported as follows: chemical shift (δ) measured in ppm downfield from TMS; multiplicity; proton count.

Reaction Setup

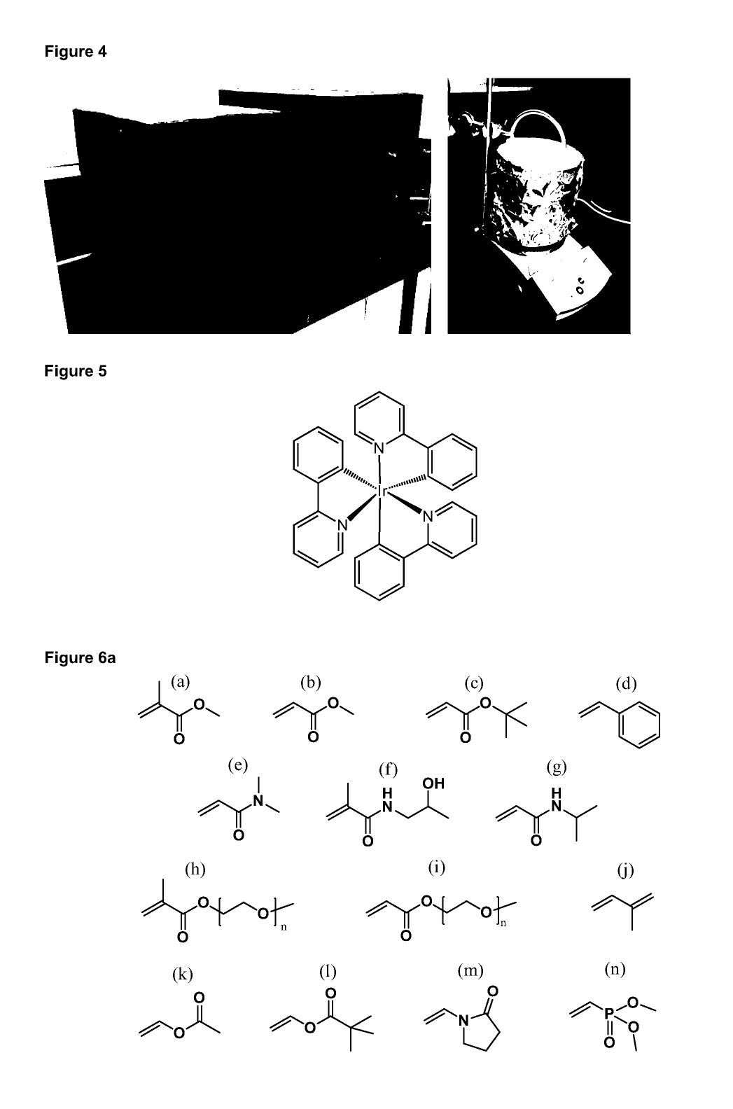

Photopolymerizations were carried out under visible light irradiation by a 1 m blue LED strip (λₘₐₓ=435 nm, 4.8 Watts) surrounding the reaction vessels. The reaction set up is shown in FIG. 4.

General Procedure for Kinetic Studies of PET-RAFT Polymerization.

In a typical experiment of kinetic study of MMA polymerization, a 5 mL glass vial was equipped with a rubber septum and charged with DMSO (2 mL), MMA (1.72 g, 17.2 mmol), CPADB (24 mg, 0.086 mmol), Ir(ppy)₃ (0.011 mg, 1.72×10⁻⁵ mmol). The mixture covered in aluminum foil was degassed by N₂ for 20 min. The mixture was then irradiated by blue LED strip (4.8 Watts) at room temperature. Aliquots were withdrawn by nitrogen purged syringes from the reaction mixture at predetermined intervals and analyzed by ¹H NMR (CDCl₃) and GPC (DMAc) to measure the conversions, number average molecular weights (Mₙ), and polydispersities (M_{w}/Mₙ).

General Procedure for Preparation of Diblock Copolymers by PET-RAFT Polymerization.

In a typical experiment of diblock copolymer of poly(methyl methacrylate)-b-poly(tert-butyl methacrylate) (PMMA-b-PtBMA), a 5 mL glass vial was equipped with a rubber septum and charged with DMSO (0.5 mL), MMA (0.43 g, 4.3 mmol), CPADB (6 mg, 0.0215 mmol), Ir(ppy)₃ (2.8×10⁻³ mg, 4.3×10⁻⁶ mmol). The mixture covered in aluminum foil was degassed by N₂ for 20 min. The mixture was then irradiated by blue LED strip (4.8 Watts) at room temperature for 24 h. The final solution was precipitated in mixture of methanol/petroleum spirit (1/1, v/v) with stirring. The pink precipitate was collected, redisolved in minimal amount of dichloromethane, and precipitated a second time from the mixture of methanol/petroleum spirit (1/1, v/v). The pink precipitate was then collected and dried to give desired products: and Mₙ=13800, M_{w}/Mₙ=1.08.

For the chain extension, a 5 mL glass vial was equipped with a rubber septum and charged with DMSO (0.5 mL), MMA (0.29 g, 2.9 mmol), PMMA macroinitiator (0.2 g, Mₙ=13800, 0.0145 mmol), Ir(ppy)₃ (1.9×10⁻³ mg, 2.9×10⁻⁶ mmol). The mixture covered in aluminum foil was degassed by N₂ for 20 min. The mixture was then irradiated by blue LED strip (4.8 Watts) at room temperature for 24 h. The final solution was precipitated in methanol with stirring. The pink precipitate was collected, redissolved in minimal amount of dichloromethane, and precipitated a second time from methanol. The pink precipitate was then collected and dried to give desired products: and Mₙ=23390, M_{w}/Mₙ=1.16.

Preparation of Decablock Copolymer of MA by PET-RAFT Polymerization Without Purification.

Methyl acrylate (MA, 0.3 g, 3.49 mmol), DMSO (0.4 mL), BTPA (6.9 mg, 0.029 mmol), and Ir(ppy)₃ (0.0114 mg, 1.74×10⁻⁵ mmol) were charged to a pear shape flask fitted with a rubber septum and the mixture covered in aluminum foil was degassed by N₂ for 20 min. The mixture was then irradiated by blue LED strip (4.8 Watts) at room temperature. After 2 h an aliquot of the reaction mixture was withdrawn for ¹H NMR, GPC (THF) analysis. The sample for ¹H NMR was simply diluted with CDCl₃, and the sample for GPC (THF) analysis was diluted with THF and filtered through Teflon filter (0.45 μm pore size). For the iterative chain extension, a further 0.3 g of a degassed monomer (in 25 vol % DMSO) solution was added via nitrogen purged syringe and again the solution was allowed to polymerize at RT for another 2 h. The above polymerization-sampling-extension procedure was repeated as required.

Compatibility test of chain transfer agent, CPADB, and photocatalyst, Ir(ppy)₃. A 5 mL glass vial was equipped with a rubber septum and charged with DMSO-d₆ (2.0 mL), CPADB (24 mg, 0.086 mmol), and Ir(ppy)₃ (0.562 mg, 8.6×10⁻⁴ mmol). The mixture covered in aluminum foil was degassed by N₂ for 20 min. The mixture was then irradiated by a blue LED strip (4.8 Watts) at room temperature. Aliquots were withdrawn by nitrogen purged syringes from the reaction mixture at predetermined intervals and analyzed by ¹H NMR (DMSO-d₆).

Results and Discussion

Initially, MMA was polymerized using a dithioester (CPADB) as chain transfer agent (CTA) and initiator, fac-[Ir(ppy)₃] as catalyst and a 4.8 W blue LED light source in dimethylformamide (DMF) (Table 1, entry 1). PMMA polymers were obtained with relatively good control of the molecular weight and a narrow MWD. These results motivated us to reduce the concentration of catalyst to 1 ppm (Table 1, entry 2). After 67 h, a ˜70% monomer conversion was determined by NMR demonstrating that the polymerization can be carried out with very low concentration of catalyst, although the decrease of the concentration of catalyst resulted in a slight decrease of polymerization kinetics. Such ultra-low concentration of catalyst is highly desirable for industrial applications, given it allows the elimination of the purification steps, therefore cutting production costs.

Other solvents, including dimethyl sulfoxide (DMSO), were also explored. We observed that DMSO allows a faster polymerization kinetics resulting in the production of polymers with a lower M_{w}/Mₙ, suggesting higher catalyst efficiency in DMSO (Table 1, entries 3-4; FIG. 8). In addition, the reactions performed in DMSO generated PMMA with a slightly lower M_{w}/Mₙ value compared to those in DMF.

To confirm that the activation and deactivation is induced by light, control experiments in the absence of catalyst (Table 1, entry 5) or light (data no shown) were conducted. Formation of polymers was not detected in both cases.

TABLE 1
Summary of PET-RAFT polymerization investigated in this study.

| | | | | Catalyst/ | | | | M_{n, GPC} | |
|---|---|---|---|---|---|---|---|---|---|
| | Initiating | | | Monomer | Time | Conv. | M_{n,th} | (Mₙ, _{NMR}) | |
| Entry | System | Monomer | Solvent | ratio (ppm) | (h) | (%) | (g/mol) | (g/mol) | M_{W}/Mₙ |
| 1 | Ir(ppy)₃/ | MMA | DMF | 5 | 23 | 69 | 14120 | 14900 | 1.18 |
| 2 | CPADB | | | 1 | 67 | 71 | 14520 | 15500 | 1.15 |
| 3 | | | DMSO | 2 | 28 | 71 | 14620 | 14100 | 1.12 |
| 4 | | | | 1 | 36 | 85 | 17260 | 17000 | 1.09 |
| 5 | | | | 0 | 48 | 0 | — | 0 | — |
| 6 | | HPMA | DMSO | 5 | 20 | 70 | 20210 | 58610 | 1.16 |
| | | | | | | | | (24000) | |
| 7 | | | | 1 | 24 | 37 | 5530 | 12100 | 1.09 |
| | | | | | | | | (6200) | |
| 8 | | MA | DMSO | 5 | 48 | — | — | 0 | — |
| 9 | | St | DMSO | 5 | 48 | — | — | 0 | — |
| 10 | Ir(ppy)₃/ | MA | DMSO | 5 | 2 | 94 | 16320 | 15550 | 1.06 |
| | BTPA | | | 1 | 2 | 93 | 16170 | 15000 | 1.08 |
| 12 | | | | 0.2 | 10 | 96 | 16770 | 17100 | 1.19 |
| 13 | | | | 0.1 | 10 | 83 | 14531 | 15300 | 1.19 |
| 14 | | St | DMSO | 10 | 72 | 50 | 10320 | 8100 | 1.13 |
| 15 | Ir(ppy)₃ | VAc | DMSO | 1 | 24 | 23 | 4140 | 4400 | 1.17 |
| | Xanthate | | | | | | | | |

Notes:

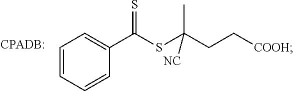 [SMILES: CC(C#N)(CCC(=O)O)SC(=S)c1ccccc1]

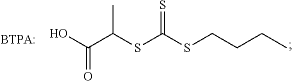

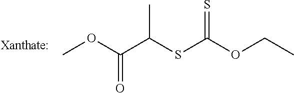

Subsequently, to demonstrate temporally controlled polymerization, the mixture of MMA, CTA and Ir complex was exposed in alternative light “ON” and “OFF”. In the absence of light (light “off”), no chain extension was observed. When the light was “on”, the polymerization proceeded (FIG. 2a). We investigated the polymerization kinetic of MMA at 1 ppm catalyst concentration. A short inhibition period (typically 3 h) was observed for MMA, which could be attributed to slow fragmentation of CTA similar with traditional RAFT process. The monomer conversion as well as In([M]₀/[M]ₜ) increased with the exposure time of light indicating a controlled/living free radical polymerization mechanism (FIG. 2c). The plot of M_{n, GPC} versus exposure time gave a linear relationship (FIG. 2b) in perfect agreement with the theoretical values (M_{n, th}) and molecular weights calculated by NMR (M_{n, NMR}). GPC analysis showed a shift of the polymer distribution to low retention time with the time of exposure (FIG. 2d).

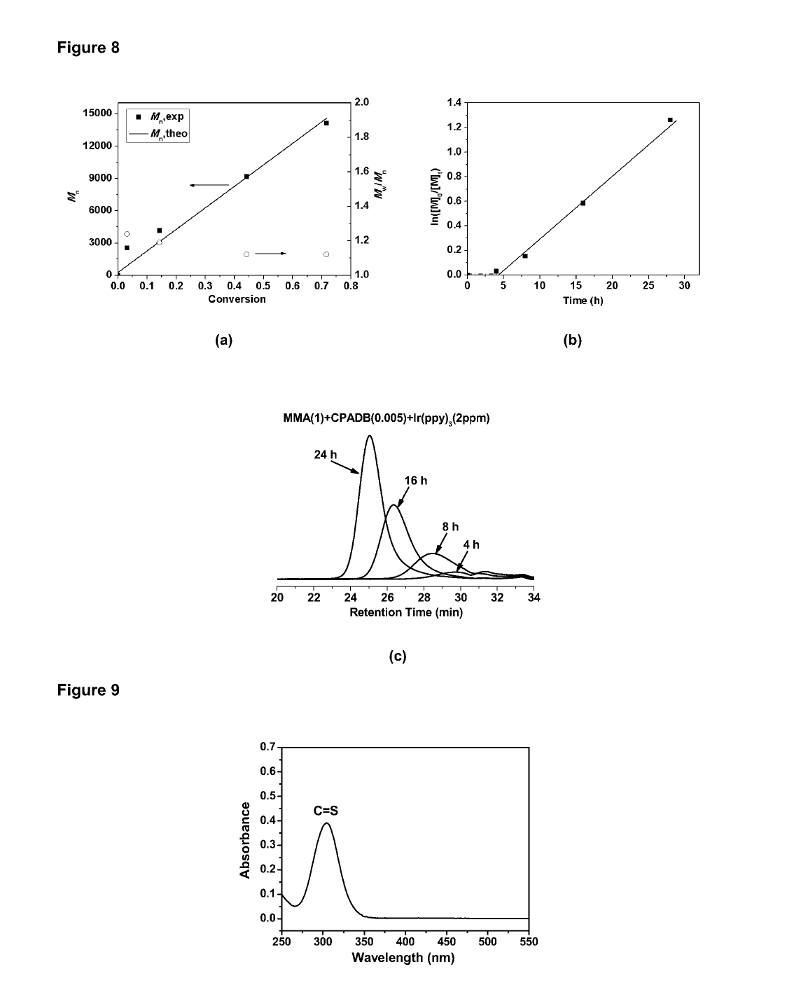

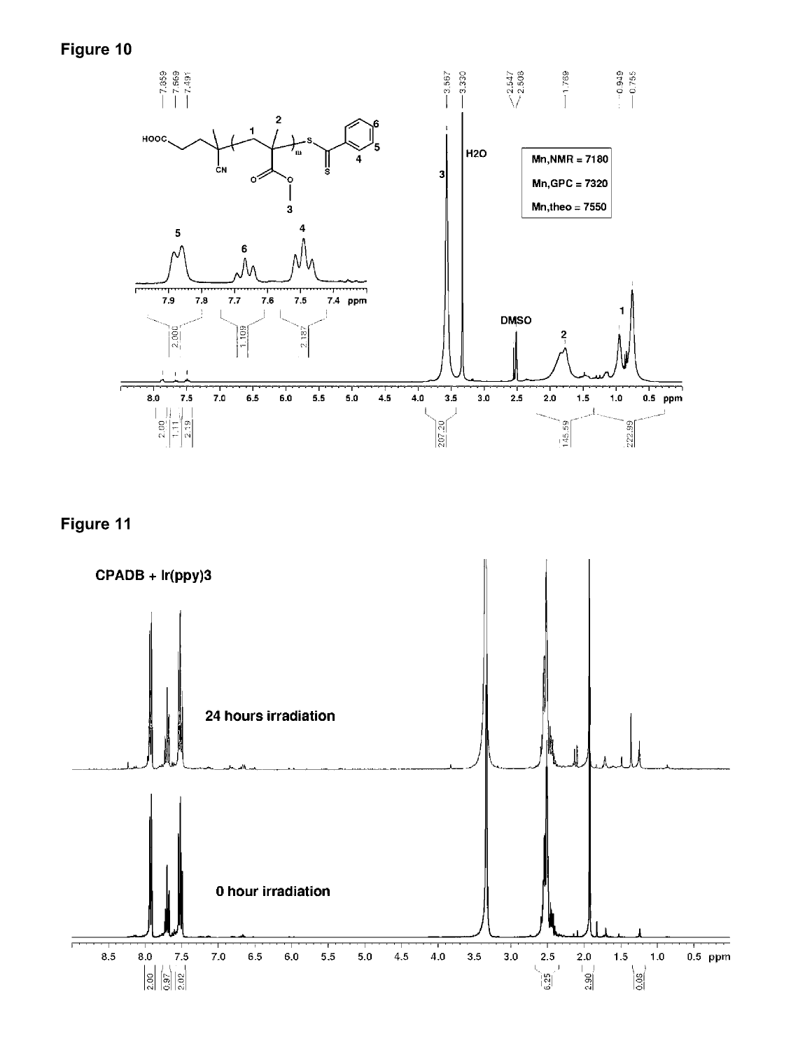

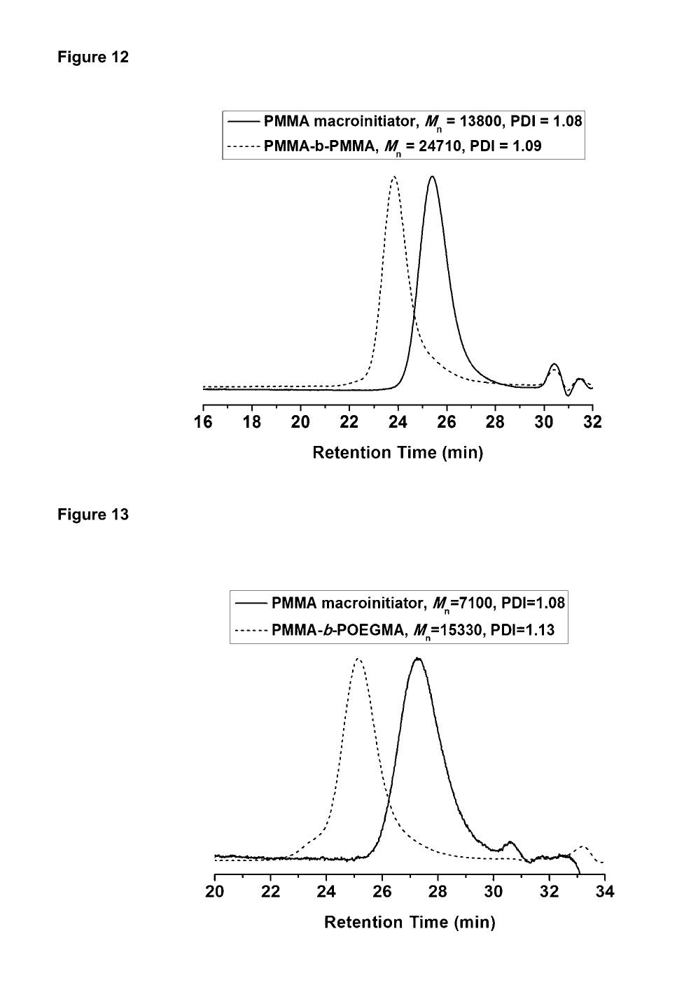

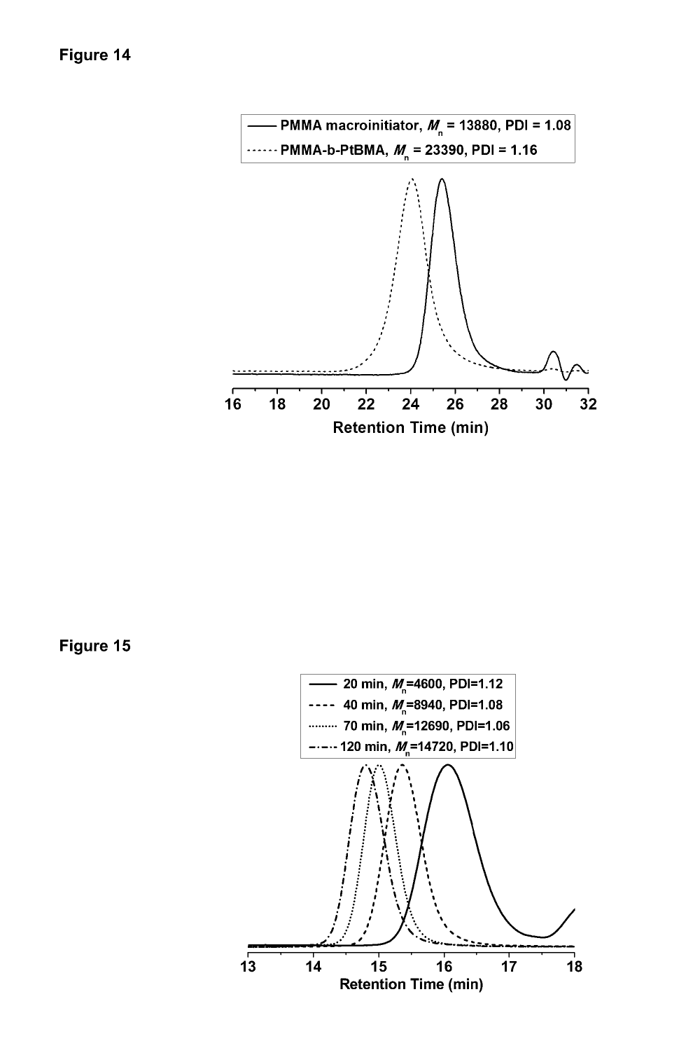

PMMA polymers obtained by PET-RAFT were purified via precipitation, and analyzed by NMR and UV-vis. spectroscopy. The signal at 305 nm characteristic of C═S bond (FIG. 9) and signals at 7.3 ppm, 7.4 ppm and 7.8 ppm characteristic of phenyl group (FIG. 10) thus confirming the presence of dithioester end group, which demonstrated that dithioester species were not degraded under exposure of blue LED light. In addition, CPADB was exposed under blue LED light in the presence of Ir catalyst for 24 h as a control experiment, to test the compatibility of CTA and catalyst. ¹H NMR analysis did not show any degradation or formation of side products (FIG. 11). To further investigate the end-group fidelity, chain extensions of PMMA polymers were carried out using MMA, oligoethylene glycol methyl ether methacrylate (OEGMA), N-(2-hydroxylpropyl) methacrylamide (HPMA) and tert-butyl methacrylate (tBuMA) as monomers to yield diblock copolymers: PMMA-b-OEGMA, PMMA-b-HPMA and PMMA-b-tBuMA, respectively (see, e.g. FIG. 7). GPC revealed a complete shift of the MWD, with no starting macro-transfer agent, to low retention time with a low M_{w}/Mₙ value (<1.20) (FIGS. 12 to 14). To illustrate the exceptional end group fidelity, we prepared PMMA-b-PMMA block polymers with ultra-high molecular weight (Mₙ>300,000 g/mol) using PMMA initiator of 20,000 g/mol. Such diblock copolymer has been rarely reported in the literatures, as it is well known that methacrylate monomers are difficult to control via C/LRP at high molecular weight. GPC showed the formation of well-defined block with unprecedented control (Mₙ=350,000 g/mol, M_{w}/Mₙ=1.31).

Subsequently, we decided to test the versatility of this polymerization technique for the polymerization of other common monomers, including styrene (St), acrylate (methyl acrylate, MA), methacrylamide (hydroxylpropylmethylacrylamide, HPMA) and vinyl acetate (VAc). The first attempt to polymerize MA and St failed using CPADB in DMSO. In the case of HPMA, we observed the formation of polymers with a good control of the molecular weight (Table 1, entries 6-7) and M_{w}/Mₙ (<1.10). To polymerize St and MA, we decided to test a trithiocarbonate compound (BTPA) instead of dithioester compound (CPADB). The initial attempts using BTPA and Ir complex revealed the formation of polymers with a conversion greater than 93% and 50% for MA and St, respectively (Table 1, entries 8 and 14). The molecular weights determined by GPC were in good agreement with M_{n, th}. and M_{n, NMR} with a low M_{w}/Mₙ (<1.17) demonstrating that the polymerization is controlled. Following these successful tests, the catalyst concentration was reduced for MA to 1, 0.2 and 0.1 ppm. At 1 ppm, a monomer conversion of 92% was observed after 2 h, showing that fast polymerization of MA can be carried out using an ultralow concentration of catalyst. As expected, at lower catalyst concentration, the polymerization required longer polymerization time to reach high conversion.

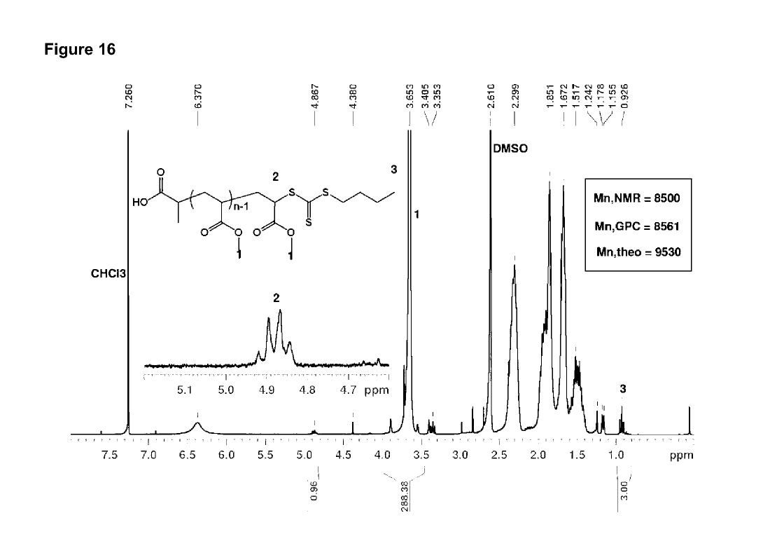

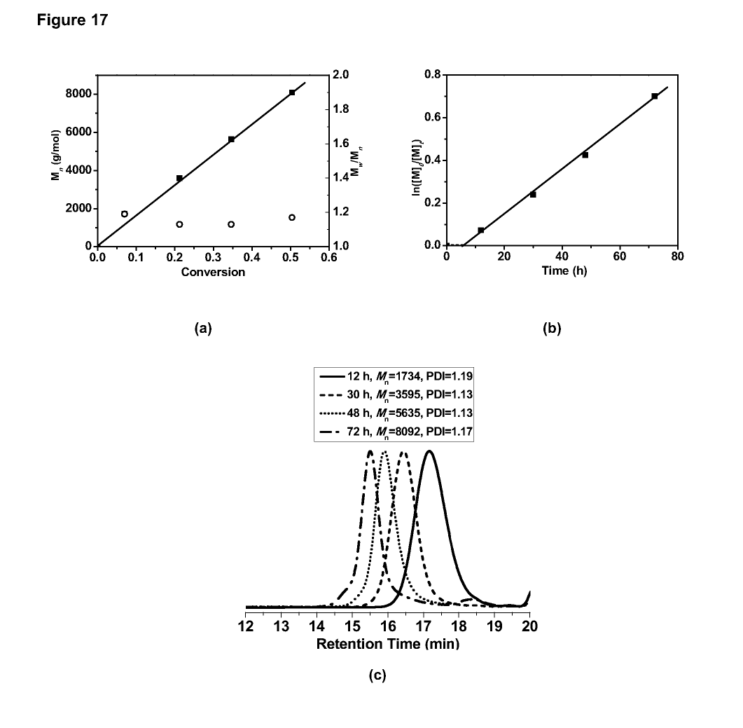

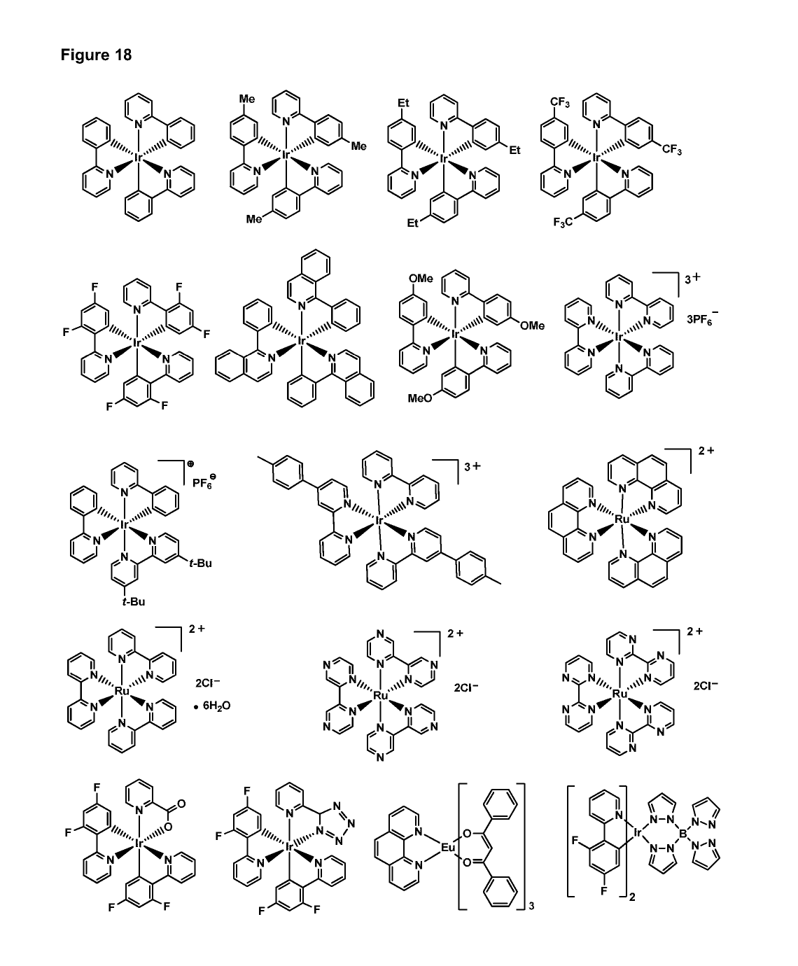

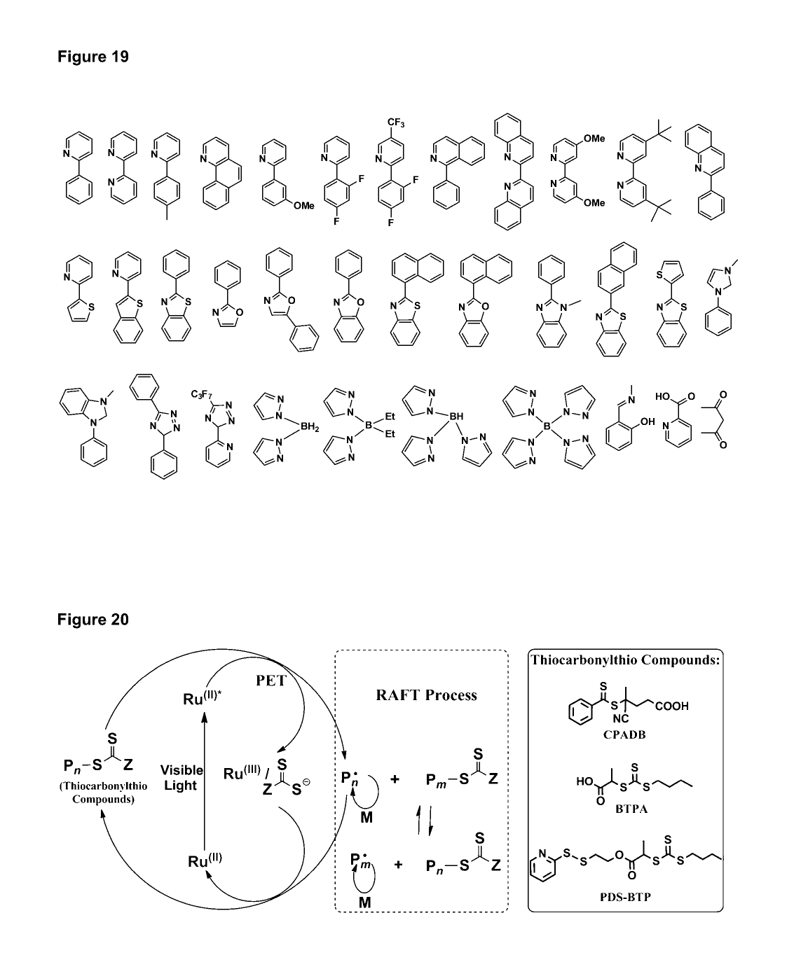

The concentration of BTPA has been varied to prepare PMA polymers with different molecular weights ranging from 2500 to 2,000,000 g/mol. To demonstrate the presence of trithiocarbonate end group, the polymer with molecular weight of 8000 Da was purified and analyzed by NMR (FIG. 16) and UV-vis spectroscopy (data no shown). The controlled/living character was demonstrated by monitoring monomer conversion and molecular weight versus exposure time for both MA and St.

Finally, vinyl acetate (VAc) was investigated using a xanthate (MADIX agent) in the presence of Ir catalyst. After 24 h, GPC revealed the presence of PVAc with a low M_{w}/Mₙ (Table 1, entry 15), demonstrating that this polymerization technique can also be employed for the polymerization of unconjugated monomers.

To further investigate the livingness (i.e., the end group fidelity) and the robustness of the catalyst (Ir), successive chain extensions of PMA was performed to generate a decablock P(MA)₁₀ copolymers. We first synthesized a PMA macroinitiator (M_{n, GPC}=8 000 g/mol) by polymerization of MA in the presence of BTPA and 5 ppm of Ir catalyst during 2 h in DMSO. NMR confirmed full monomer conversion (>99%) in the first step. For the second block, MA in a degassed 50 vol-% solution in DMSO was then added under nitrogen. The polymerization was allowed to continue for a further 2 h to reach full monomer conversion. This process was repeated several times until the formation of the high-order multi-block copolymers with high molecular weight (M_{n, GPC}˜82 000 g/mol) was obtained. To our knowledge, it is the first time that such high molecular weight block copolymer was obtained using an iterative approach. In previous studies, short block polymers, with a typically M_{n, block} ranging from 500 to 2000 g/mol were achieved. GPC analysis of the molecular weight distributions confirmed successful chain extensions as manifested by clear shifts to higher molecular weights in each step. In addition, after 10 chain extensions, MWD remained narrow (M_{w}/Mₙ=1.40). M_{n, GPC} were in good agreement with the theoretical values, although the formation of some low molecular weight tailings was observed after 6-7 cycles. These results are shown in FIG. 3. These experiments demonstrated that the catalyst is extremely robust and efficient in PET-RAFT polymerization.

### Example 2

### Materials

Methyl methacrylate (99%), tert-butyl methacrylate (99%), methyl acrylate (99%), styrene (99%), vinyl acetate (99%), methyl 2-bromopropionate (98%), poly(ethylene glycol) methyl ether acrylate (average Mₙ 480), N,N-dimethylacrylamide (99%), and tris[2-phenylpyridinato-C²,N]iridium(III) (fac-[Ir(ppy)₃], 99%) were all purchased from Aldrich and used as received. N-(2-hydroxypropyl) methacrylamide (HPMA, Polysciences Inc., 97%) was used as received. N,N-dimethylformamide (DMF, 99.8%, Ajax Chemical), dimethyl sulfoxide (DMSO, Ajax Chemical), n-hexane (Ajax Chemical), methanol (Ajax Chemical), diethyl ether (Ajax Chemical), petroleum spirit (Ajax Chemical) were also used as received. Disulphide compounds, such mercaptropionic acid disulphide, or thiol compounds, such 2-mercaptoethanol, mercaptopropionic acid, were provided by Aldrich.

Instrumentation

Gel permeation chromatography (GPC) was performed using tetrahydrofuran (THF) or dimethylacetamide (DMAc) as the eluent. The GPC system was a Shimadzu modular system comprising an auto injector, a Phenomenex 5.0 μm beadsize guard column (50×7.5 mm) followed by four Phenomenex 5.0 μm bead-size columns (10⁵, 10⁴, 10³ and 10² Å) for DMAc system, two Phenomenex 5.0 μm bead-size columns (10⁴ and 10² Å, MIX C provided by Polymer Lab) for THF system, and a differential refractive-index detector. The system was calibrated with narrow molecular weight distribution polystyrene standards with molecular weights of 200 to 10⁶ g mol⁻¹.

Nuclear magnetic resonance (NMR) spectroscopy was carried out on a Bruker DPX 300 spectrometer operating at 400 MHz for ¹H and 100 MHz for ¹³C using CDCl₃ and DMSO-d₆ as solvents and tetramethylsilane (TMS) as a reference. Data were reported as follows: chemical shift (a) measured in ppm downfield from TMS; multiplicity; proton count.

Reaction Setup

Photopolymerizations were carried out under visible light irradiation by a 1 m blue LED strip (λₘₐₓ=435 nm, 4.8 Watts) surrounding the reaction vessels. The reaction set up is shown in FIG. 4.

In an experiment of MMA polymerization, a 5 mL glass vial was equipped with a rubber septum and charged with DMSO (2 mL), MMA (1.72 g, 17.2 mmol), mercaptopropionic acid (21 mg, 0.1 mmol), Ir(ppy)₃ (0.011 mg, 1.72×10⁻⁵ mmol). The mixture covered in aluminum foil was degassed by N₂ for 30 min. The mixture was then irradiated by blue LED strip (4.8 Watts) at room temperature. Aliquots were withdrawn by nitrogen purged syringes from the reaction mixture at predetermined intervals and analyzed by ¹H NMR (CDCl₃) and GPC (DMAc) to measure the conversions, number average molecular weights (Mₙ), and polydispersities (Mₙ/M_{w}). Mₙ=200 000 g/mol, M_{w}/Mₙ=2.2

In an experiment of MMA polymerization, a 5 mL glass vial was equipped with a rubber septum and charged with DMSO (2 mL), MMA (1.72 g, 17.2 mmol), mercaptopropionic acid (10.6 mg, 1 mmol), Ir(ppy)₃ (0.011 mg, 1.72×10⁻⁵ mmol). The mixture covered in aluminum foil was degassed by N₂ for 30 min. The mixture was then irradiated by blue LED strip (4.8 Watts) at room temperature. Aliquots were withdrawn by nitrogen purged syringes from the reaction mixture at predetermined intervals and analyzed by ¹H NMR (CDCl₃) and GPC (DMAc) to measure the conversions, number average molecular weights (Mₙ), and polydispersities (Mₙ/M_{w}). Mₙ=2500 g/mol, M_{w}/Mₙ=1.5

### Example 3

### Polymerization using the photoredox catalyst tris(2,2′-bipyridyl)dichlororuthenium(II) hexahydrate (Ru(bby)₃Cl₂)

Materials. N,N-dimethylacrylamide (99%, DMA), N,N-diethylacrylamide (99%, DEA), N-isopropylacrylamide (99%, NIPAAm), di(ethylene glycol) ethyl ether acrylate (>90%, DEGA), oligo(ethylene glycol) methyl ether methacrylate (Mₙ=300) (OEGMA), and oligo(ethylene glycol) methyl ether acrylate (Mₙ=480) (OEGA) were all purchased from Aldrich and were deinhibited via basic activated alumina oxide column chromatography before use. 2,2′-dithiodipyridine (99%), 4-dimethylaminopyridine (99%, DMAP), N,N′ dicyclohexylcarbodiimide (99%, DCC), fetal bovine serum, and bovine serum albumin lyophillized powder (>96%, BSA) were purchased from Aldrich and used as received. Tris(2,2′-bipyridyl)dichlororuthenium(II) hexahydrate (Ru(bpy)₃Cl₂, 99%) was freshly prepared into stock solutions at concentrations of 0.5 mg/mL and 0.05 mg/mL for each solvent used for the experiments. N,N-dimethylformamide (DMF, 99.8%, Ajax Chemical), dimethyl sulfoxide (DMSO, Ajax Chemical), acetonitrile (Ajax Chemical), toluene (Ajax Chemical), n-hexane (Ajax Chemical), methanol (Ajax Chemical), diethyl ether (Ajax Chemical), and petroleum spirit (Ajax Chemical) were used as received. Chain transfer agents (CTA) 4-cyanopentanoic acid dithiobenzoate (CPADB) and 2-(n-butyltrithiocarbonate)-propionic acid (BTPA) were synthesized according to procedures described in, for example J. Xu, L. Tao, C. Boyer, A. B. Lowe, T. P. Davis, Macromolecules 2009, 43, 20-24; M. H. Stenzel, L. Cummins, G. E. Roberts, T. P. Davis, P. Vana, C. Barner-Kowollik, Macro. Chem. Phys. 2003, 204, 1160-1168; or C. Boyer, A. Granville, T. P. Davis, V. Bulmus, J. Polym. Sci. Part A: Polym. Chem. 2009, 47, 3773-3794.

Instrumentation.

Gel permeation chromatography (GPC) was performed using tetrahydrofuran (THF), dimethylacetamide (DMAc) or deionized water as the eluent. The GPC system was a Shimadzu modular system comprising an auto injector, a Phenomenex 5.0 μm beadsize guard column (50×7.5 mm) followed by four Phenomenex 5.0 μm bead-size columns (10⁵, 10⁴, 10³ and 10² Å) for DMAc system, two Phenomenex 5.0 μm bead-size columns (MIX C provided by Polymer Lab) for THF system, and a differential refractive-index detector and a UV-vis. detector. The system was calibrated with narrow molecular weight distribution polystyrene standards with molecular weights of 200 to 10⁶ g mol⁻¹. Aqueous GPC was conducted using a Shimadzu modular system comprising a DGU-12A solvent degasser, on LC-10AT pump, a CTO-10A column oven, and a RID-10A refractive index detector (flow rate: 0.8 ml/min). The column was equipped with a Polymer Laboratories 5.0 mm bead-size guard column (50×7.8 mm2) followed by three PL aquagel-OH columns (50, 40, 8 μm). Calibration was performed with PEO standards ranging from 500 to 500,000 g/mol.

UV-Vis Spectroscopy.

UV-vis spectra were recorded using a CARY 300 spectrophotometer (Varian) equipped with a temperature controller.

Nuclear magnetic resonance (NMR) spectroscopy was carried out on a Bruker DPX 300 spectrometer operating at 400 MHz for ¹H and 100 MHz for ¹³C using CDCl₃, DMSO-d₆, acetonitrile-d3 and D₂O as solvents and tetramethylsilane (TMS) as a reference. Data was reported as follows: chemical shift (δ) measured in ppm downfield from TMS.

Fluorescence Spectroscopy.

Fluorescence spectra were recorded using Agilent fluorescent spectrometer.

Reaction Setup.

Photopolymerizations were carried out under visible light irradiation by a 1 m blue LED strip (λₘₐₓ=435 nm, 4.8 Watts) surrounding the reaction vessels (see FIG. 4).

Experimental Procedure for the Kinetic Study of DMA in DMSO.

In a typical kinetic study experiment of DMA, a 6 mL glass vial equipped with a rubber septum was charged with DMA (1.68 g, 16.95 mmol), BTPA (20 mg, 0.084 mmol), Ru(bpy)₃Cl₂ (0.013 mg, 1.74×10⁻⁵ mmol, 260 μL of 0.05 mg/mL DMSO solution) and DMSO (1460 μL, total solvent=1720 μL) at a molar ratio of [Monomer]:[CTA]:[Ru(bpy)₃Cl₂]=202:1:0.000202 (leading to a catalyst concentration of 1 ppm with respect to the monomer) and a molar concentration of 10 M of the monomer with respect to the solvent. The reaction mixture was covered with aluminum foil and degassed with N₂ in a water bath for 30 min. After purging, the reaction vessel was sealed and was irradiated with blue LED light (LED strip, 4.8 Watts) at room temperature. Aliquots were withdrawn using nitrogen-purged syringes and predetermined time points and subsequently analyzed via ¹H NMR (CDCl₃) and GPC (DMAc) to measure the conversion, number-average molecular weight (Mₙ) and polydispersity (PDI), respectively.

Experimental Procedure for the Kinetic Study of DMA in H₂O.

In a similar manner to the method prescribed for the kinetic study of DMA in DMSO, the experiments in the different solvents utilized the same molar ratios; [Monomer]:[CTA]:[Ru(bpy)₃Cl₂]=202:1:0.000202 (leading to a catalyst concentration of 1 ppm with respect to the monomer) at a molar concentration of 10 M of the monomer with respect to the solvent. A 6 mL glass vial equipped with a rubber septum was charged with DMA (1.68 g, 16.95 mmol), BTPA (20 mg, 0.084 mmol), Ru(bpy)₃Cl₂ (0.013 mg, 1.74×10⁻⁵ mmol, 260 μL of 0.05 mg/mL H₂O solution) and milliQ H₂O (1460 μL, total solvent=1720 μL). Following addition of the reactants to a 6 mL glass vial covered with aluminum foil, the reaction mixture was degassed with N₂ in an ice bath for 30 min. After purging, the reaction vessels were irradiated under blue LED light (4.8 Watts) at room temperature. Nitrogen-purged syringes were used to withdraw aliquots at predetermined time points. Again, ¹H NMR (D₂O) and GPC (DMAc) analyses were performed to measure the conversion, number-average molecular weight (Mₙ) and the polydispersity (PDI).

Experimental Procedure for the Kinetic Study of DMA in Acetonitrile.

In a similar manner to the method prescribed for the kinetic study of DMA in DMSO, the experiments in the different solvents utilized the same molar ratios; [Monomer]:[CTA]:[Ru(bpy)₃Cl₂]=202:1:0.000202 (leading to a catalyst concentration of 1 ppm with respect to the monomer) at a molar concentration of 10 M of the monomer with respect to the solvent. A 6 mL glass vial equipped with a rubber septum was charged with DMA (1.68 g, 16.95 mmol), BTPA (20 mg, 0.084 mmol), Ru(bpy)₃Cl₂ (0.013 mg, 1.74×10⁻⁵ mmol, 260 μL of 0.05 mg/mL acetonitrile solution) and acetonitrile (1460 μL, total solvent=1720 μL). Following addition of the reactants to a 6 mL glass vial covered with aluminum foil, the reaction mixture was degassed with N₂ in an ice bath for 30 min. After purging, the reaction vessels were irradiated under blue LED light (4.8 Watts) at room temperature. Nitrogen-purged syringes were used to withdraw aliquots at predetermined time points. Again, ¹H NMR (acetonitrile-d₃) and GPC (DMAc) analyses were performed to measure the conversion, number-average molecular weight (Mₙ) and the polydispersity (PDI).

Experimental Procedure for the Kinetic Study of DMA in Methanol.

In a similar manner to the method prescribed for the kinetic study of DMA in DMSO, the experiments in the different solvents utilized the same molar ratios; [Monomer]:[CTA]:[Ru(bpy)₃Cl₂]=202:1:0.000202 (leading to a catalyst concentration of 1 ppm with respect to the monomer) at a molar concentration of 10 M of the monomer with respect to the solvent. A 6 mL glass vial equipped with a rubber septum was charged with DMA (1.68 g, 16.95 mmol), BTPA (20 mg, 0.084 mmol), Ru(bpy)₃Cl₂ (0.013 mg, 1.734×10⁻⁵ mmol, 260 μL of 0.05 mg/mL methanol solution) and methanol (1460 μL, total solvent=1720 μL). Following addition of the reactants to a 6 mL glass vial covered with aluminum foil, the reaction mixture was degassed with N₂ in an ice bath for 30 min. After purging, the reaction vessels were irradiated under blue LED light (4.8 Watts) at room temperature. Nitrogen-purged syringes were used to withdraw aliquots at predetermined time points. Again, ¹H NMR (CDCl₃) and GPC (DMAc) analyses were performed to measure the conversion, number-average molecular weight (Mₙ) and the polydispersity (PDI).

Experimental Procedure for the Kinetic Study of DMA in Toluene.

In a similar manner to the method prescribed for the kinetic study of DMA in DMSO, the experiments in the different solvents utilized the same molar ratios; [Monomer]:[CTA]:[Ru(bpy)₃Cl₂]=202:1:0.000202 (leading to a catalyst concentration of 1 ppm with respect to the monomer) at a molar concentration of 10 M of the monomer with respect to the solvent. A 6 mL glass vial equipped with a rubber septum was charged with DMA (1.68 g, 16.95 mmol), BTPA (20 mg, 0.084 mmol), Ru(bpy)₃Cl₂ (0.013 mg, 1.74×10⁻⁵ mmol, 260 μL of 0.05 mg/mL toluene solution) and toluene (1460 μL, total solvent=1720 μL). Following addition of the reactants to a 6 mL glass vial covered with aluminum foil, the reaction mixture was degassed with N₂ in an ice bath for 30 min. After purging, the reaction vessels were irradiated under blue LED light (4.8 Watts) at room temperature. Nitrogen-purged syringes were used to withdraw aliquots at predetermined time points. Again, ¹H NMR (CDCl₃) and GPC (DMAc) analyses were performed to measure the conversion, number-average molecular weight (Mₙ) and the polydispersity (PDI).

Experimental Procedure for the “ON”/“OFF” Study of DMA in H₂O.

In a similar manner to the method prescribed for the kinetic study of DMA in DMSO, the experiments in the different solvents utilized the same molar ratios; [Monomer]:[CTA]:[Ru(bpy)₃Cl₂]=202:1:0.000202 (leading to a catalyst concentration of 1 ppm with respect to the monomer) at molar concentration of 10 M of monomer with respect to the solvent. A 6 mL glass vial equipped with a rubber septum was charged with DMA (1.68 g, 16.94 mmol), BTPA (20 mg, 0.084 mmol), Ru(bpy)₃Cl₂ (0.013 mg, 1.74×10⁻⁵ mmol, 260 μL of 0.05 mg/mL H₂O solution) and milliQ H₂O (1460 μL, total solvent=1720 μL). Following addition of the reactants to a 6 mL glass vial covered with aluminum foil, the reaction mixture was degassed with N₂ in an ice bath for 30 min. After purging, the reaction vessels were irradiated under blue LED light (4.8 Watts) at room temperature. For the light “ON”/“OFF” study, the reaction mixture was initially irradiated for 2 h. Following this initial irradiation period, the light was turned off for an hour, then turned on again for x hours (x corresponds to 1 h, 2 h, 4 h and 6 h). Nitrogen-purged syringes were used to withdraw aliquots at 1 h (ON), 2 h (ON), 3 h (OFF), 4 h (ON), 5 h (OFF) and 6 h (ON). Again, ¹H NMR (D₂O) and GPC (DMAc) analyses were performed on the aliquots to measure the conversion, number-average molecular weight (Mₙ) and the polydispersity (PDI).

Experimental Procedure for the Chain Extension of PDMA with DEGA, NIPAAm or OEGA in H₂O.

In a similar manner to the method prescribed for the kinetic study of DMA in DMSO, PDMA was synthesized using DMA (847 mg, 8.540 mmol), BTPA (10 mg, 0.042 mmol), Ru(bpy)₃Cl₂ (0.0325 mg, 4.34×10⁻⁵ mmol, 65 μL of 0.5 mg/mL H₂O solution) and milliQ H₂O (795 μL, total solvent=860 μL) in a 6 mL glass vial equipped with a rubber septum. The reaction mixture was covered with foil then degassed with N₂ in an ice bath for 30 mins. Following degassing, the reaction vessel was placed under blue LED light and was irradiated for 3 h. The reaction mixture was then purified by dialysis against water for 24 h with water changed at 3 h and 16 h. The sample was then freeze dried overnight and was analyzed via ¹H NMR (CDCl₃) and GPC (DMAc). The purified sample was then chain extended with OEGA in H₂O. PDMA (50 mg, 0.00313 mmol, Mₙ=17 150 g/mol (GPC)), OEGA (63 mg, 0.131 mmol), Ru(bpy)₃Cl₂ (0.0002 mg, 2.67×10′ mmol, 10 μL of 0.05 mg/mL H₂O solution) and milliQ H₂O (1000 μL, total solvent=1010 μL). The ratio of [Monomer]:[macroCTA]:[Ru(bpy)₃Cl₂] was 42:1:0.0002. The reaction mixture was covered with aluminum foil then degassed with N₂ in an ice bath for 30 mins. Following degassing, the reaction vessel was placed under blue LED light and was irradiated for 40 h. After 40 h, the reaction mixture was analysed via ¹H NMR (CDCl₃) and GPC (DMAc) to measure the final conversion, number average molecular weight (Mₙ) and the polydispersity (PDI).

Experimental Procedure for the Chain Extension of PNIPAAm with DMA in H₂O.

In a similar manner to the method prescribed for the kinetic study of DMA in DMSO, poly-N-isopropylacrylamide (PNIPAAm) was synthesized using N-isopropylacrylamide (NIPAAm) (957 mg, 8.540 mmol), BTPA (10 mg, 0.042 mmol), Ru(bpy)₃Cl₂ (0.0065 mg, 8.68×10⁻⁶ mmol, 130 μL of 0.05 mg/mL H₂O solution) and milliQ H₂O (730 μL, total solvent=860 μL) in a 6 mL glass vial equipped with a rubber septum. The reaction mixture was covered with foil then degassed with N₂ in an ice bath for 30 mins. Following degassing, the reaction vessel was placed under blue LED light and was irradiated for 4 h. The reaction mixture was then purified by dialysis against water for 24 h with water changed at 3 h and 16 h. The sample was then freeze dried overnight and was analyzed via ¹H NMR (CDCl₃) and GPC (DMAc). The purified sample was then chain extended with DMA in H₂O. PNIPAAm (50 mg, 0.00256 mmol, Mₙ=18,250 g/mol (GPC)), DMA (50 mg, 0.505 mmol), Ru(bpy)₃Cl₂ (0.0002 mg, 2.67×10⁻⁷ mmol, 10 μL of 0.05 mg/mL H₂O solution) and milliQ H₂O (1000 μL, total solvent=1010 μL). The ratio of [Monomer]: [macroCTA]:[Ru(bpy)₃Cl₂] was 200:1:0.0002. The reaction mixture was covered with aluminum foil then degassed with N₂ in an ice bath for 30 mins. Following degassing, the reaction vessel was placed under blue LED light and was irradiated for 4 h. After 4 h, aliquots were removed for ¹H NMR (CDCl₃) and GPC (DMAc) analyses. The remainder of the reaction mixture was kept in darkness for 10 hr. Degased DMA (100 mg, 1010 mmol) in water (0.5 mL) was added to the solution and then irradiated under blue LED light for a further 10 h. Finally, the reaction mixture was analysed GPC (DMAc) to measure the final conversion, number average molecular weight (Mₙ) and the polydispersity (PDI).

Experimental Procedure for the Kinetic Study of DMA in Biologic Media.

In a similar manner to the method prescribed for the kinetic study of DMA in water, using the molar ratio of [Monomer]:[BTPA]:[Ru(bpy)₃Cl₂]=202:1:0.00202 (leading to a catalyst concentration of 10 ppm with respect to the monomer) at a molar concentration of 10 M of the monomer with respect to the solvent. A 6 mL glass vial equipped with a rubber septum was charged with DMA (1.68 g, 16.95 mmol), BTPA (20 mg, 0.084 mmol), Ru(bpy)₃Cl₂ (0.13 mg, 1.74×10⁴ mmol, 260 μL of 0.5 mg/mL H₂O solution) and H₂O/fetal bovine serum (90/10 v/v) (1460 μL, total solvent=1720 μL). Following addition of the reactants to a 6 mL glass vial covered with aluminum foil, the reaction mixture was degassed with N₂ in an ice bath for 30 min. After purging, the reaction vessels were irradiated under blue LED light (4.8 Watts) at room temperature. Nitrogen-purged syringes were used to withdraw aliquots at predetermined time points. Again, ¹H NMR (CDCl₃) and GPC (DMAc) analyses were performed to measure the conversion, number-average molecular weight (Mₙ) and the polydispersity (PDI).

### Synthesis of 2-(pyridin-2-yldisulfanyl)ethyl 2-(((butylthio)carbonothioyl)thio) propanoate (PDS-BTP)

Hydroxyethyl pyridyldisulfide was prepared according to a procedure similar to that previously reported, e.g. N. Murthy, J. Campbell, N. Fausto, A. S. Hoffman, P. S. Stayton, Bioconjugate Chem. 2003, 14, 412-419. The yield was 60%. The product was analyzed by ¹H NMR: (CDCl₃, 400 MHz), δ (ppm from TMS): 3.00 ppm (2H, p, —CH₂—S—S—), 3.80 ppm (2H, t, —CH₂—OH), 5.30 (1H, s, —OH), 7.1 (1H, m, aromatic hydrogen meta to nitrogen, 7.70 (2H, m, para to nitrogen and ortho to thiol derivatized carbon), 8.45 (1H, q, aromatic hydrogen ortho to nitrogen); and by ¹³C NMR, a (ppm from TMS): 30.50 (CH₂—S—), 58.85 (HO—CH₂), 119.30 121.70, 138.02, 149.51, 159.23 (CH of Ar).

2-(n-Butyltrithiocarbonate)-propionic acid (BTPA) (1 g, 4.20×10⁻³ mol) was introduced in round bottom flask (50 mL). 20 mL of dichloromethane, 4-dimethylaminopyridine (DMAP, 25 mg, 2.10×10⁻⁴ mol) and N,N′-dicyclohexylcarbodiimide (0.95 g, 4.62×10⁻³ mol) were introduced in the round bottom flask and the flask was placed in ice bath. Hydroxyethyl pyridyldisulfide (0.863 g, 4.62×10⁻³ mol) was added to the solution. The solution was stirred overnight. The solution was filtered, and the solution was concentrated to yield a yellow product. The crud product was purified by column chromatography, using a mixture of ethyl acetate/hexane (30/70, v/v). The solvent was removed by vacuum to yield yellow oil (yield 65%). The product was analyzed by ¹H NMR spectroscopy (SI, Figure S16).

### Synthesis of BSA-macroinitiator (BSA-MI)

81 mg (1×10⁻⁴ mol) of 2-(pyridin-2-yldisulfanyl)ethyl 2-(((butylthio)carbonothioyl)thio)propanoate (PDS-BTP) was dissolved in 1 ml of DMF and added dropwise to bovine serum albumin (BSA) solution (50 g/L, 7.5×10⁻⁶ mol diluted in phosphate buffer solution (pH=6), total volume: 10 mL) to prepare BSA-macroinitiator. The mixture was gently shaken for 14 h at room temperature. An aliquot was taken and analyzed by UV-vis spectrometer to detect the presence of 2-pyridinethione, a by-product of the conjugation reaction, which appears at the maximum of 350 nm. The excess of PDS-BTP was precipitated in water (40 mL), and the solution was centrifuged (5000 rcf for 5 min) to eliminate the excess of unreacted PDS-BTP. The solution was dialyzed against water to remove the trace of DMF and other impurities for 1 day. Then, the solution was freeze dried to yield a white/yellow powder (35 mg, yield 70%). BSA-MI (50 g/1) was re-dispersed in water.

Polymerization of DMA and OEGA Using BSA-Macroinitiator (BSA-MI).

200 mg (3.0 μmol) of BSA, (i.e. 55 mol % free BSA and 45 mol % BSA-MI) was dissolved in 5 ml of phosphate buffer (pH=6). A DMA monomer solution (4 mL, 0.5 M, 2 mmol) in phosphate buffer was added slowly to the BSA-MI solution. The flask was covered by aluminum foil. A solution of Ru(bpy)₃Cl₂ was added to the mixture. The final concentration ratios were as follows: [DMA]:[BSA-MI]:[Ru(bpy)₃Cl₂]=1200.0:1.0:12×10⁻³. Following the sealing of the vials with rubber septa, the polymerization solutions were deoxygenated for 30 min in an ice bath. After purging, the reaction vessels were irradiated under blue LED light (4.8 Watts) at room temperature. Nitrogen-purged syringes were used to withdraw aliquots at predetermined time points. Aliquots were taken at predetermined time intervals and quenched via rapid cooling and exposure to oxygen. These samples were directly analyzed by ¹H NMR to determine the molecular weight and the monomer conversion, respectively and also by aqueous GPC analysis. Polymerization samples were treated with a solution containing tris(2-carboxyethyl)phosphine hydrochloride (TCEP) (0.5 mg/ml, 1.7 M) and incubated at 25° C. for 4 hrs. Samples were freeze dried and re-dissolved in DMAc (for 14 hrs at room temperature). The samples were then filtered through a 0.45 μm filter and analyzed by DMAc GPC.

Measurement of Enzyme-Like Activity of BSA.

0.100 mL of BSA or BSA conjugate solution ([BSA]=0.27 mM) in phosphate buffer (pH 8), 10 μL of nitrophenyl acetate dissolved in acetonitrile (10 mM) and 0.900 mL of phosphate buffer solution (pH 8) were rapidly mixed and incubated at room temperature for 20 min. At the end of exact incubation time, absorbance at 405 nm was measured for each sample to evaluate the activity, and normalized using native BSA. Activity measurements were performed with two different samples in triplicates. The results represent the average of 6 measurements±standard deviation.

Results and Discussion

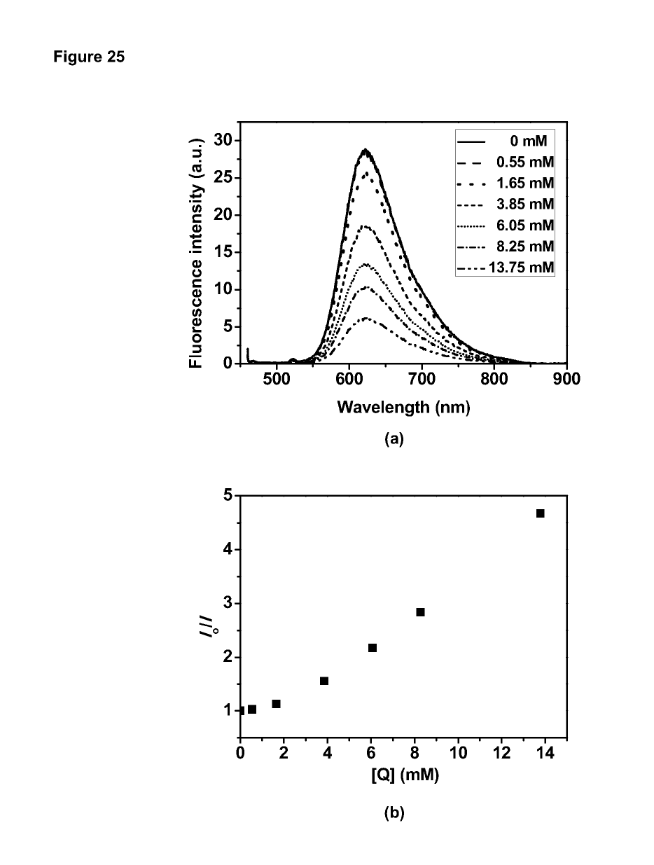

In this Example, a photocontrolled radical polymerization of a diverse range of monomers (methacrylates, acrylates, acrylamides) performed in aqueous and biological media, using a commercially available water soluble photoredox catalyst, Ru(bpy)₃Cl₂, is described. The catalyst can be employed for the in-situ polymerization from biomacromolecules, such as protein, to generate protein-polymer bioconjugates under low energy light irradiation without sacrificing the bioactivity of the protein. Regarding the proposed mechanism as shown in FIG. 20, the photoredox catalyst (Ru(bpy)₃Cl₂, Ru^{(II)}; FIG. 21) generated an excited species (Ru^{(II)}*) under visible light irradiation, which was then able to reduce thiocarbonylthio compounds via photoinduced electron transfer (PET). The PET mechanism was demonstrated by fluorescence quenching study (or Stern-Volmer quenching) (FIGS. 24 and 25). FIG. 25(b) shows a plot of the ratio Iₒ/I versus quencher concentration, from fluorescence quenching (Stern-Volmer) studies of a 6.68 μM solution of Ru(bpy)₃Cl₂ in DMSO with varying concentrations of thiocarbonylthio compound CPADB. Iₒ and I correspond to the emission intensity in the absence and presence of quencher, respectively. Plotting the ratio Iₒ/I versus the quencher concentration showed a non-linear relationship, indicative of both dynamic and static quenching behaviors. In the case of dynamic quenching (also called collisional quenching), the excited state of photoredox catalyst Ru(bpy)₃Cl₂ transfers the energy to the thiocarbonylthio compound, whereas static quenching results in the formation of a complex. This plot demonstrates that a reductive or oxidative quenching is operative via photoinduced electron transfer (PET).

The PET mechanism results in the generation of radicals (Pₙ^{}) and Ru^{(III)} species (FIG. 21) via an oxidative quenching mechanism. The generated radical (P^{}) is able to initiate polymerization of monomers and participate in the reversible addition-fragmentation chain transfer (RAFT) process or it can be deactivated by Ru^{(III)} which results in regeneration of the initial Ru^{(II)}. The regeneration of the starting Ru^{(II)} species restarts the catalytic cycle and is in stark contrast to the conventional RAFT polymerization mechanism; the thiocarbonylthio compound in this technique acts as both an initiator and a chain transfer agent. The elimination of the consumable initiator species is highly advantageous in both laboratory and industrial settings. The PET-RAFT technique is even more attractive when considering the ability to perform polymerizations at room temperature using low energy, household grade visible light sources (1-4.8 W) along with catalyst doses in the ppm range.

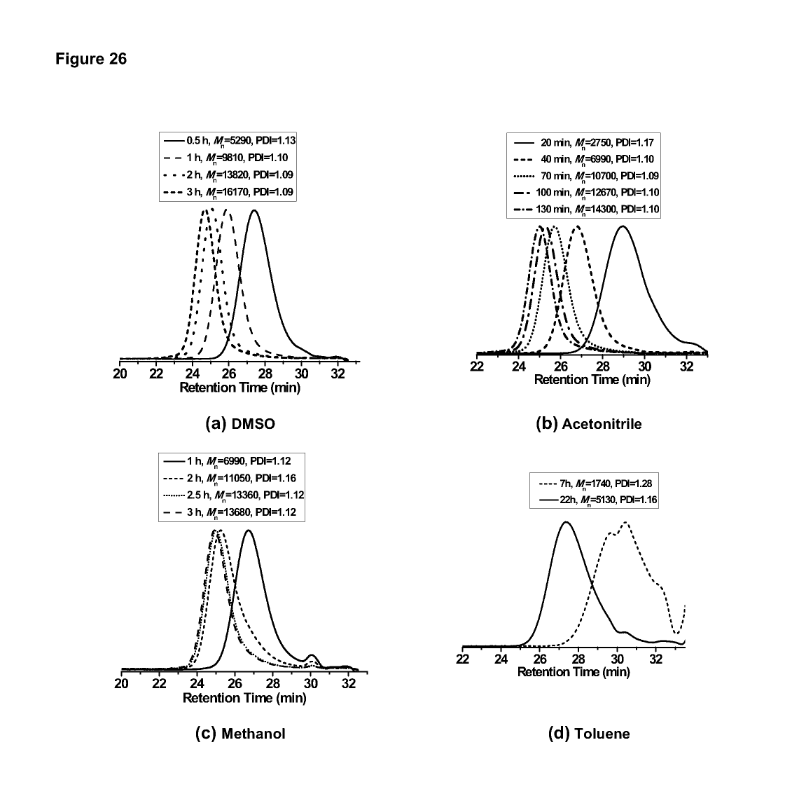

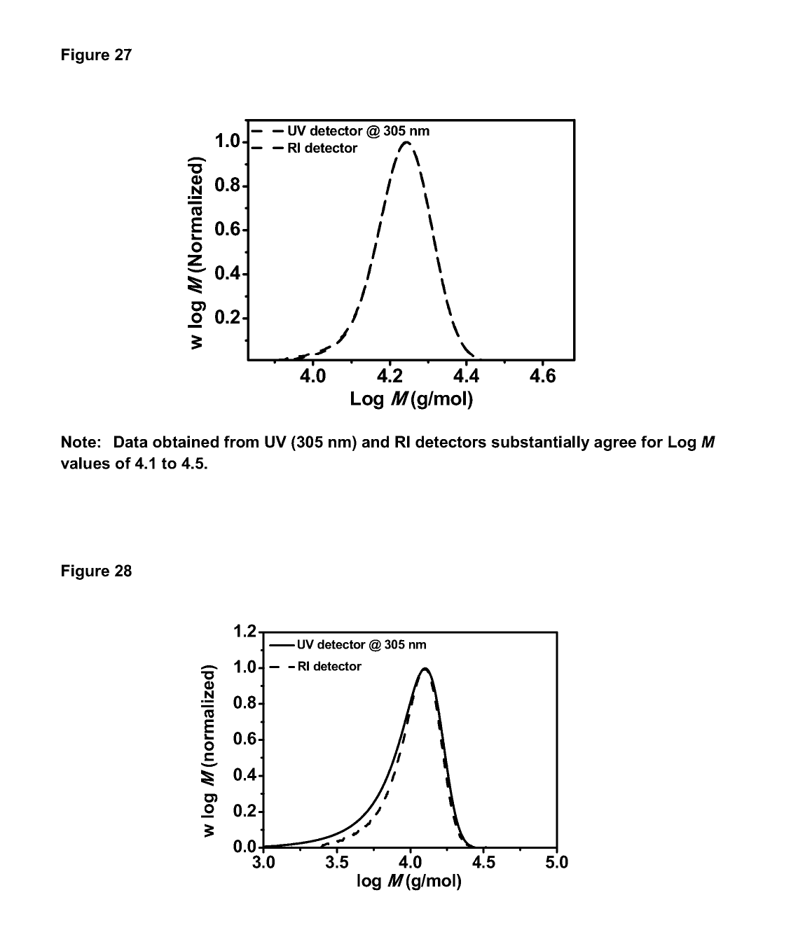

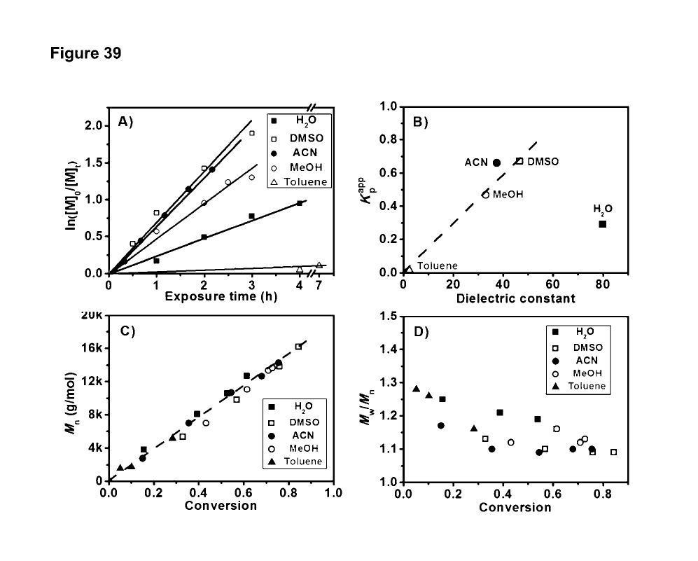

Since Ru(bpy)₃²⁺ presents good solubility in a large range of solvents, the process was tested in solvents commonly employed for polymerization. N,N′-dimethylacrylamide (DMA) was employed as a model monomer due to its good solubility in both organic solvents and water. The solvents examined include dimethyl sulfoxide (DMSO), acetonitrile, methanol, toluene and water. For all these solvents, we observed that the plot of In([M]₀/[M]ₜ) followed a linear relationship in accord with the principle of living radical polymerization (FIG. 39A). Moreover, the solvents had a strong effect on the apparent propagation rate (kₚ^{app}), which increased with the dielectric constant of the solvents, except in the case of water (FIG. 39B). Previous reports (e.g. V. Percec, T. Guliashvili, J. S. Ladislaw, A. Wistrand, A. Stjerndahl, M. J. Sienkowska, M. J. Monteiro, S. Sahoo, J. Am. Chem. Soc. 2006, 128, 14156-14165.) have demonstrated that a higher dielectric constant allows for better stabilization of the radical intermediates, i.e. higher kₚ^{app}. However, in this Example water was an exception, where the polymerization rate was lower than expected, likely due to the reduction in efficacy of the fully solvated catalyst in water relative to other solvents. The slight decrease in the efficiency of the catalyst was also confirmed by a slightly higher molecular weight distribution (MWD) obtained in water in comparison to organic solvents. Although, the polymerizations performed in organic solvents and water still showed excellent control of the molecular weights and MWDs (FIGS. 39C, 39D, and 26).

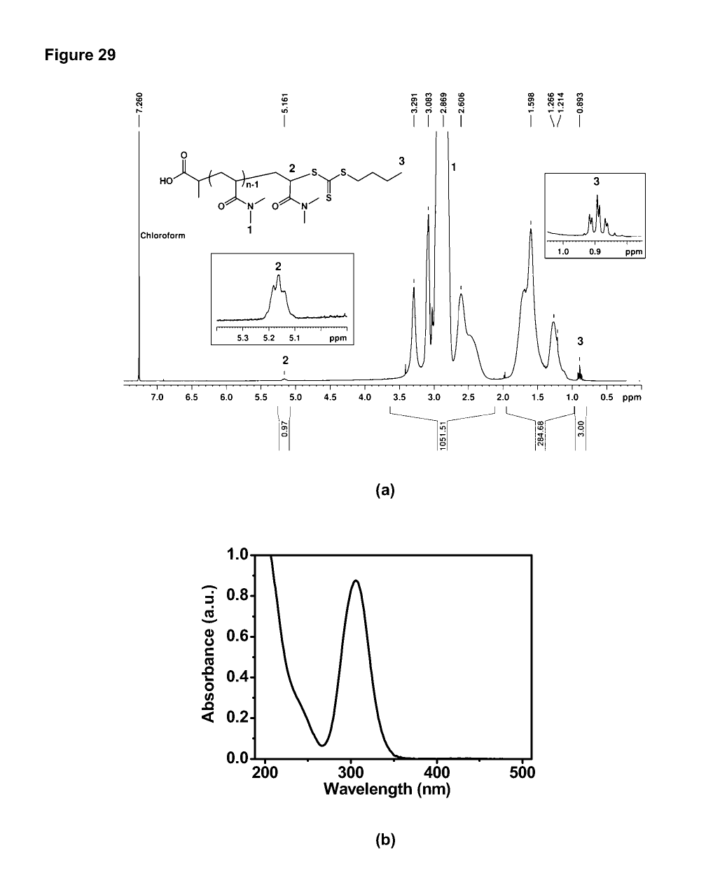

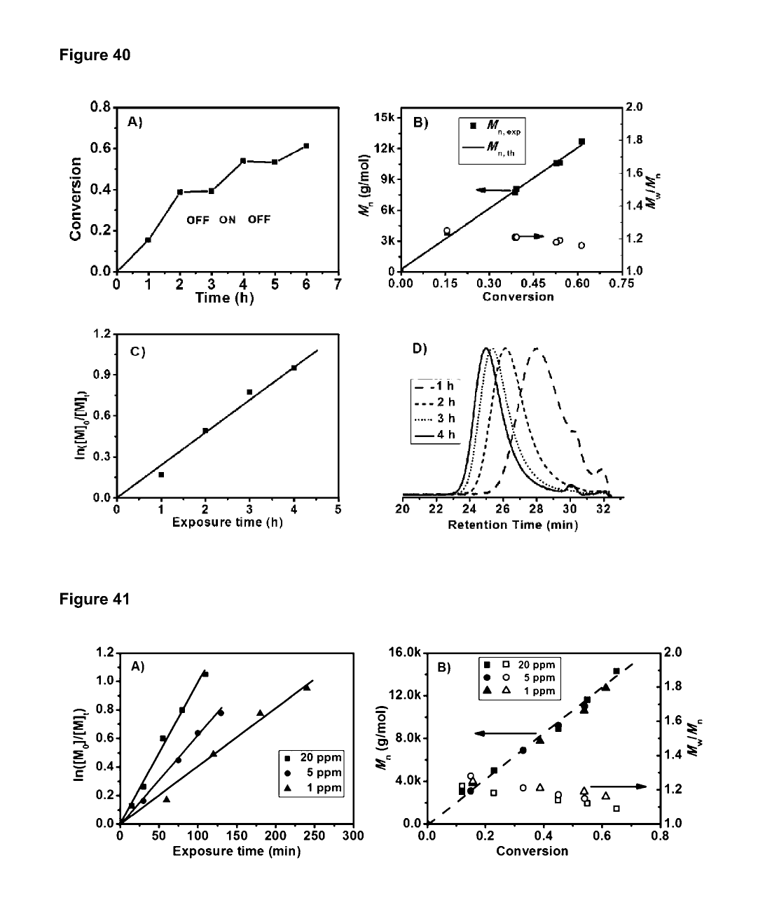

After demonstrating that the polymerization can be performed in a range of different organic solvents with DMA, the detailed kinetics of the polymerization of DMA in water was investigated. To demonstrate that the polymerization can be activated and deactivated by light, we performed polymerizations exposed to an alternating sequence of light “ON” and “OFF” environment using a molar ratio of [DMA]:[BTPA]:[Ru(bpy)₃Cl₂] equal to 202:1:2×10⁻⁴. In the absence of light, no polymerization was observed, whilst when the light was “ON”, the polymerization proceeded as expected (FIG. 40A). The plot of molecular weights measured by gel permeation chromatography (GPC) using RI detector (M_{n, GPC-RI}) versus total exposure time gave a linear relationship in perfect agreement with the theoretical values (M_{n, theo}, (FIG. 40B). To confirm the presence of the trithiocarbonate end-group, we also determined the molecular weight using a GPC equipped with an UV-vis detector at λ=305 nm as the thiocarbonyl bond (C═S) presents a strong absorption at this wavelength. Both RI and UV detectors showed similar MWDs, which confirmed the presence of trithiocarbonate group (FIG. 28). Similarly, PDMA prepared by PET-RAFT polymerization was purified by several precipitations in petroleum ether, and subsequently analysed by nuclear magnetic resonance (NMR) and UV-vis spectroscopy. The signal at δ 4.6 ppm observed by ¹H NMR is characteristic of the CH adjacent to the trithiocarbonate group (FIG. 29) and the absorbance peak at 305 nm in UV-vis spectrum confirmed the presence of C═S group. The end group fidelity of trithiocarbonate group, calculated using PDMA of Mₙ=17 150 g/mol, was determined to be close to 100% using both NMR and UV-vis analysis (FIG. 29). Additional kinetics with different concentrations of catalyst (5 ppm and 20 ppm relative to monomer) were conducted to evaluate their effect on the polymerization rates. The increase of catalyst concentration resulted in an acceleration of the polymerization (kₚ^{app}) as expected by our proposed mechanism (FIG. 41A), whilst a surprisingly slight decrease of the polydispersity (PDI) was noted at higher concentrations of catalyst in water (FIG. 41B). Such a result is paradoxical to conventional controlled/living radical polymerization mechanism, as fast polymerization has been reported to result in the formation of a greater amount of dead polymers, consequently resulting in a higher PDI value. However, in the process of Example 3 Ru(bpy)₃Cl₂ acts as both an activator and a deactivator, regulating the amount of active chains throughout the polymerization. This dual action could explain the decrease in the PDI at high concentrations of catalyst.

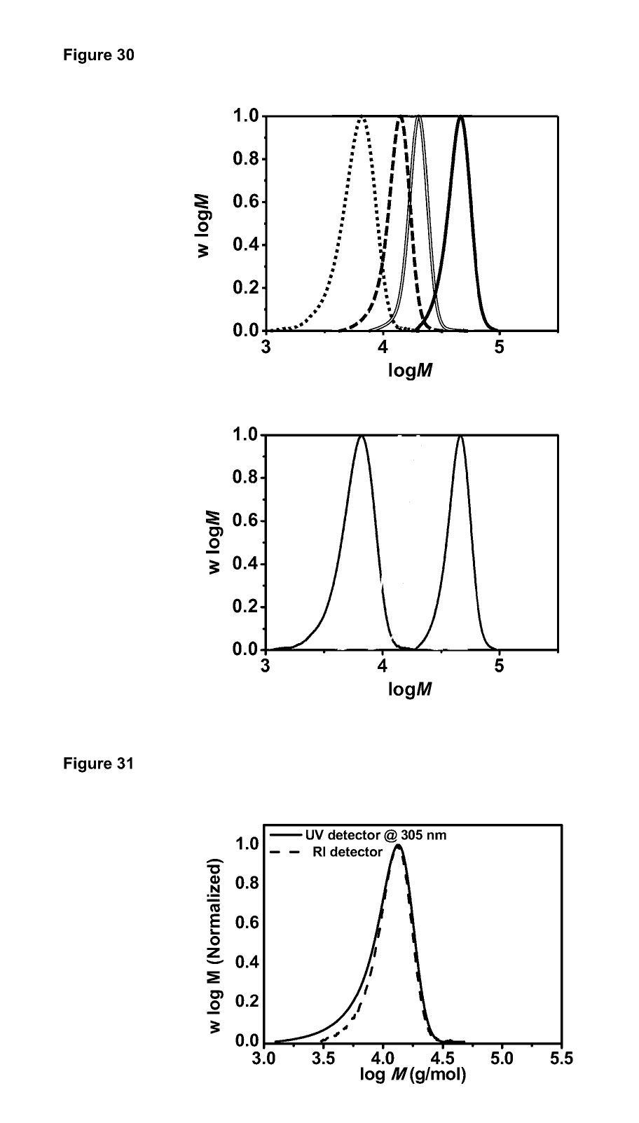

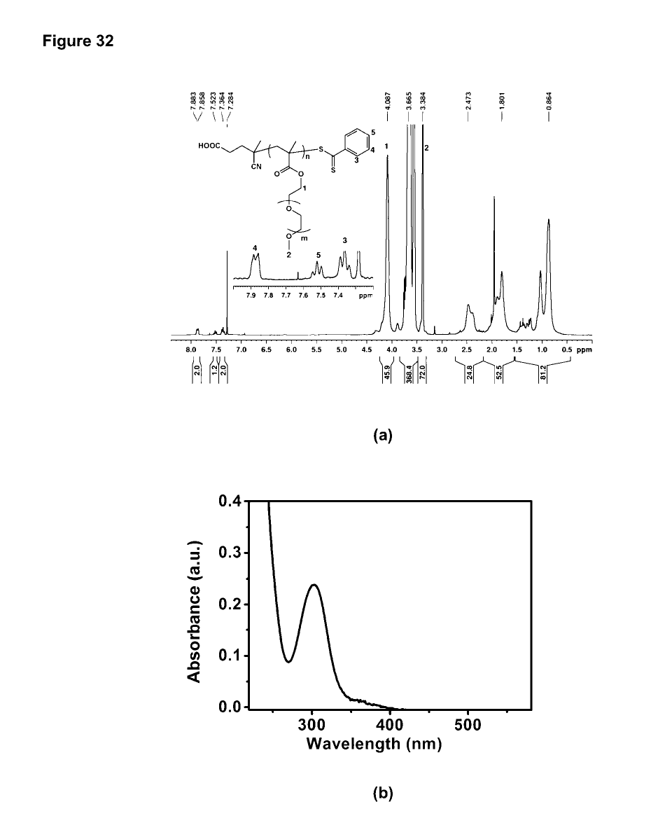

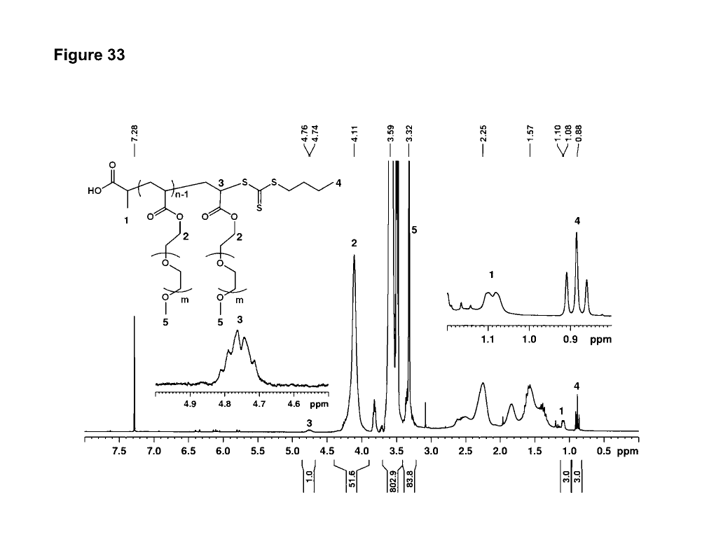

Following the work on DMA, the versatility of this system was tested for the polymerization of other water soluble monomers, including oligo(ethyleneglycol) methyl ether (meth)acrylate (OEGA and OEGMA), N,N′-diethylacrylamide (DEA), and N-isopropylacrylamide (NIPAAm). The polymerizations were performed using BTPA as the thiocarbonylthio compound for OEGA, DEA, and NIPAAm, while CPADB was employed for OEGMA; all polymerizations were performed in water under a 4.8 W blue LED light. Table 2 presents the details for these polymers synthesized by PET-RAFT polymerization in water. All polymers displayed narrow MWDs and good control of the molecular weights. In addition, the theoretical molecular weight values agreed with the experimental values determined by GPC and NMR. By varying the amount of thiocarbonylthio compounds, different molecular weights were prepared ranging from 6 000 g/mol to 62 000 g/mol (FIG. 30). Homopolymers with molecular weights around 10 000 g/mol were purified by dialysis and analyzed using UV-vis, NMR and GPC equipped with a dual RI and UV detector (FIGS. 31, 32 and 33) to confirm the presence of the thiocarbonylthio end-group. The presence of dithibenzoate end-group was confirmed by ¹H NMR for POEGMA (FIG. 32); the signals at a δ 7.3 ppm, 7.4 ppm and 7.8 ppm are attributed to benzyl group of CPADB.

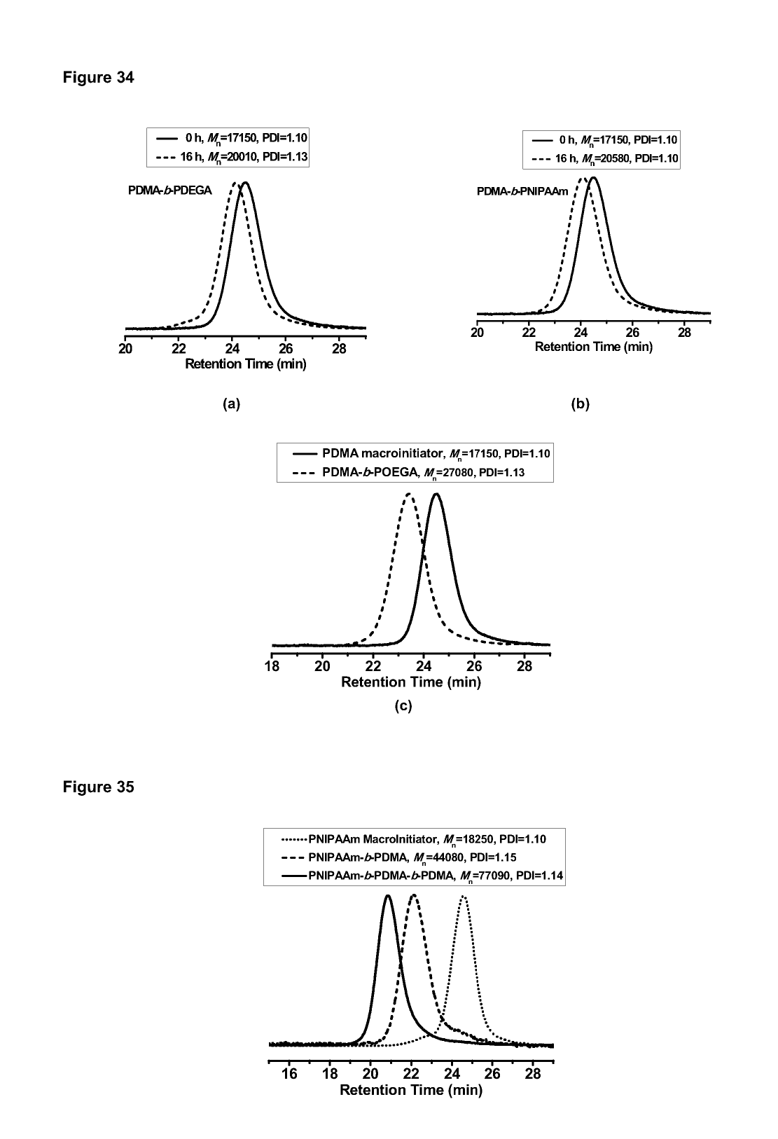

To further investigate the livingness (i.e. end group fidelity), we decided to chain extend PDMA and PNIPAAm macroinitiators in water. We first synthesized a PDMA macroinitiator (M_{n, GPC}=17 150 g/mol) using BTPA and 5 ppm of catalyst for 3 h in water. The polymer was then purified by dialysis against water, and freeze dried to yield a light yellow powder. In a second step, PDMA was chain extended in the presence of diethyleneglycol acrylate (DEGA), NIPAAm or OEGA to yield PDMA-b-PDEGA, PDMA-b-PNIPAAm or PDMA-b-POEGA diblock copolymers. GPC revealed a complete shift of the starting macro-initiator to low retention time with low M_{w}/Mₙ values (<1.15) (FIG. 34). To illustrate the temporal control, we decided to prepare a triblock copolymer: PNIPAAm-b-PDMA-b-PDMA, by successive addition (FIG. 35). PNIPAAm macroinitiator (Mₙ=18 250 g/mol) was prepared using a similar procedure as described for the PDMA macroinitiator. After purification, PNIPAAm was chain extended in the presence of DMA for 5 h under 4.8 W blue LED light to yield PNIPAAm-b-PDMA (Mₙ=44 080 g/mol), and then, the light was turned “OFF” for 14 h. Finally, the diblock polymer was again exposed to light for 3 h and chain extended in the presence of an additional amount of DMA. NMR showed an increase of the conversion after light irradiation. GPC revealed the successful formation of diblock copolymer (PNIPAAm-b-PDMA) and block copolymer (PNIPAAm-b-PDMA-b-PDMA) with a narrow MWD (PDI<1.15).

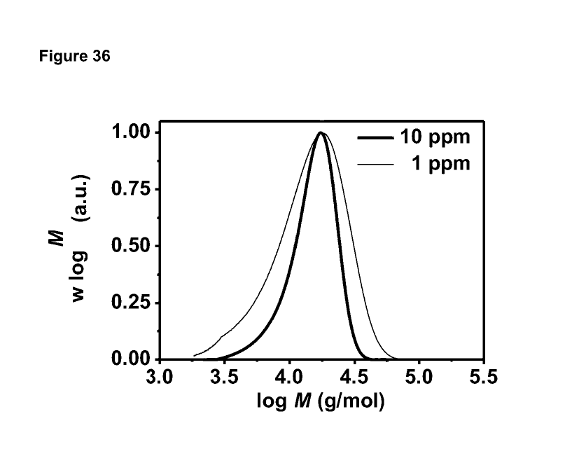

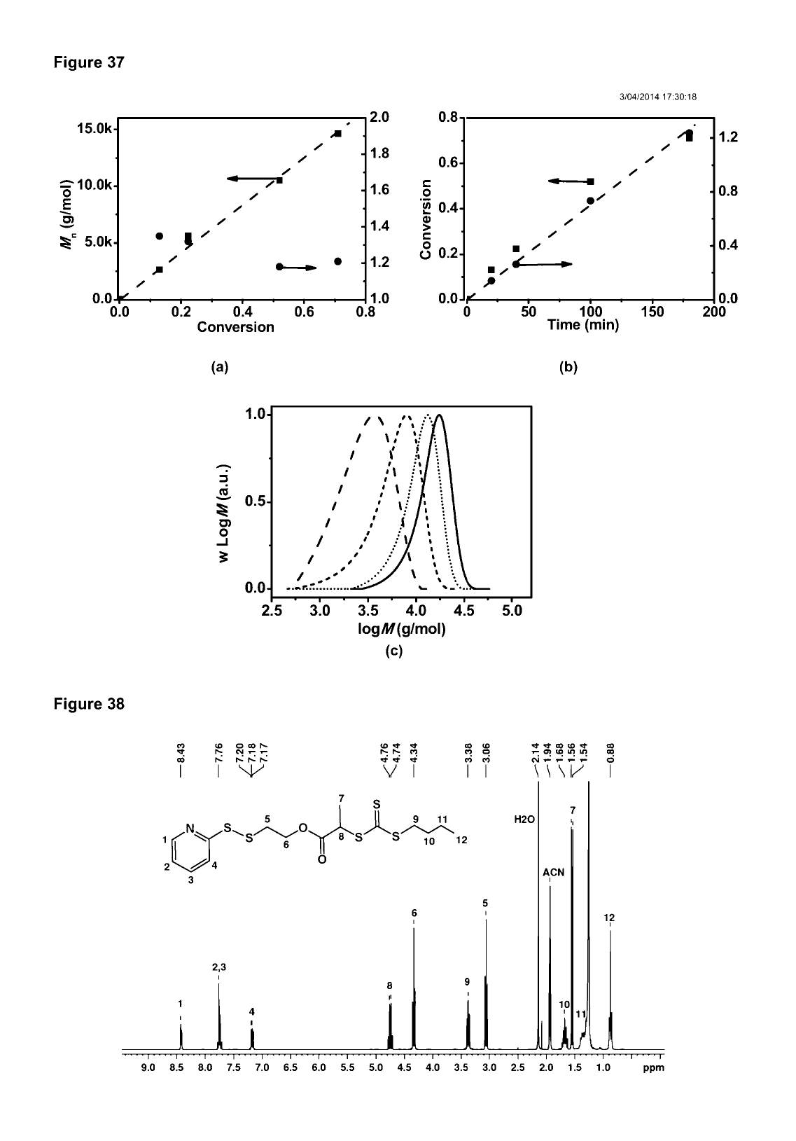

This polymerization technique was then tested in biological media to demonstrate its biocompatibility. A media was employed containing 10% of serum (fetal bovine serum, which has been widely used in biomedical research). Initial attempts were performed using DMA as monomer using a molar ratio [DMA]:[BTPAHRu(bpy)₃Cl₂] equal to 202:1:2×10⁻⁴ for 4 h. Under these conditions, a low monomer conversion and a relative broad PDI (PDI>1.5) was obtained, which is attributed to possible interactions between the catalyst and the media inducing partial deactivation of the catalyst. A longer polymerization (24 h) was also investigated, which resulted in a higher monomer conversion, but also in the production of broad and asymmetric MWD (PDI>1.5; FIG. 36). When the concentration of the catalyst ([DMA]:[BTPA]:[Ru(bpy)₃Cl₂] equal to 202:1:2×10⁻³) was increased, the polymerization of DMA reached 95% monomer conversion within 4 h to yield PDMA with good agreement between both theoretical and experimental molecular weights (M_{n, GPC}=20 500 g/mol, M_{n, th}=19 500 g/mol), and a narrow and symmetrical MWD (PDI=1.21, FIGS. 36 and 37).

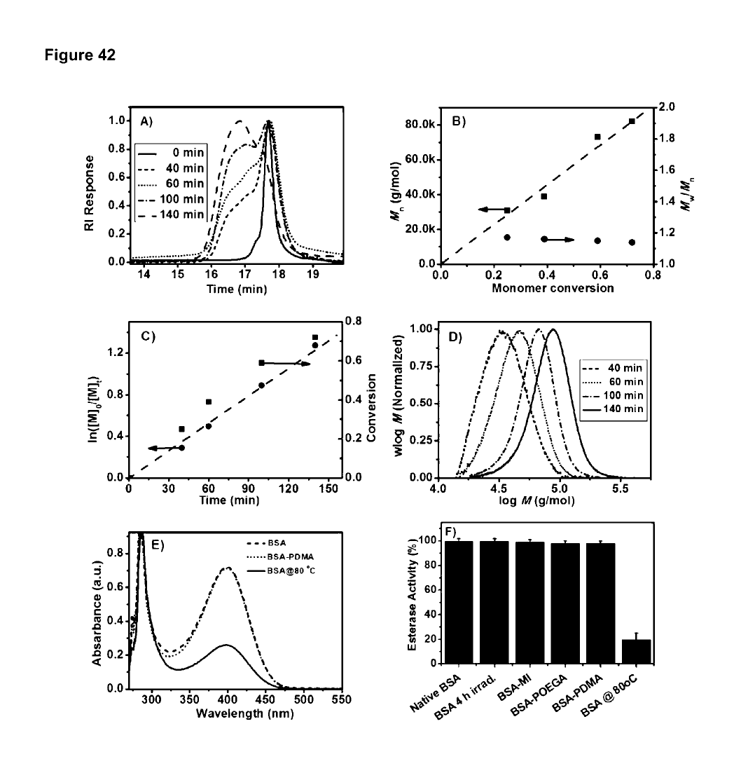

Considering the unique properties of PET-RAFT polymerization (i.e., extremely mild conditions, low catalyst concentration, compatibility with biological media, and low energy light source), this technique may advantageously be used for in-situ polymerization of water soluble monomers from biomolecules, such as proteins. This versatility was exploited for the preparation of protein-polymer bioconjugates. Bovine serum albumin (BSA) was chosen as a model protein, as it is relatively inexpensive and can be easily modified using the free thiol at Cys-34 residue, although 55% of BSA contains an oxidized thiol. To modify the thiol of BSA a thiocarbonylthio compound (PDS-BTP; FIG. 38) was designed and synthesized. PDS-BTP contains a thiol-reactive group, pyridyl disulfide, which is able to react with the free thiol of BSA to give a thiocarbonylthio functionalized protein. The attachment of the thiocarbonylthio functionality to BSA was performed using PDS-BTP in excess (20 equivalents) in a mixture of water/DMF (90/10, v/v) at 6° C. After 14 h, the excess PDS-BTP was removed by precipitation in a large volume of water, followed by dialysis against water. UV-vis analysis of the solution showed the presence of 2-pyridinethione with a characteristic UV-absorption signal at 350 nm (by-product forming upon the reaction, data not shown). BSA-macroinitiator (BSA-MI; that is, the thiocarbonylthio modified BSA) was freeze dried to yield a powder, and redispersed in water. GPC analysis of purified BSA-MI showed a monomodal peak (FIG. 4A). OEGA and DMA were polymerized in aqueous buffer solution (pH=6.5) at room temperature in the presence of BSA-MI and Ru(bpy)₃Cl₂ catalyst under 4.8 W blue LED light. The molar ratio of [Monomer]:[BSA-MI]:[Ru(bpy)₃Cl₂] was fixed to 1200:1:12×10⁻³. Aliquots of reaction mixtures were withdrawn at predetermined time intervals and analyzed by aqueous GPC and ¹H NMR to determine molecular weights and monomer conversions, respectively. FIG. 42C depicts the evolution of In([M]₀/[M]ₜ) versus time. The linear plot of In([M]₀/[M]ₜ) versus time indicated the system was in stationary state. Aqueous GPC revealed the formation of macromolecules having a hydrodynamic volume larger than that of BSA. It is worth noting that aqueous GPC revealed the presence of unreacted BSA attributed to the presence of free BSA without thiocarbonylthio moieties. To confirm the controlled nature of the polymerization, the disulfide bond between BSA and polymers were cleaved in the presence of tris(2-carboxyethyl)phosphine (TCEP). The mixtures were then analysed by DMAc GPC. The increase in the molecular weight of the in-situ grown polymer chains with increasing monomer conversion was demonstrated by DMAc GPC analysis, with good control of the molecular weight distribution (FIGS. 42B, 42C, and 42D).

Additionally, BSA activity was evaluated by the hydrolysis of p-nitrophenylacetate (standard assay) indicating that BSA showed esterase-like activity towards arylester. As previously described in, e.g. P. De, M. Li, S. R. Gondi, B. S. Sumerlin, J. Am. Chem. Soc. 2008, 130, 11288-11289; J. Geng, G. Mantovani, L. Tao, J. Nicolas, G. Chen, R. Wallis, D. A. Mitchell, B. R. G. Johnson, S. D. Evans, D. M. Haddleton, J. Am. Chem. Soc. 2007, 129, 15156-15163; or J. Liu, V. Bulmus, D. L. Herlambang, C. Barner-Kowollik, M. H. Stenzel, T. P. Davis, Angew. Chem. Inter. Ed. 2007, 46, 3099-3103, this enzyme-like activity requires the conformational integrity of the protein. Finally, the p-nitrophenylacetate hydrolysis activity was tested of native BSA along with the in-situ generated BSA-polymer conjugates and BSA incubated under light and at 80° C. as control experiments. Native BSA and BSA-MI showed almost the same activity (FIGS. 42E and 42F), whilst 98% of the original activity of BSA (with uncertainty of ±2%) was retained for BSA-POEGA and BSA-PDMA bioconjugates.

TABLE 2
Examples of homopolymers synthesized by PET-RAFT polymerization in water.

| | | | | | [Catalyst] | | | | | |
|---|---|---|---|---|---|---|---|---|---|---|
| | | | | | (ppm to | Time | a | | M_{n,exp} | |
| | [M]:[CTA]:[Ru] | | Monomer | CTA | Monomer) | (h) | (%) | M_{n,th} | (GPC) | PDI |
| 1 | 70:1:3.5 | × 10⁻⁴ | POEGMA | CPADB | 5 | 22 | 40 | 8680 | 9470 | 1.18 |
| 2 | 50:1:2.5 | × 10⁻⁴ | POEGA | BTPA | 5 | 22 | 42 | 10080 | 15400 | 1.29 |
| 3 | 200:0:0 | | DMA | — | 0 | 4 | 4 | 1030 | 356000 | 3.68 |
| 4 | 200:0:2 | × 10⁻⁴ | DMA | — | 1 | 4 | 4.8 | — | — | — |
| 5 | 200:1:2 | × 10⁻⁴ | DMA | BTPA | 1 | 4 | 61.3 | 12450 | 12690 | 1.16 |
| 6 | 200:1:10 | × 10⁻⁴ | DMA | BTPA | 5 | 2 | 65 | 14900 | 14300 | 1.09 |
| 7 | 1000:1:10 | × 10⁻⁴ | DMA | BTPA | 1 | 4 | 62 | 62300 | 61500 | 1.12 |
| 8 | 500:1:5 | × 10⁻⁴ | DMA | BTPA | 1 | 4 | 65 | 32800 | 29000 | 1.10 |
| 9 | 100:1:1 | × 10⁻⁴ | DMA | BTPA | 1 | 4 | 55 | 5800 | 5900 | 1.21 |
| 10 | 200:1:2 | × 10−4 | NIPAAM | BTPA | 1 | 4 | 90 | 20600 | 20300 | 1.06 |
| 11 | 200:1:2 | × 10−4 | DEA | BTPA | 1 | 4 | 60 | 15480 | 14800 | 1.09 |

Note:
a) The reactions were performed in water at room temperature;
b) Monomer conversion determined by ¹H NMR spectroscopy;
c) Theoretical molecular weight calculated using the following equation: M_{n, theo} = [M]₀/[Thio]₀ × MW^{M} × α + MW^{Thio}, where [M]₀, [Thio]₀, MW^{M}, α and MW^{Thio} correspond to M and Thio concentration, molar mass of M, monomer conversion and molar mass of trithiocarbonate or dithioester compounds;
d) Molecular weight and polydispersity (M_{w}/Mₙ) determined by GPC analysis (DMAc used as eluent).

### Example 4

### Polymerization of Unconjugated Monomers, Including Vinyl Acetate (VAc), Vinyl Pivalate (VP), N-Vinyl Pyrrolidinone (NVP) and Dimethyl Vinylphosphonate (DVP) by PET-RAFT Polymerization

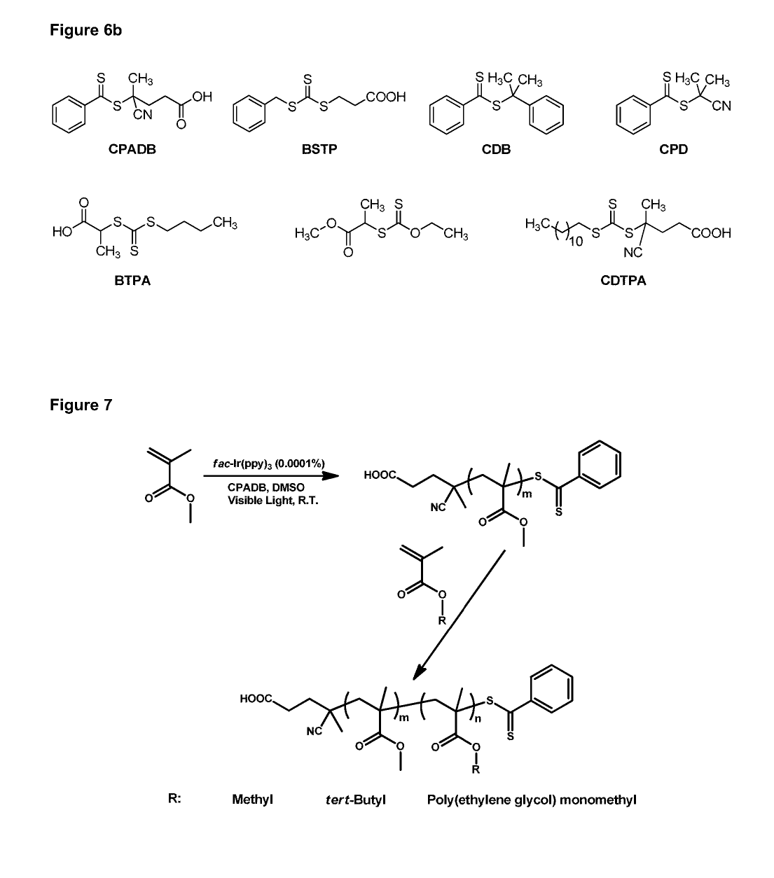

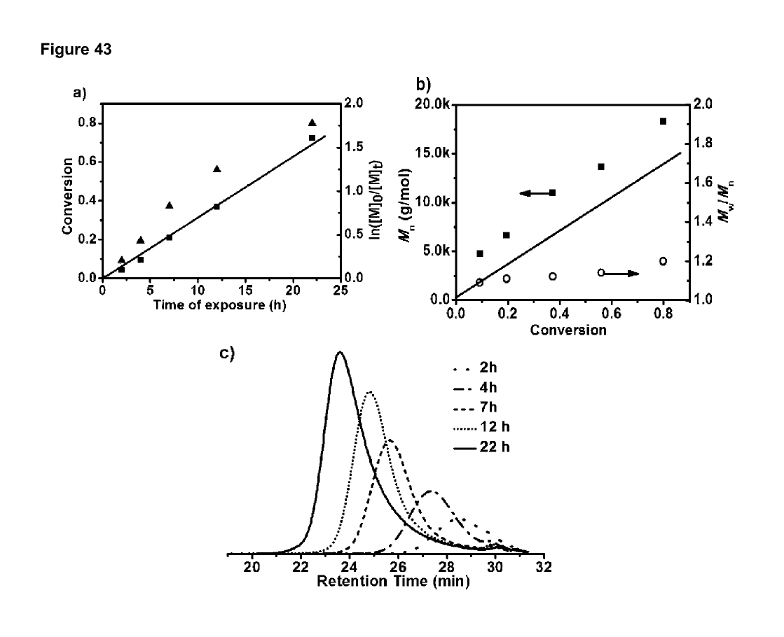

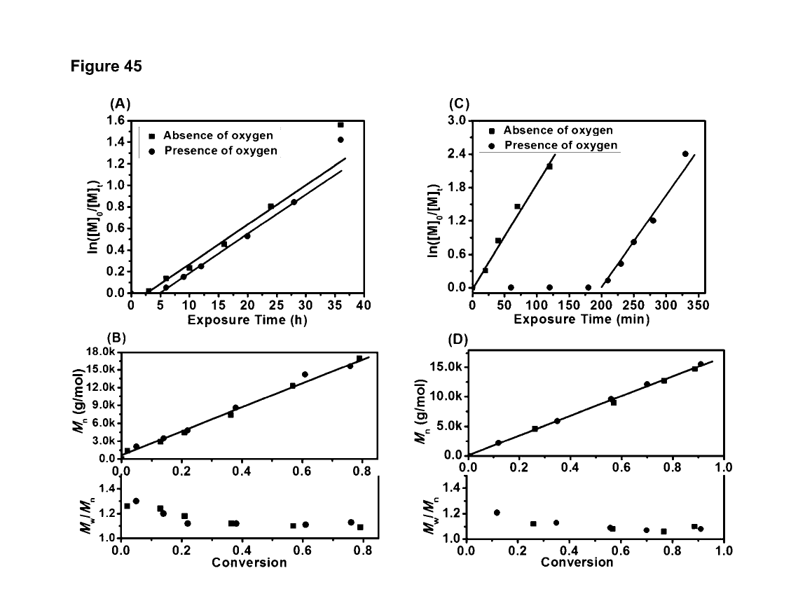

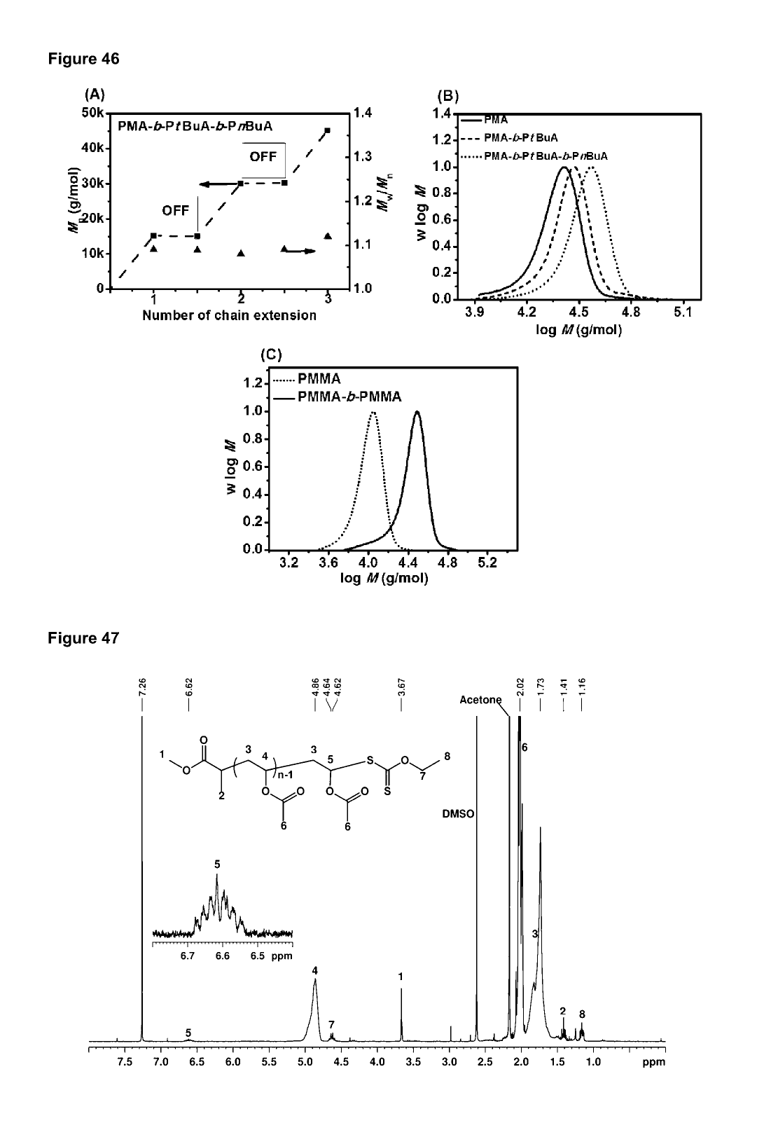

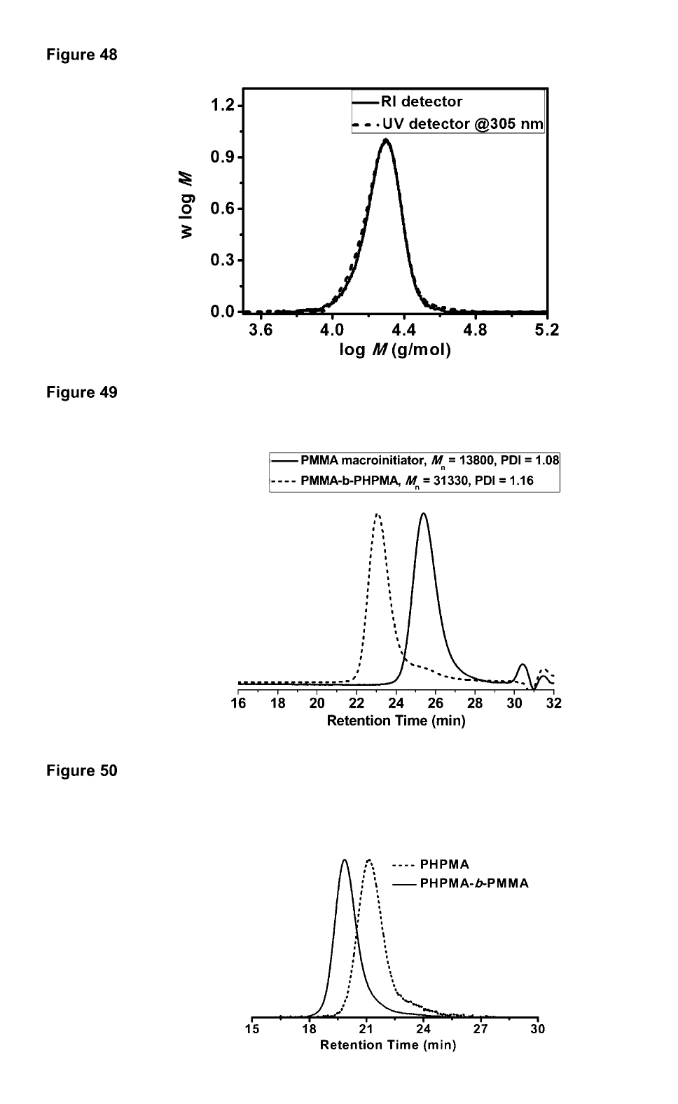

Four model monomers, vinyl acetate (VAc), vinyl pivalate (VP), N-vinylpyrrolidinone (NVP) and dimethyl vinylphosphonate (DVP) are used in the PET-RAFT process. All of these monomers are widely employed in industry due to their interesting properties. For instance, PVAc is the precursor of polyvinyl alcohol (used in coatings and also a biocompatible polymer), and PNVP is used in the synthesis of inks, coatings and adhesives. Firstly, vinyl acetate (VAc) was investigated using BTPA or methyl 2-[(ethoxycarbonothioyl)sulfanyl]propanoate (sometimes referred to below as “xanthate”) in the presence of various photoredox catalyst concentrations. Initial polymerizations using BTPA as initiator and chain transfer agent were unsuccessful (Table 3, #1), which is believed to be due to inhibition of polymerization resulting from the poor radical leaving-group ability. Successful polymerizations were obtained with methyl 2-[(ethoxycarbonothioyl)sulfanyl]propanoate (Table 3, #2-6). The molecular structure of methyl 2-[(ethoxycarbonothioyl)sulfanyl]propanoate is shown in FIG. 6b. The experimental molecular weights determined by GPC were greater than the theoretical values, which was attributed to the difference in hydrodynamic volume between PVAc and the PSt standard. NMR was employed to calculate the molecular weight. M_{n,NMR} was in good agreement with the theoretical values. Interestingly, the amount of photoredox catalyst does not affect the molecular weight distribution, as all the polymerizations displayed a PDI lower than 1.20. After these initial successful results, VAc kinetics was investigated using [fac-[Ir(ppy)₃]]/[Monomer] of 5 ppm. A linear evolution of In([M]₀/[Mₜ]) and molecular weight versus exposure time demonstrates the living character of this polymerization (FIG. 43). To demonstrate the presence of xanthate end group, PVAc (Table 3, #2 and 3) was analyzed by NMR (FIG. 46) and GPC equipped with RI and UV detector (FIG. 48). Other monomers, including vinyl pivalate (VP), N-vinyl pyrrolidinone (NVP) and dimethyl vinylphosphonate (DVP) were also tested using a catalyst concentration of 10 ppm (relative to monomer). These monomers revealed the synthesis of polymers with a narrow MWD and good control of the molecular weight (Table 3, #7-12). These results demonstrate that this polymerization technique can control a diverse range of unconjugated monomers.

TABLE 3
Examples of polymers synthesized using unconjugated monomers in this study.

| | Exp. Cond.^{a} | | | | [Ir]/[M] | Time | α ^{b} | M_{n, th.}^{c} | M_{n,GPC}^{d} | |
|---|---|---|---|---|---|---|---|---|---|---|
| # | [M]:[Thiocar.]:[Ir] | | Monomer | Thiocar. | (ppm) | (h) | (%) | (g/mol) | (g/mol) | M_{w}/Mₙ |
| 1 | 200:1:40 | × 10⁻⁴ | VAc | BTPA | 20 | 24 | 0 | — | — | — |
| 2 | 200:1:40 | × 10⁻⁴ | VAc | Xanthate | 20 | 22 | 76 | 13300 | 18200 | 1.20 |
| 3 | 200:1:10 | × 10⁻⁴ | VAc | Xanthate | 5 | 2 | 16 | 3700 | 5300 | 1.09 |
| 4 | 200:1:10 | × 10⁻⁴ | VAc | Xanthate | 5 | 22 | 81 | 14000 | 18300 | 1.20 |
| 5 | 200:1:2 | × 10⁻⁴ | VAc | Xanthate | 1 | 20 | 41 | 7200 | 11900 | 1.18 |
| 6 | 1000:1:50 | × 10⁻⁴ | VAc | Xanthate | 5 | 22 | Nd^{e} | Nd^{e} | 56000 | 1.38 |
| 7 | 200:1:10 | × 10⁻⁴ | VP | Xanthate | 5 | 3 | 22 | 4500 | 3800 | 1.18 |
| 8 | 200:1:10 | × 10⁻⁴ | VP | Xanthate | 5 | 24 | 80 | 20800 | 22000 | 1.38 |
| 9 | 100:1:10 | × 10⁻⁴ | DVP | Xanthate | 10 | 6 | 22 | 3100 | 3500 | 1.27 |
| 10 | 100:1:10 | × 10⁻⁴ | DVP | Xanthate | 10 | 14 | 41 | 5800 | 6700 | 1.17 |
| 11 | 170:1:17 | × 10⁻⁴ | NVP | Xanthate | 10 | 6 | 40 | 6900 | 7200 | 1.23 |
| 12 | 170:1:17 | × 10⁻⁴ | NVP | Xanthate | 10 | 14 | 65 | 12500 | 13200 | 1.10 |

Note:
^{a}The reactions were performed at room temperature under 4.8 W blue LED light (λₘₐₓ = 435 nm);
^{b}Monomer conversion determined by ¹H NMR spectroscopy;
^{c}Theoretical molecular weight calculated using the following equation: M_{n, th.} = [M]₀/[xanthate]₀ × MW^{M} × α + MW^{xanthate}, where [M]₀, [xanthate]₀, MW^{M}, α and MW^{xanthate} correspond to M and xanthate concentration, molar mass of M, monomer conversion and molar mass of xanthate;
^{d}Molecular weight and polydispersity determined by GPC analysis;
^{e}Nd: not determined.

### Example 5

### Synthesis of Diblock Copolymers Using Different Monomer Families

To investigate the versatility of the photopolymerization approach, block polymers comprising monomers from different monomer families were prepared. Six different macro-initiators, i.e. poly(methyl methacrylate) (PMMA), poly(N-(2-hydroxylpropyl) methacrylamide) (PHPMA), polystyrene (PSt), poly(methyl acrylate) (PMA), poly(N,N′-dimethylacrylamide) (PDMA) and poly(N-vinyl pyrrolidone) (PNVP) were prepared by PET-RAFT polymerization, and subsequently purified by precipitation (Table 4). First, the PMMA macro-initiator was prepared using CPADB and chain extended in the presence of St, MA and HPMA using a concentration of photoredox catalyst (Ru(bpy)₃Cl₂) of 5 ppm relative to the monomer. The chain extensions of PMMA with St and MA were unsuccessful. Without wishing to be bound by theory, it is believed that the chain extensions with St and MA were unsuccessful because the photoredox catalyst used could not activate PMA-S(C═S)-Ph end group. The chain extension of PMMA with HPMA was successful via PET-RAFT polymerization, resulting in the synthesis of poly(methyl methacrylate)-block-poly(N-(2-hydroxylpropyl) methacrylamide) (PMMA-b-HPMA) with a narrow MWD (M_{w}Mₙ<1.2) (Table 4, #4 and FIG. 49). PHPMA was also successfully chain extended in the presence of MMA to yield poly(N-(2-hydroxylpropyl) methacrylamide)-block-poly(methyl methacrylate) (PHPMA-b-PMMA) diblock copolymer (Table 4, #7 and FIG. 50).

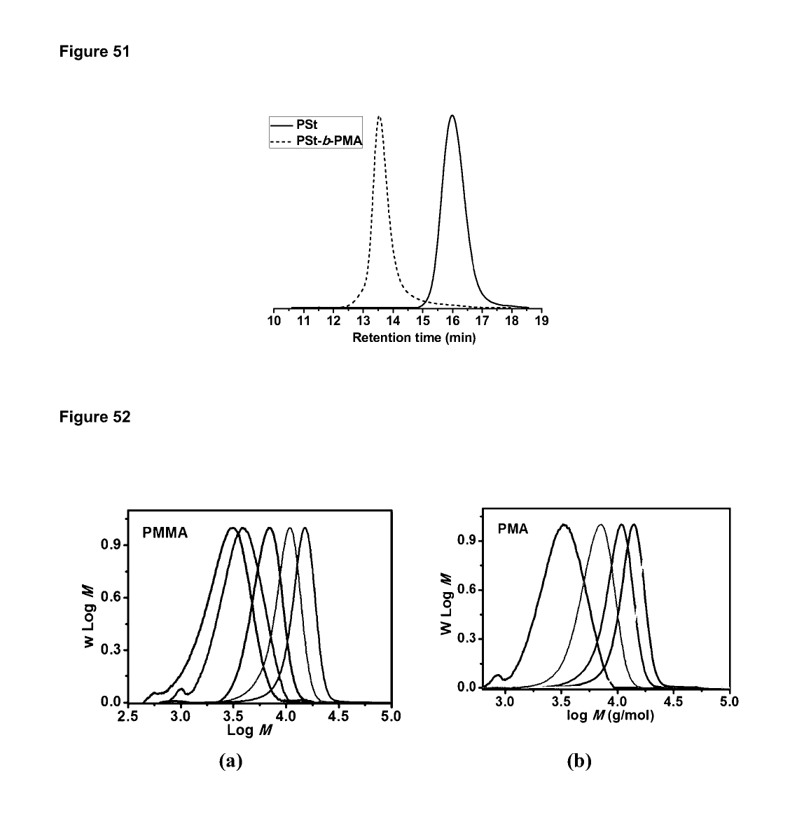

The chain extension of PSt macro-initiator with MMA was uncontrolled, resulting in a much higher molecular weight polymer than the theoretical values with a broad MWD (Table 4, #9). Such results have been previously reported in the literature for RAFT and ATRP process and are attributed to the difference in reactivity between the end-group (PMMA-RAFT and PSt-RAFT). Successful chain extension of PSt with MA was confirmed by GPC with a narrow MWD (M_{w}/Mₙ=1.20) (Table 4, #10 and FIG. 51).

The chain extension of PMA and PDMA were successful with MA, DMA and St to yield well-defined poly(methyl acrylate)-block-poly(N,N′-dimethylacrylamide) (PMA-b-PDMA), poly(methyl acrylate)-block-polystyrene (PMA-b-PSt), poly(N,N′-dimethylacrylamide)-block-poly(methyl acrylate) (PDMA-b-PMA) and poly(N,N′-dimethylacrylamide)-block-polystyrene (PDMA-b-PSt) block copolymers, respectively (Table 4, #12, 13, 15 and 16). Finally, the synthesis of poly(N-vinyl pyrrolidone)-block-poly(vinyl acetate) (PNVP-b-PVAc) was achieved using catalyst concentration of 10 ppm relative to monomer (Table 4, #18).

TABLE 4
Molecular weights and polydispersities (M_{w}/Mₙ) of block copolymers
synthesized by PET-RAFT polymerization using PMMA, PHPMA, PSt,
PDMA, PMA and PNVP as macro-initiators.

| | | Conversion^{a} | | M_{n, Th..}^{c} | M_{n, GPC}^{d} | |
|---|---|---|---|---|---|---|
| # | Copolymers | (%) | [M]₀/[Macro]₀^{b} | (g/mol) | (g/mol) | M_{w}/Mₙ |
| 1 | PMMA macro-initiator | — | — | — | 13800 | 1.08 |
| 2 | PMMA-b-PSt | 0 | 200/1 | — | — | — |
| 3 | PMMA-b-PMA | 0 | 200/1 | — | — | — |
| 4 | PMMA-b-PHPMA | 38 | 200/1 | 25100 | 31330 | 1.16 |
| 5 | PHPMA macro-initiator | — | — | — | 58600 | 1.16 |
| | | | | | (24210)^{e} | |
| 6 | PHPMA-b-PSt | 0 | 200/1 | — | — | — |
| 7 | PHPMA-b-PMMA | 83 | 200/1 | 78600 | 75200 | 1.13 |
| 8 | PSt macro-initiator | — | — | — | 4300 | 1.09 |
| 9 | PSt-b-PMMA | 41 | 200/1 | 12200 | 105000 | 2.1 |
| 10 | PSt-b-PMA | 85 | 200/1 | 34800 | 35400 | 1.20 |
| 11 | PMA macro-initiator | — | — | — | 12600 | 1.08 |
| 12 | PMA-b-PDMA | 72 | 400/1 | 41500 | 40300 | 1.11 |
| 13 | PMA-b-PSt | 24 | 200/1 | 18600 | 17200 | 1.11 |
| 14 | PDMA macro-initiator | — | — | — | 18430 | 1.09 |
| 15 | PDMA-b-PMA | 56 | 400/1 | 36800 | 37300 | 1.14 |
| 16 | PDMA-b-PSt | 58 | 400/1 | 41700 | 42800 | 1.28 |
| 17 | PNVP macro-initiator | — | — | — | 7200 | 1.23 |
| 18 | PNVP-b-PVAc | 35 | 200/1 | 12200 | 13300 | 1.24 |

Note:
The reactions were performed in DMSO at room temperature using 4.8 W blue LED lamp (λₘₐₓ = 435 nm) as light source and molar ratio [M]/[catalyst] = 200:10 × 10⁻⁴ (styrene case: [M]/[catalyst] = 400:80 × 10⁻⁴);
^{a}Monomer conversion determined by ¹H NMR spectroscopy;
^{b}molar ratio of monomer to macro-initiator;
^{c}Theoretical molecular weight calculated using the following equation: M_{n, th.} = [monomer]₀/[Polymer-macro]₀ × MW^{monomer} × α + MW^{Polymer-macro}, where [monomer]₀, [Polymer-macro]₀, MW^{Monomer}, α and MW^{Polymer-macro} correspond to monomer and polymer macro-initiator concentration, molar mass of Monomer, monomer conversion and molar mass of Polymer macro-initiator;
^{d}molecular weight and polydispersity determined by GPC analysis (DMAc used as eluent);
e) Molecular weight determined by ¹H NMR using M_{n, NMR} = (I^{3.8 ppm}/1)/(I^{7.8 pm}/2) × MW^{HPMA} + MW^{CPADB}, where I^{3.8 ppm} and I^{7.8 ppm} correspond to integrals of signal at δ 3.8 ppm and δ 7.8 ppm attributed to CH of HPMA and phenyl group (Z-group) of CPADB.

### Example 6

### Polymerization in the Presence of Air

In some embodiments, the polymerizations disclosed herein can be performed without degassing the reaction mixture. Oxygen is detrimental to radical polymerizations, as oxygen is an excellent radical scavenger. Typically, conventional free radical and controlled/living radical polymerization techniques, including atom transfer radical polymerization (ATRP), RAFT and nitroxide-mediated radical polymerization (NMP), are susceptible to trace amounts of oxygen and require de-oxygenation procedures, such as degassing with nitrogen or several freeze-pump-thaw cycles. Construction of an oxygen-free environment could be challenging for specific industrial applications, such as surface modifications, miniemulsion polymerization, coatings, etc.

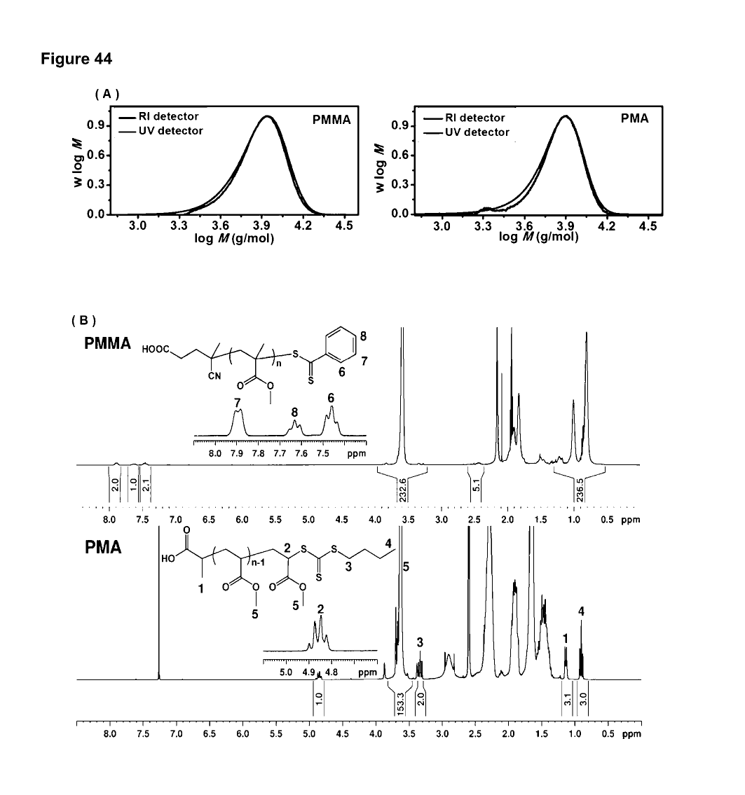

The polymerizations of MMA and MA were performed in a sealed but non-degassed vessel of 4 mL using a total liquid volume of 3 mL (50/50 (v/v) of solvent/monomer) under a 4.8 W blue LED light. After 24 h, the reaction solutions were analyzed by ¹H NMR and GPC. NMR revealed a monomer conversion of 99% and 50% for MA and MMA, respectively, whilst GPC showed the presence of PMA and PMMA with very good control of the molecular weight in agreement with the theoretical values and M_{w}/Mₙ (<1.10). Additional analysis using GPC equipped with a dual UV and RI detectors revealed the presence of identical MWDs, demonstrating the homogenous proportion of thiocarbonylthio groups within the polymer chains (FIG. 44A). ¹H NMR and UV-vis analyses were invoked to quantify the exact amounts of dithiobenzoate and trithiocarbonate group present in both polymers after purification. FIG. 44B displays the ¹H NMR spectra of purified PMMA and PMA synthesized without prior degassing. Dithiobenzoate and trithiocarbonate groups were confirmed by the characteristic signals at δ 7.3-7.8 ppm and δ 4.8 ppm, respectively, which could be used to calculate the molecular weights of polymers. Both NMR and GPC values for molecular weights were in agreement, demonstrating high end group fidelity. Finally, the molecular weights were also calculated by UV-vis using the signal at 305 nm and the extension coefficients of dithiobenzoate and trithiocarbonate (data not shown), which were also in agreement with M_{n, th} and M_{n, GPC}.

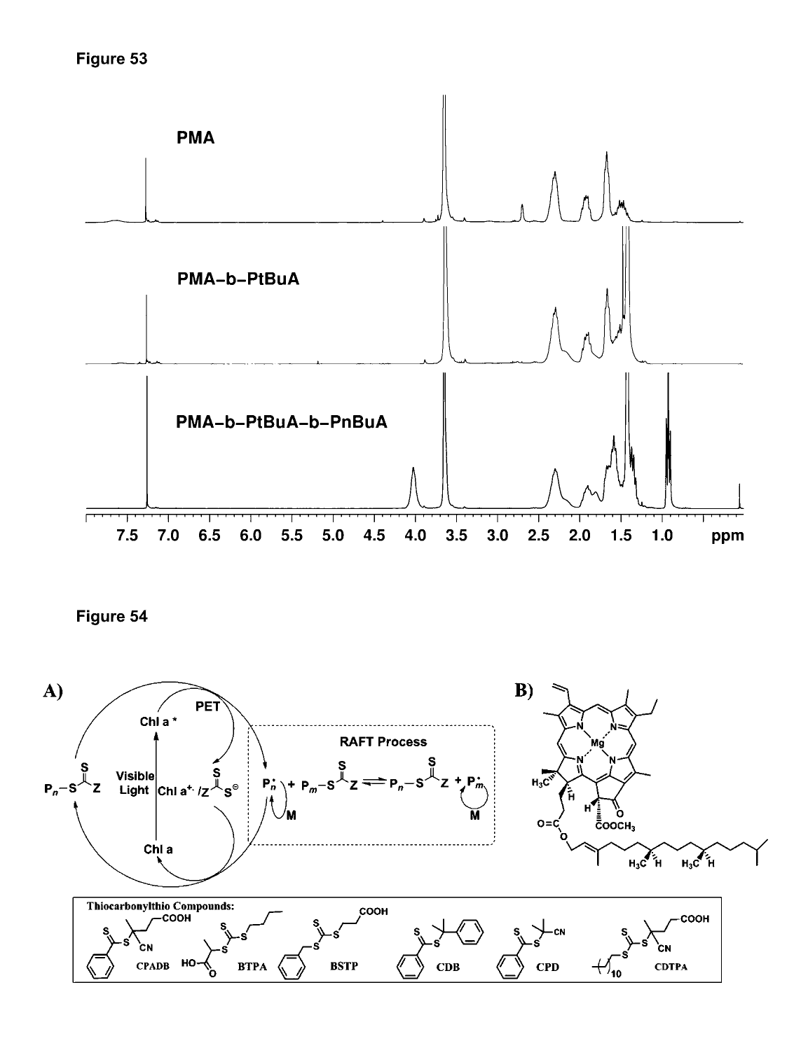

Next, the polymerization kinetics of MMA and MA were investigated. As expected, a long inhibition period of 3-4 h was observed attributed to the reduction of oxygen by the photoredox catalyst. After this inhibition period, the polymerization proceeded in a controlled manner, giving an linear plots of Mₙ versus monomer conversion and In([M]₀/[M]ₜ) versus exposure time (FIGS. 45A and 45C). Interestingly, the slopes of In([M]₀/[M]ₜ) (apparent propagation constant, kₚ^{app}) versus time for the polymerizations in the presence of air were almost the same as the degassed reactions after the inhibition period (FIGS. 45A and 45C), which indicated that both photocatalyst and thiocarbonylthio compounds were not degraded during the oxygen reduction period. In addition, the evolutions of M_{n, GPC} values versus exposure time were in agreement with those in the absence of oxygen (degassed system) and theoretical values (FIGS. 45B and 45D). GPC showed a shift of the molecular weight distribution to higher molecular weight with a narrow polydispersity (FIG. 52). To further investigate the livingness (i.e. the end group fidelity) and the robustness of the catalyst in a non-degassed environment, successive chain extensions of PMA and PMMA were performed to generate a diblock of PMMA-b-PMMA and a triblock of PMA-b-PtBuA-b-PnBuA copolymers without degassing the solutions (FIG. 46). In this approach, an iterative process was used as described in the previous paragraph. To our knowledge, it is the first time that block copolymers were obtained without purification and also degassing between each chain extension. For each chain extension, we added a non-degassed solution containing monomer and solvent. Subsequently, the solution was placed under a 4.8 W blue LED light for 7 h (MA) and 24 h (MMA) to obtain high monomer conversion (>98% determined by ¹H NMR). Then, the solutions were placed in the dark to avoid the formation of dead polymers during monomer conversion analysis. After confirmation of full monomer conversion, a new aliquot of monomer and solvent were added to the mixture. After an inhibition period of 2-3 h, the polymerization proceeded until full monomer conversion. GPC revealed the formation of well-defined block copolymers with a narrow MWD (M_{w}/Mₙ<1.10). Purified copolymers were finally analyzed by NMR to determine the exact composition (FIG. 53).

### Example 7

### Polymerizations Using Organo-Photocatalysts

The polymerizations described herein may be conducted using an organo-photocatalyst. Results of polymerizations using organo-photocatalysts are shown in Table 5.

TABLE 5
Molecular weights and polydispersities (M_{w}/Mₙ) of polymers synthesized by PET-RAFT
polymerizations using organophotocatalysts.

| | Exp. Cond.^{a} | | | | | | | |
|---|---|---|---|---|---|---|---|---|
| | [M]:[Thiocar.]: | | Initiating | Time | α ^{b} | M_{n, th.}^{c} | M_{n,GPC}^{d} | |
| # | [catalyst] | Monomer | System | (h) | (%) | (g/mol) | (g/mol) | M_{w}/Mₙ^{d} |
| 1 | 200:1:0.1 | MMA | Fluorescein/ | 24 | 47.6 | 9800 | 8910 | 1.17 |
| | | | CPADB | | | | | |
| 2 | 200:1:0.04 | MMA | Fluorescein/ | 24 | 31 | 6450 | 6300 | 1.23 |
| | | | CPADB | | | | | |
| 3 | 200:1:0.04 | MA | Fluorescein/ | 12 | 69.4 | 12180 | 11430 | 1.08 |
| | | | BTPA | | | | | |
| 4 | 200:1:0.04 | MMA | Eosin Y/ | 14 | 79 | 16010 | 15400 | 1.12 |
| | | | CPADB | | | | | |
| 5 | 200:1:0.04 | MMA | Eosin Y/ | 24 | 94 | 19130 | 18900 | 1.13 |
| | | | CPADB | | | | | |
| 6 | 200:1:0.04 | MMA | Eosin Y/ | 7 | 37 | 7620 | 7400 | 1.18 |
| | | | CPADB | | | | | |
| 7 | 200:1:0.04 | MA | Eosin Y/ | 14 | 45 | 7980 | 7800 | 1.19 |
| | | | BTPA | | | | | |
| 8 | 200:1:0.04 | MA | Eosin Y/ | 20 | 98 | 16870 | 16800 | 1.13 |
| | | | BTPA | | | | | |
| 9 | 200:1:0.04 | MMA | Fluorescein | 18 | 45 | 9060 | 8900 | 1.12 |
| | | | Sodium Salt/ | | | | | |
| | | | CPADB | | | | | |
| 10 | 200:1:0.01 | MA | Fluorescein | 16 | 26 | 4510 | 4400 | 1.10 |
| | | | Sodium Salt/ | | | | | |
| | | | BTPA | | | | | |
| 11 | 200:1:0.04 | DMA | Fluorescein | 3.5 | 99 | 20200 | 21740 | 1.11 |
| | | | Sodium Salt/ | | | | | |
| | | | BTPA | | | | | |

Note:
^{a}The reactions were performed at room temperature under 4.8 W blue LED light (λₘₐₓ = 435 nm);
^{b}Monomer conversion determined by ¹H NMR spectroscopy was calculated by the following equation: α = (1 − [(I^{5.5-6.0 ppm}/2)/(I^{3.5 ppm}/3)]) × 100;
^{c}Theoretical molecular weight calculated using the following equation: M_{n, th.} = [M]₀/[Thiocar]₀ × MW^{M} × α + MW^{thiocar.}, where [M]₀, [Thiocar.]₀, MW^{M}, α and MW^{Thiocar} correspond to monomer and thiocarbonylthio compound concentration, molar mass of monomer, monomer conversion and molar mass of thiocarbonylthio compound;
^{d}Molecular weight and polydispersity determined by GPC analysis.

### Example 8

### Polymerizations Using Chlorophyll a and Chlorophyll Derivatives

In this example, we describe the use of Chl a to mediate a living radical polymerization under blue and red LED light via photoinduced electron transfer—reversible addition fragmentation chain transfer (PET-RAFT) polymerization. This polymerization requires only ppm levels of Chl a to activate the PET-RAFT process. A wide range of monomer families, including (meth)acrylamide and (meth)acrylates containing a large variety of functional groups, such as carboxylic acid, amine, alcohol, and glycidyl groups, was successfully polymerized within a few hours and showed excellent control over molecular weight and polydispersity.

Materials:

Methyl methacrylate (MMA, 99%), tert-butyl methacrylate (tBuMA, 99%), methyl acrylate (MA, 99%), oligo (ethylene glycol) methyl ether methacrylate (OEGMA, average Mₙ 300), N,N-dimethylacrylamide (DMA, 99%), N-isopropylacrylamide (NIPAAm, 97%), glycidyl methacrylate (GMA, 97%), pentafluorophenyl acrylate (PFPA, 98%), methacrylic acid (MAA, 99%), 2-(dimethylamino)ethyl methacrylate (DMAEMA, 98%), N-(2-hydroxypropyl) methacrylamide (HPMA, Polysciences Inc., 97%), 2-phenyl-2-propyl benzodithioate (CDB, 99%), 4-Cyano-4-[(dodecylsulfanylthiocarbonyl)sulfanyl]pentanoic acid (CDTPA, 97%), and 2-cyano-2-propylbenzodithioate (CPD, >97%) were all purchased from Aldrich. Monomers were deinhibited by percolating over a basic alumina column (Ajax Chemical, AR). N,N′-dimethylformamide (DMF, 99.8%, Ajax Chemical), dimethyl sulphoxide (DMSO, Ajax Chemical), diethyl ether (Ajax Chemical), petroleum spirit (Ajax Chemical), n-hexane (Ajax Chemical), acetonitrile (Ajax Chemical), and toluene (Ajax Chemical) were used as received. Chlorophyll a (Chl a) was extracted from spinach leaves with acetone and isolated with column chromatography using hexane and acetone mixtures in an alumina column. The Chl a extraction was adapted from literature procedures, e.g. as described in H. T. Quach, R. L. Steeper, G. W. Griffin, J. Chem. Educ. 2004, 81, 385 and A. Johnston, J. Scaggs, C. Mallory, A. Haskett, D. Warner, E. Brown, K. Hammond, M. M. McCormick, 0. M. McDougal, J. Chem. Educ. 2013, 90, 796-798. The structure of Chl a and its purity was confirmed by NMR (Bruker Avance III 500) and UV-vis spectroscopy. The concentration of Chl a was determined in DMSO by spectral measurements based on the equation described in A. R. Wellburn, J. Plant Physiol. 1994, 144, 307-313. Thiocarbonylthiol compounds: 4-cyanopentanoic acid dithiobenzoate (CPADB), 2-(n-butyltrithiocarbonate)-propionic acid (BTPA) and 3-benzylsulfanylthiocarbonylthiosulfanyl propionic acid (BSTP) were synthesized according to literature procedures.

General Procedure for the Synthesis of Methyl Acrylate (MA) Via PET-RAFT Polymerization.

Polymerization of MA was carried out in a 5 mL glass vial with a rubber septum in the presence of DMSO (370 μL), MA (0.361 g, 4.19 mmol), BTPA (5 mg, 20.97 μmol), and Chl a (75 μL of 224 μM of Chl a stock solution, 0.017 μmol). The glass vial was wrapped with aluminium foil and degassed with nitrogen for 30 minutes. The degassed mixture was then irradiated in red LED light (4.8 W, max=635 nm (red)) at room temperature. After 5 hours of irradiation, the reaction mixture was removed from the light source in order to be analysed by 1H NMR (CDCl3) and GPC (DMAc) to determine the conversions, number-average molecular weights (Mn) and polydispersities (Mw/Mn).

General Procedures for Kinetic Studies of PET-RAFT Polymerization of Methyl Methacrylate (MMA) with Online Fourier Transform Near-Infrared (FTNIR) Spectroscopy.

A reaction stock solution consisting of DMSO (294 μL), MMA (0.358 g, 3.58 mmol), CPADB (5 mg, 17.90 μmol), and Chl a (64 μL of 224 μM of Chl a stock solution, 0.017 μmol) was prepared in a glass vial. Approximately 500 μL of stock solution was transferred into a 0.9 mL FTNIR quartz cuvette (1 cm×2 mm) covered with aluminium foil. The reaction mixture in the cuvette was degassed for 30 minutes with nitrogen. The quartz cuvette was then irradiated in red LED light (4.8 W, max=635 nm (red)) at room temperature. The cuvette was transferred to a sample holder manually for FTNIR measurements every 20 minutes. After 15 seconds of scanning, the cuvette was transferred back to the irradiation source. Monomer conversions were calculated by taking the ratio of integrations of the wavenumber area 6250-6150 cm-1 for all curves at different reaction times to that of 0 minutes. Aliquots of reaction samples were taken at specific time points during the reaction to be analysed by 1H NMR (CDCl3) and GPC (DMAc) to determine the conversions, number average molecular weights (Mn) and polydispersities (Mw/Mn).

General Procedures for Preparation of PMA-b-PDMA Diblock Copolymers by PET-RAFT.

In the synthesis of PMA-b-PDMA diblock copolymers, MA was polymerized in a 5 mL glass vial containing DMSO (740 μL), MA (0.722 g, 8.38 mmol), BTPA (10 mg, 41.94 μmol), and Chl a (150 μL of 224 μM of Chl a stock solution, 0.034 μmol) sealed with a rubber septum. The reaction mixture was then covered with aluminium foil and degassed for 30 minutes with nitrogen. The reaction mixture was irradiated in red LED light (4.8 W, max=635 nm (red)) at room temperature for 2 hours. The final reaction mixture was purified by precipitating in a mixture of methanol/petroleum spirit (1/1, v/v) with stirring. The pale yellow precipitate was collected and redissolved in minimum amount of dichloromethane before precipitating a second time in methanol/petroleum spirit (1/1, v/v) mixture. The precipitate was analysed in GPC and 1H NMR: Mn,GPC=8 810 g/mol, Mw/Mn=1.10 and 46% monomer conversion.

Chain extension of PMMA macroinitiator to DMA was carried out in a 5 mL glass vial in the presence of DMSO (495 μL), DMA (0.366 g, 3.69 mmol), PMMA macroinitiator (0.065 g, 7.38 μmol), and Chl a (66 μL of 224 μM of Chl a stock solution, 0.015 μmol) sealed with a rubber septum. Aluminium foil was used to cover the reaction mixture before degassing for 30 minutes with nitrogen. The reaction mixture was irradiated in red LED light (4.8 W, max=635 nm (red)) at room temperature for 5 hours. The final reaction mixture was purified by precipitating in a mixture of methanol/petroleum spirit (1/1, v/v) with stirring. The pale yellow precipitate was collected and redissolved in minimum amount of dichloromethane before precipitating a second time in methanol/petroleum spirit (111, v/v) mixture. The precipitate was analysed in GPC and 1H NMR: Mn,GPC=45 570 g/mol, Mw/Mn=1.08 and 79% monomer conversion. RAFT end group fidelity was determined by using UV-Vis spectroscopy.

Photostability Test of Chl a.

A reaction stock solution consisting of DMSO (370 μL) and Chl a (75 μL of 224 μM of Chl a stock solution, 0.017 μmol) was prepared in a 0.9 mL FTNIR quartz cuvette (1 cm×2 mm) covered with aluminium foil. The reaction mixture in the cuvette was degassed for 30 minutes with nitrogen. The quartz cuvette was then irradiated in red LED light (4.8 W, λmax=635 nm (red)) at room temperature for 16 h. Another quartz cuvette containing the same formulation was degassed for 30 min with nitrogen, and then was kept in the dark as a parallel control.

After 16 h, MA (0.361 g, 4.19 mmol) and BTPA (5 mg, 20.97 μmol) was added into both cuvettes and sealed with rubber septa. The final reaction mixtures were degassed for 30 min with nitrogen. The cuvette was then irradiated under red light at room temperature. The monomer conversions were monitored by online FTNIR spectroscopy.

Results and Discussion

The most abundant natural visible light photocatalyst for PET processes on Earth is chlorophyll, which is the principal photoacceptor in the chloroplasts of most green plants. During photosynthesis, the absorption of a photon excites the chlorophyll from its ground state to its excited state and initiates an electron transfer reaction. This high-energy electron can have several fates. The electron could return to the ground state, with the absorbed energy converted to heat or fluorescence. However, if a suitable electron acceptor with high electron affinity is close to the chlorophyll molecule, the excited electron can be transferred from the initial chlorophyll molecule to the acceptor and generate a positive charge on the chlorophyll molecule (due to the loss of an electron) and a negative charge on the acceptor. This process is also referred to as photoinduced charge separation. In plants, the electron extracted from chlorophyll is used to reduce species such as water and CO₂. Despite ongoing research on artificial photosynthesis for solar energy conversion, this is the first example of chlorophyll being used as an efficient photoredox catalyst for the production of high-performance polymeric materials via living polymerization. In this example, we demonstrate that chlorophyll a (Chl a, the most widely distributed form of chlorophyll) can mediate the PET-RAFT process and lead to the production of well-defined polymers with controlled molecular weights, polydispersities and end group functionalities.

Because spinach is an affordable and renewable feedstock, it can be used as the raw material for the extraction, isolation and characterization of Chl a. Chl a was extracted from spinach leaves and purified by column chromatography described above. Water miscible solvents such as pyridine, methanol, ethanol, acetone, N,N′-dimethyformamide (DMF) and dimethylsulfoxide (DMSO) are most suitable for extraction of chlorophyll. The concentration of Chl a was determined as described above. In our experiments, 24 mg of Chl a was extracted from 100 g of spinach leaves. Chl a is reported to have a half-wave reduction potential of −1.1 V in DMSO versus the saturated calomel electrode (SCE) in the excited state. Consequently, excited Chl a is a strong reducing agent capable of transferring an electron to an oxidant of lower reduction potential to yield a π-cation radical. As the magnesium center in Chl a (FIG. 54B) is a redox-neutral metal, the electron does not originate from the metal center of the Chl a molecule but from the aromatic π-electron system of the porphyrin. This mechanism is in direct contrast with the electron generation mechanism of transition metal photocatalysts (such as ruthenium and iridium) because these photocatalysts rely on metal to ligand charge transfer (MLCT). The resultant positive charge of the cationic Chl a and the spin of the unpaired electron are delocalized extensively over the π-electron system.

The reduction of a PET-RAFT agent leads to the generation of a radical (P^{}) capable of initiating RAFT polymerization as well as serving as a chain transfer agent. Upon addition of propagating radical (P^{}) to the π-cation radical Chl a-thiocarbonylthio complex (FIG. 54A), deactivation of polymerization takes place to yield dormant propagating chain and uncharged Chl a, thereby restarting the catalytic cycle. In another possible but unlikely pathway of deactivation, π-cation radical Chl a-thiocarbonylthio complex directly abstracts an electron from the propagating radical (P^{}) to regenerate dormant propagating chain and Chl a. However, the generation of cationic propagating radical will be energetically unfavorable. In addition, there is also a possibility of regenerating Chl a from π-cation radical Chl a-thiocarbonylthio complex through disproportionation of π-cation radical Chl a to Chl a and a di-cation radical Chl a (Chl a²⁺) which can be reduced by nucleophiles and water to form allomers of Chl a.

To confirm that the polymerizations were activated by Chl a and PET-RAFT agent, a range of control experiments was carried out in detail under blue and red light emitting diode (LED) lights. Firstly, the methyl methacrylate (MMA) and methyl acrylate (MA) polymerizations, containing PET-RAFT agents, Chl a and monomers, were performed in the absence of light. In these conditions, no monomer conversion was detected by NMR and gel permeation chromatography (GPC) analysis (data not shown), which demonstrated that the light is required to activate the polymerization. Secondly, the polymerizations were performed in the absence of Chl a or PET-RAFT agents. Upon 10 hours of red light irradiation in the presence of 4 ppm of Chl a with respect to monomer concentration in the absence of PET-RAFT agent (2-(n-butyltrithiocarbonate)-propionic acid, BTPA), MA showed a negligible conversion to polymer (Table 6, #2); on the other hand, MMA remained inert even after 13 hours of irradiation (Table 6, #10). An interesting fact to note was that similar results were achieved for control experiment carried out with MMA in the presence of blue light as no polymerization was observed (Table 7, #2). These results demonstrated that both Chl a and PET-RAFT agents (acting as CTA and initiator) activate polymerization.

In contrast to ruthenium and iridium catalysts (Examples 1 to 7), Chl a presents two absorption bands in the visible spectrum, i.e., at 430 and 665 nm which correspond to the blue (Soret band) and red (Q-band) regions of the visible spectrum, respectively. It has been demonstrated that both absorption bands induce a PET process during photosynthesis. In our early attempts, we tested the polymerization of MMA and MA under blue (λₘₐₓ=461 nm) and red LED light (λₘₐₓ=635 nm) in DMSO. The polymerization of MMA was initially tested using dithiobenzoate (CPADB), whereas that of MA was tested using trithiocarbonate (BTPA). In the presence of PET-RAFT agent and several hours of irradiation with a molar ratio of [monomer]:[PET-RAFT agent]:[Chl a]=200:1:8×10⁻⁴, we observed a viscous reaction mixture, which indicated the generation of polymers. The polymerizations proceeded smoothly to high monomer conversions (50% and 76% for MMA (Table 6, #4) and MA (Table 6, #1) after 20 h and 5 h of red light irradiation, respectively). The samples were also analyzed by GPC, which revealed the synthesis of well-defined polymers with narrow molecular weight distributions (M_{w}/Mₙ<1.15) and a good control over molecular weights.

In addition, the polymerization of (meth)acrylamides (Table 6, #11-12), methacrylates (Table 6, #13, 15-16), acrylate (Table 6, #14) and statistical copolymerization of methacrylic acid with methyl methacrylate (Table 6, #24) were also successfully carried out in the presence of red light and blue light (Table 7, #1, 3-6, and 8) with the synthesis of polymers with narrow molecular weight distributions (M_{w}/Mₙ<1.25). In the polymerization of DMAEMA, it was found that prolonged irradiation of monomer under blue light in the absence of PET-RAFT agent and catalyst could lead to self-initiation (Table 7, #7) resulting in very low monomer conversion (7% as determined by ¹H NMR spectroscopy). However, no such initiation was reported upon irradiation with red light (Table 6, #17).

In order to further test the versatility of Chl a, we decided to polymerize MA and MMA with RAFT agents other than CPADB and BTPA. Polymerization of MA with 3-benzylsulfanyl-thiocarbonylthiosulfanyl propionic acid (BSTP) was successful (Table 6, #18) but a little higher polydispersity was observed as compared to that BTPA was used. For MMA, polymerization with 2-cyano-2-propylbenzodithioate (CPD) (Table 6, #20) and 4-Cyano-4-[(dodecylsulfanylthiocarbonyl)sulfanyl] pentanoic acid (CDTPA) (Table 6, #21) yielded polymers with narrow molecular weight distributions (M_{w}/Mₙ<1.20); and polymerization with 2-phenyl-2-propyl benzodithioate (CDB) (Table 6, #19) yielded a slightly broader molecular weight distribution (M_{w}/Mₙ=1.27).

We then tested the tolerance of Chl a with different solvents, including dimethylformamide (DMF), acetonitrile (MeCN), and toluene (PhMe). Chl a was effective in polymerizing MA in both DMF (Table 6, #22) and MeCN (Table 6, #23) with low polydispersities (M_{w}/Mₙ<1.10), however, the polymerization in MeCN was much slower.

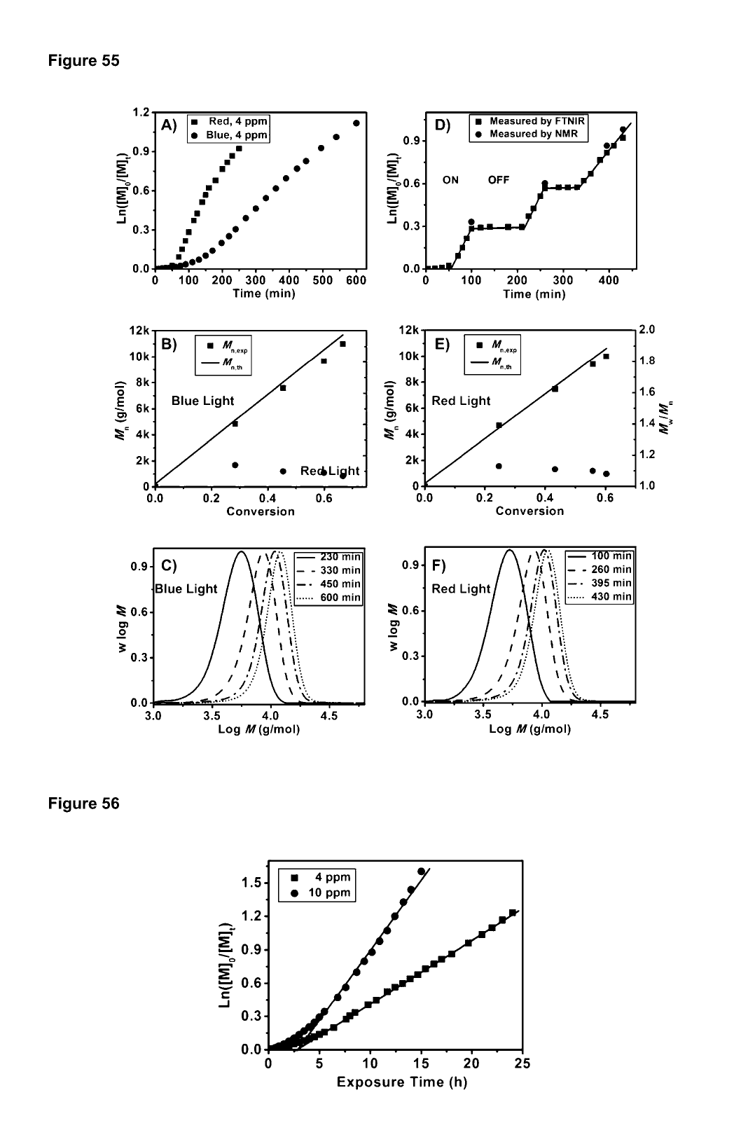

We subsequently investigated the polymerization kinetics using online Fourier transform near-infrared (FTNIR) spectroscopy, which measured the monomer conversions by following the decrease in the vinylic C—H stretching overtone of monomers at ˜6200 cm⁻¹, as described in previous publications. Ln([M]₀/[M]ₜ) was plotted against exposure time, as shown in FIG. 55A, to determine the apparent propagation rate constant (kₚ^{app}). Interestingly, a higher propagation rate constant (kₚ^{app} (red)=5.6×10⁻³ min⁻¹) and a shorter induction period (50 min) were observed under red light compared to those observed under blue light (kₚ^{app} (blue)=2.4×10⁻³ min⁻¹ and 100 min induction period). These findings are contrary to the observed specific absorption coefficient (a) for Chl a. Based on previous studies (see L. P. Vernon and G. R. Seely, The chlorophylls, Academic Press, New York, 1966), specific absorption coefficient of Chl a was determined to be 96.6-100.9 at 665 nm (red light) and 125.1-131.5 at 430 nm (blue light). In other words, polymerization should be faster in blue light than red light. We propose that the higher activity of Chl a in polymerization of MA lies in its efficiency in absorbing low energy red light which leads to photoinduced electron transfer to BTPA. Moreover, the higher propagation rate for red light as compared to blue light may also come from competitive absorption between PET-RAFT agent and Chl a. In addition, no other intense light absorption is observed in the visible light spectrum for Chl a. Therefore, polymerization should be observed only in blue and red lights. To test this hypothesis, a polymerization of MA was carried out under green LED light (λₘₐₓ=530 nm, 4.8 W). As expected, no polymerization was observed under green light, which is attributed to the absence of strong absorbance band. After purification, the presence of thiocarbonylthio end groups in both PMA and PMMA was confirmed by NMR and UV-vis spectroscopy. End group fidelity was quantified to be greater than 95% for both polymerizations under blue and red LED light.

There are fewer reports employing low-energy light (>600 nm, or red light) to activate polymerization than those using high-energy light (<400 nm, blue or UV light). We explored the polymerization of MMA, MA and other monomers under red light in various solvents. Several aliquots were taken at specific intervals during the polymerization of MMA under red light to measure the molecular weights and molecular weight distributions by GPC. By plotting Mₙ and polydispersity values against monomer conversion, we observed the characteristics of living radical polymerization, particularly a linear increase in Mₙ and a slight decrease in polydispersity (FIGS. 55E and 55F) for both MA and MMA. A lower polydispersity was obtained under red light, suggesting better control under red light. An additional feature introduced in this experiment was switching “ON” and “OFF” the light source to demonstrate that Chl a was acting as a molecular switch, which afforded temporal and potentially spatial control. For example, the polymerization of MA (FIG. 55D) was observed when the light was “ON”. In the absence of light (“OFF”), no monomer conversion was recorded. Aliquots of the reaction mixtures used for MA polymerization were also taken at specific intervals to measure the molecular weights and molecular weight distributions by GPC and the monomer conversions by NMR analysis. As indicated in FIG. 55D, the conversions at specific times, calculated by FTNIR, were in close agreement with the NMR data. Similar results were obtained for the polymerization of MMA.

We also investigated the effect of Chl a concentration on the polymerization kinetics of MMA via on-line FTNIR. The polymerizations were carried out in the presence of 4 ppm and 10 ppm of Chl a relative to the monomer concentration; samples were taken from the reaction mixture at designated times for GPC analysis. By plotting Ln([M]₀/[M]ₜ) against time (FIG. 56), we observed linear kinetics that fit the criteria within a first-order approximation for both polymerizations. The propagation rate constants at 10 ppm were determined to be kₚ^{app} (red)=0.133 h⁻¹ and kₚ^{app} (red)=0.057 h⁻¹ at 4 ppm. Consequently, the presence of a higher concentration of catalyst resulted in an increase in the overall rate of polymerization. In addition, the induction period observed in the polymerization of MMA (FIG. 56) and MA (FIG. 55A) can be attributed to stable and long lifetime intermediate of radical addition product in the PET-RAFT process, which has been previously observed and reported for conventional RAFT polymerization. Analysis of aliquots obtained throughout the course of the polymerization showed a linear increase in molecular weight as a function of conversion. A repetition of these experiments with no sampling during the course of reaction revealed that at conversions 94% for both 10 ppm (Table 6, #6) and 4 ppm (Table 6, #5) Chl a concentrations (relative to monomer concentration), the molecular weight distributions of the homopolymers remain low (PDI<1.20). Surprisingly, an increase in catalyst concentration from 4 ppm to 10 ppm led to a higher propagation rate constant with negligible changes to the molecular weight and molecular weight distributions (in an inert environment) even at high monomer conversions (>90%). As both 4 ppm and 10 ppm Chl a show a similar trend at high monomer conversions, we attempted to further increase the concentration of Chl a to 25 ppm (Table 6, #7-9) to determine the validity of this trend. Interestingly, Chl a concentrations of 4 ppm (FIG. 56) and 25 ppm (Table 6, #7) have similar polymerization rates by comparing the polymerization of MMA at roughly 70% monomer conversion while the polymerization at 10 ppm (Table 6, #6) is much faster than that at 25 ppm. The lower polymerization rate for 25 ppm compared to 10 ppm of Chl a is related to self-quenching of Chl solutions at higher concentrations. The mechanism of concentration quenching relies on transfer of excitation energy to statistical pairs of Chl a, which are separated by small distance in solutions, acting as quenching sites. At low concentration of Chl a solutions, fluorescence intensity is independent of concentration; however, at higher concentrations, fluorescence intensity decreases as there is rapid transport of excitonic energy to quenching sites. In the presence of these quenching sites, reduction of PET-RAFT agent through photoinduced electron transfer competes with energy transfer to statistical pairs of Chl a molecules leading to observation of a slower rate for 25 ppm of Chl a as compared to 4 ppm of Chl a.

TABLE 6
PET-RAFT Polymerization of a variety of monomers using Chl a as biocatalyst and 4.8
W red LED lamp as a light source (λₘₐₓ = 635 nm).

| | Exp. Cond.^{a} | | | | | | | | |
|---|---|---|---|---|---|---|---|---|---|
| | [M]:[RAFT | | RAFT | [Chl a]/[M] | Time | α ^{b} | M_{n, th.}^{c} | M_{n,GPC}^{d} | |
| # | agent]:[Chl a] | Monomer | agent | (ppm) | (h) | (%) | (g/mol) | (g/mol) | M_{w}/Mₙ |
| 1 | 200:1:8 × 10⁻⁴ | MA | BTPA | 4 | 5 | 76 | 13300 | 10800 | 1.06 |
| 2 | 200:0:8 × 10⁻⁴ | MA | — | 4 | 10 | 6 | — | — | — |
| 3 | 200:1:8 × 10⁻⁴ | MMA | CPADB | 4 | 4 | 24 | 5100 | 6570 | 1.10 |
| 4 | 200:1:8 × 10⁻⁴ | MMA | CPADB | 4 | 20 | 50 | 10300 | 14650 | 1.14 |
| 5 | 200:1:8 × 10⁻⁴ | MMA | CPADB | 4 | 36 | 94 | 19100 | 20300 | 1.13 |
| 6 | 200:1:2 × 10⁻³ | MMA | CPADB | 10 | 25 | 94 | 19100 | 20420 | 1.16 |
| 7 | 200:1:5 × 10⁻³ | MMA | CPADB | 25 | 25 | 71 | 14500 | 16700 | 1.13 |
| 8 | 200:1:5 × 10⁻³ | MMA | CPADB | 25 | 15 | 50 | 10300 | 12360 | 1.15 |
| 9 | 200:1:5 × 10⁻³ | MMA | CPADB | 25 | 10 | 29 | 6100 | 8400 | 1.12 |
| 10 | 200:0:8 × 10⁻⁴ | MMA | — | 4 | 20 | 0 | — | — | — |
| 11 | 200:1:8 × 10⁻⁴ | NIPAAm | BTPA | 4 | 4 | 47 | 10900 | 13970 | 1.08 |
| 12 | 200:1:8 × 10⁻⁴ | HPMA | CPADB | 4 | 12 | 53 | 15600 | 9800 | 1.05 |
| | | | | | | | | (15900)ⁱ | |
| 13 | 200:1:8 × 10⁻⁴ | HEMA | CPADB | 4 | 6 | 77 | 20330 | 22700 | 1.09 |
| 14 | 200:1:8 × 10⁻⁴ | PFPA | BTPA | 4 | 6 | 55 | 26180 | 22300 | 1.08 |
| 15 | 200:1:8 × 10⁻⁴ | GMA | CPADB | 4 | 12 | 53 | 15330 | 16300 | 1.12 |
| 16 | 200:1:8 × 10⁻⁴ | DMAEMA | CPADB | 4 | 14 | 20 | 6300 | 9600 | 1.18 |
| 17 | 200:1:0 | DMAEMA | CPADB | 0 | 10 | 0 | — | — | — |
| 18 | 200:1:8 × 10⁻⁴ | MA | BSTP | 4 | 3 | 41 | 7340 | 7920 | 1.20 |
| 19 | 370:1:8 × 10⁻⁴ | MMA | CDB | 4 | 12 | 33 | 12500 | 15550 | 1.27 |
| 20 | 200:1:8 × 10⁻⁴ | MMA | CPD | 4 | 12 | 60 | 12240 | 13700 | 1.17 |
| 21 | 200:1:8 × 10⁻⁴ | MMA | CDTPA | 4 | 14 | 79 | 16200 | 12800 | 1.17 |
| 22^{f} | 200:1:8 × 10⁻⁴ | MA | BTPA | 4 | 8 | 53 | 9400 | 11500 | 1.07 |
| 23^{g} | 200:1:8 × 10⁻⁴ | MA | BTPA | 4 | 20 | 44 | 7800 | 8700 | 1.06 |
| 24^{j} | 200:1:8 × 10⁻⁴ | MMA- | CPADB | 4 | 9 | ND^{h} | ND^{h} | 25000 | 1.19 |
| | | stat-MAA^{e} | | | | | | | |

Notes:
^{a}The polymerizations were performed in the absence of oxygen at room temperature in dimethylsulfoxide (DMSO) using 4.8 W red LED lamp as a light source (λₘₐₓ = 635 nm);
^{b}Monomer conversion was determined by using ¹H NMR spectroscopy;
^{c}Theoretical molecular weight was calculated using the following equation: M_{n,th} = [M]ₒ/[RAFT] × MW^{M} × α + MW^{RAFT}, where [M]ₒ, [RAFT]ₒ, MW^{M}, α, and MW^{RAFT} correspond to initial monomer concentration, initial RAFT concentration, molar mass of monomer, conversion determined by ¹H NMR, and molar mass of RAFT agent;
^{d}Molecular weight and polydispersity were determined by GPC analysis (DMAc as eluent) based on polystyrene standards,
^{e}[MMA]₀:[MAA]₀:[RAFT]:[Chl a] = 100:100:1:8 × 10⁻⁴;
^{f}The reaction was carried out in N,N-dimethylformamide (DMF) under red LED light irradiation;
^{g}The reaction was carried out in acetonitrile (MeCN) under red LED light irradiation;
^{h}Not determined;
ⁱMolecular weight determined by ¹H NMR;
^{j}Methylation was carried out with trimethylsilyldiazomethane prior to GPC analysis (DMAc eluent) based on polystyrene standards.

TABLE 7
Polymerization of a variety of monomers by PET-RAFT using Chl a as biocatalyst and
4.8 W blue LED lamp as a light source.

| | | | | [Chl a]/ | | | | | |
|---|---|---|---|---|---|---|---|---|---|
| | Exp. Cond.^{a} | | RAFT | [M] | Time | α ^{b} | M_{n, th.}^{c} | M_{n,GPC}^{d} | |
| # | [M]:[CTA]:[Chl a] | Monomer | agent | (ppm) | (h) | (%) | (g/mol) | (g/mol) | M_{w}/Mₙ^{d} |
| 1 | 200:1:8 × 10⁻⁴ | MMA | CPADB | 4 | 10 | 21 | 5100 | 4500 | 1.11 |
| 2 | 200:0:8 × 10⁻⁴ | MMA | — | 4 | 13 | 0 | — | — | — |
| 3 | 200:1:8 × 10⁻⁴ | NIPAAm | BTPA | 4 | 4 | 48 | 11100 | 14530 | 1.09 |
| 4 | 200:1:8 × 10⁻⁴ | HEMA | CPADB | 4 | 6 | 77 | 20330 | 22800 | 1.09 |
| 5 | 200:1:8 × 10⁻⁴ | GMA | CPADB | 4 | 13 | 47 | 13630 | 14660 | 1.14 |
| 6 | 200:1:8 × 10⁻⁴ | DMAEMA | CPADB | 4 | 14 | 35 | 11300 | 13400 | 1.14 |
| 7 | 200:1:0 | DMAEMA | CPADB | 4 | 14 | 7 | 2500 | 5600 | 1.17 |
| 8 | 200:1:8 × 10⁻⁴ | MMA-stat- | CPADB | 4 | 9 | ND^{f} | ND^{f} | 20000 | 1.21 |
| | | MAA^{e} | | | | | | | |

Notes:
^{a}The polymerizations were performed in the absence of oxygen at room temperature in dimethylsulfoxide (DMSO) using 4.8 W blue LED lamp as a light source (λₘₐₓ = 461 nm).
^{b}Monomer conversion was determined by using ¹H NMR spectroscopy.
^{c}Theoretical molecular weight was calculated using the following equation: M_{n,th} = [M]₀/[RAFT]₀ × MW^{M} × α + MW^{RAFT}, where [M]₀, [RAFT]₀, MW^{M}, α, and MW^{RAFT} correspond to initial monomer concentration, initial RAFT concentration, molar mass of monomer, conversion determined by ¹H NMR, and molar mass of RAFT agent.
^{d}Molecular weight and polydispersity were determined by GPC analysis (DMAC as eluent).
^{e}[MMA]₀:[MAA]₀:[RAFT agent]:[Chl a] = 100:100:1:8 × 10⁻⁴.
^{f}ND: not determined.

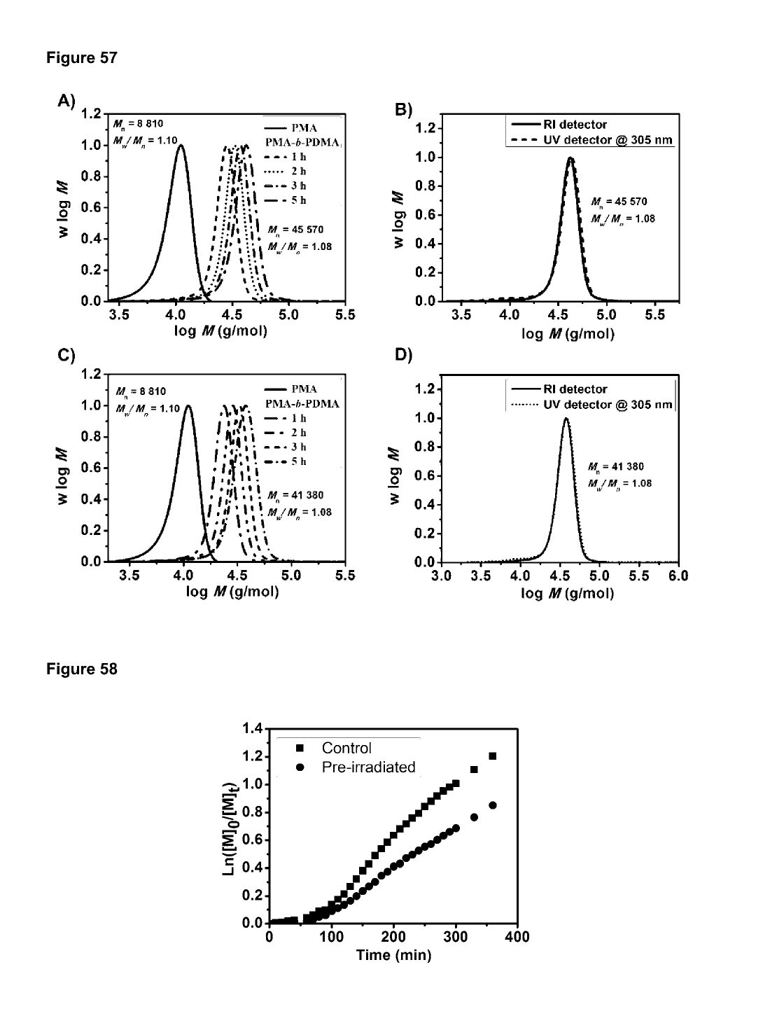

The livingness of the polymers synthesized by PET-RAFT using Chl a was further investigated by chain extensions of PMA and PMMA under both blue and red light. PMA macroinitiators were first synthesized in DMSO under irradiation by blue and red light (M_{n,GPC}=8 810 g/mol, M_{w}/Mₙ=1.10 and 46% monomer conversion for both lights) with BTPA in the presence of 4 ppm Chl a for 3 and 2 h, respectively. A molar ratio of 500:1 of the monomer N,N-dimethylacrylamide (DMA) to the PMA macroinitiator was then used for chain extension in the presence of 4 ppm of Chl a. Successful chain extension was observed for both macroinitiators under blue and red light (FIGS. 57A and 57C), with the molecular weight distributions showing a complete shift in both macroinitiators to higher molecular weights over time. In addition, the UV and RI curves for the diblock copolymers under red and blue lights at 5 h (FIGS. 57B and 57D), show a perfect overlap with the absence of dead chains and a decrease in polydispersities (PMA-b-PDMA: M_{n,GPC,red}=45 570 g/mol, M_{w}/Mₙ=1.08 and 79% monomer conversion for red light, and M_{n,GPC,blue}=41 380 g/mol, M_{w}/Mₙ=1.08 and 69% monomer conversion for blue light). Successful chain extension of the PMMA macroinitiators with tert-butyl methacrylate (tBuMA) and oligo(ethylene glycol) methyl ether methacrylate (OEGMA) monomers with a molar ratio of [monomer]:[macroinitiator]=500:1 was also demonstrated by GPC.

In order to investigate the stability of chlorophyll molecule in PET-RAFT polymerization upon prolonged exposure to light, the catalyst photostability test described above was carried out with online FTNIR measurement. For this investigation, two DMSO solutions in two quartz cuvettes containing the same concentration of Chl a (4 ppm) were both degassed with nitrogen. The first cuvette was pre-irradiated under red light for 16 hours, while the second was kept in the dark as a parallel control. Both of them were then employed for the polymerization of MA in the presence of BTPA with a molar ratio of [MA]:[BTPA]:[Chl a]=200:1:8×10⁴. The online FTNIR study showed that the polymerization of MA (FIG. 58) in control system (kₚ^{app} (control)=5.23×10⁻³ min⁻¹) was faster than that in pre-irradiated one (kₚ^{app} (pre-irradiated)=3.54×10⁻³ min⁻¹), indicating partial degradation of Chl a during light irradiation. This is possibly attributed to the formation of a tetrapyrrole structure through the cleavage of the porphyrin ring at one of the methine bridges.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A process for preparing a polymer, comprising exposing a mixture comprising a monomer, an initiator, a chain transfer agent and a photoredox catalyst, to light, wherein exposing the mixture to light initiates radical polymerization of the monomer.

2. The process of claim 1, wherein the chain transfer agent and the initiator are present in the form of a PET-RAFT agent.

3. The process of claim 2, wherein the PET-RAFT agent is a compound of formula (I′): 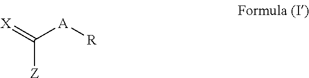
wherein:
X and A are independently selected from S or CH₂;
Z is selected from optionally substituted aryl, optionally substituted heterocyclyl, optionally substituted -Oaryl, optionally substituted -Oheterocyclyl, optionally substituted —OC₁₋₂₀alkyl, optionally substituted —SC₁₋₂₀alkyl and —NR⁴R⁵, wherein R⁴ and R⁵ are independently selected from C₁₋₄alkyl, aryl and heteroaryl; and
R is a moiety which, as a free radical, is capable of initiating polymerization of the monomer.

4. The process of claim 3, wherein X and A are both S.

5. The process of claim 2, wherein the PET-RAFT agent is selected from:

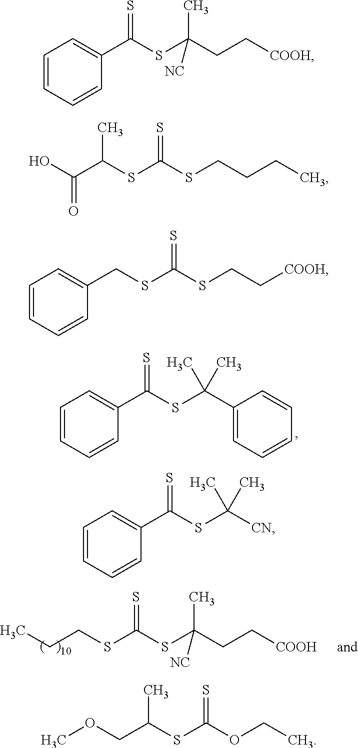

6-8. (canceled)

9. The process of claim 1, wherein the molecular weight distribution of the polymer has a M_{w}/Mₙ of less than about 1.5.

10. The process of claim 1, wherein the photoredox catalyst is a metal photoredox catalyst, an organo photocatalyst or a photo-biocatalyst.

11. The process of claim 1, wherein the photoredox catalyst is selected from fac-Ir(ppy)₃, Ru(bpy)₃Cl₂ and chlorophyll a.

12. The process of claim 1, wherein the mixture comprises the photoredox catalyst in an amount of less than about 5 ppm relative to the monomer.

13. The process of claim 1, wherein the monomer is selected from methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methystyrene, methyl acrylate, ethyl acrylate, propyl acrylate (all isomers), butyl acrylate (all isomers), 2-ethylhexyl acrylate, isobornyl acrylate, acrylic acid, benzyl acrylate. phenyl acrylate, acrylonitrile, styrene, functional methacrylates, acrylates and styrenes selected from glycidyl methacrylate, 2-hydroxyethyl methacrylate, hydroxypropyl methacrylate (all isomers), hydroxybutyl methacrylate (all isomers), N,N-dimethylaniinoethyl methacrylate, N,N-diethylaminoethyl methacrylate, triethyleneglycol methacrylate, di(ethylene glycol) ethyl ether acrylate (DEGA), oligo(ethyleneglycol) methyl ether methacrylate (OEGMA), oligo(ethyleneglycol) methyl ether acrylate (OEGA), itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N′-diethylaminoethyl acrylate, triethyleneglycol acrylate, methacrylamide, N-methylacrylamide, N,N-dimethylacrylamide (DMA), N-ethylacrylamide, N,N-diethylacrylamide (DEA), N-tert-butylmethacrylamide, N-n-butylmethacrylamide, N-methylolmethacrylamide, N-ethylolmethacrylamide, N-isopropylacrylamide (NIPAAm), N-tert-butylacrylamide, N-n-butylacrylamide, N-methylolacrylamide, N-ethylolacrylamide, vinyl benzoic acid (all isomers), diethylaminostyrene (all isomers), alpha-methylvinyl benzoic acid (all isomers), diethylamino alpha-methylstyrene (all isomers). p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilyipropylmethacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilyipropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, vinyl pivalate, dimethyl vinylphosphonate, butadiene, isoprene, chloroprene, vinyl difluoride, tetrafluoroethylene, vinyl chloride, vinyl dichloride, and combinations thereof.

14. The process of claim 1, wherein the mixture further comprises an aqueous solvent.

15-17. (canceled)

18. The process of claim 1, wherein the mixture is not degassed.

19-26. (canceled)

27. The process of claim 1, wherein the chain transfer agent is a biomolecule comprising, or bound to, a moiety capable of acting as a chain transfer agent, and wherein exposure of the mixture to light results in conjugation of the polymerized monomer to the biomolecule.

28. The process of claim 27, wherein the initiator and the biomolecule comprising, or bound to, a moiety capable of acting as a chain transfer agent are provided by the same compound.

29-31. (canceled)

32. A polymer produced by the process of claim 1.

33. A polymer produced by the process of claim 27, wherein the polymer is a polymer bioconjugate.

34. A composition comprising a monomer, an initiator, a chain transfer agent and a photoredox catalyst, wherein exposing the composition to light initiates radical polymerization of the monomer.

35. The composition of claim 34, wherein the initiation is reversibly controlled by the light.
